(19) United States
(12) Patent Application Publication
(10) Pub. No.: US 2003/0100343 A1
(43) Pub. Date: May 29, 2003

(54) Communications system and method

(76) Inventors: Takis C. Zourntos, Etobicoke (CA); Angus W. McLaren, Toronto (CA); Sebastian C. Magierowski, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/147,811

(22) Filed: May 20, 2002

Related U.S. Application Data
(60) Provisional application No. 60/291,653, filed on May 18, 2001.

(51) Int. Cl. H04B 1/38; H04M 1/00

(52) U.S. Cl. 455/562

(57) ABSTRACT

A wireless communication network and communication method utilizes beamforming techniques to establish dynamic two-way communication between nodes. The network includes a plurality of network nodes and a central router in communication with each of the network nodes. Each network node includes a node beamforming antenna array for establishing a spatial communication channel. The central router includes a memory and a processor coupled to the memory such that the processor executes instructions stored in memory for selectively activating at least one network node of the plurality of network nodes. Each activated network node has a transmission neighbourhood and each the node beamforming antenna array of each the activated network node is utilized to establish a first two way spatial communication channel. Communication is first established between the central router and each of the plurality of network nodes, selectively activating at least one network node of the plurality of network nodes such that each activated network node has a transmission neighbourhood and utilizing each the node beamforming antenna array of each the activated network node to establish a first two-way spatial communication channel.

This application claims priority from U.S. Provisional Patent Application No. 60/291,653 filed May 18, 2001.

### FIELD OF THE INVENTION

The present invention pertains to a connection-oriented wireless local area network, and more particularly to a wireless network that utilizes beamforming techniques to establish dynamic two-way communication.

### SUMMARY OF THE INVENTION

The present invention provides in one aspect a wireless communication network comprising:

(a) a plurality of network nodes, each network node including a node beamforming antenna array for establishing a spatial communication channel;

(b) a central router in communication with each of said network nodes, said central router comprising:

(i) a memory; and

(ii) a processor coupled to said memory such that said processor executes instructions stored in memory for selectively activating at least one network node of said plurality of network nodes such that each activated network node has a transmission neighbourhood and such that each said node beamforming antenna array of each said activated network node is utilized to establish a first two way spatial communication channel.

In another aspect, the present invention provides a method of providing a communication path through a wireless network comprising a central router and a plurality of network nodes each having a beamforming antenna, said method comprising the steps of:

(a) establishing communication between said central router and each of said plurality of network nodes;

(b) selectively activating at least one network node of said plurality of network nodes such that each activated network node has a transmission neighbourhood; and

(c) utilizing each said node beamforming antenna array of each said activated network node to establish a first two-way spatial communication channel.

### BRIEF DESCRIPTION OF THE DRAWINGS

FIG. 1 is a depiction of the invention and its various forms of communication;

FIG. 2 is an overview of Hardware at Each Network Node;

FIG. 3 is a preferred embodiment of the Antenna Array;

FIG. 4 is a preferred embodiment of RF Front End and Data Converters;

FIG. 5 is a Fixed-Element Layer hardware topology;

FIG. 6 is a Topological organization of EPs with respect to an AP;

FIG. 7 is a Planar layout of EPs in the vicinity of an AP;

FIG. 8 is a depiction of an NI matrix node triple;

FIG. 9 is a depiction of an SO matrix node triple;

FIG. 10 is a placement of nodes in Level k+1 relative to a source node in Level k;

FIG. 11 is an illustration of child-node placement algorithm;

FIG. 12 is a FE Layer software subsystem organizational chart;

FIG. 13 is a record structure for Matrix Node Database;

FIG. 14 is a Link Database structure (including record structure);

FIG. 15 is a Basic Housekeeping process flow;

FIG. 16 is a LinkCheck( ) function (process performed at router);

FIG. 17 is a LinkCheck( ) requires that matrix nodes can perform these flows when prompted;

FIG. 18 is a ControlRMN( ) and ControlMNR( ) process flows;

FIG. 18 is a ColdReset( ) function, this portion is executed at the router;

FIG. 19 is a corresponding matrix node function complementing ColdReset( );

FIG. 20 is a New User Enters Network;

FIG. 21 is a User 2 and 3 Require LMAC at EP₇

FIG. 22 is an Example of Network Using Power Control;

FIG. 23 is an Example of System Incorporating Adaptive SDM;

FIG. 24 is an Error Handling in Case of Introduction of Obstacle;

FIG. 25 is a Transmission of Data/Control Packet;

FIG. 26 is an Example of Tracking User 2(No Handoff);

FIG. 27 is an Example of Handoff for User 2;

FIG. 28 is a Summary of Databases at Router;

FIG. 29 is a Summary of Databases at Nodes;

FIG. 30 is a New User Broadcasts an RFA;

FIG. 31 is a New User Broadcasts an RFA;

FIG. 32 is a Structure of an RFA Signal;

FIG. 33 is a Flow Chart for Registration at New User's Module;

FIG. 34 is a Flow Chart For Registration at Matrix Node or Previously Registered User;

FIG. 35 is a Flow Chart For Registration at Router;

FIG. 36 is a Flow Chart for Registration Beamforming at New User's Module;

FIG. 37 is a Flow Chart for Registration Beamforming at Matrix Node or Existing User;

FIG. 38 is a Flow Chart for Registration Beamforming of Matrix Nodes and Existing Users at Router;

FIG. 39 is a Flow Chart for Registration Beamforming of New Users at Router;

FIG. 40 is a Flow Chart for Tracking at User Module;

FIG. 41 is a Flow Chart for Tracking at Associated User Module;

FIG. 42 is a Flow Chart for Tracking of Users at Matrix Node;

FIG. 43 is a Flow Chart for Tracking of User at Associated Matrix Node;

FIG. 44 is a Flow Chart for Tracking of Nodes at Router (Method 1);

FIG. 45 is a Flow Chart for T_{update}_{_{—}}ᵢ Adjustment Process;

FIG. 46 is a Flow Chart For Registration LMAC at New User;

FIG. 47 is a Flow Chart For Registration LMAC at Matrix Node Existing User;

FIG. 48 is a Flow Chart for Registration LMAC at Router;

FIG. 49 is a Flow Chart for Tracking LMAC at User;

FIG. 50 is a Flow Chart for Tracking LMAC at Matrix Node;

FIG. 51 is a Flow Chart for Tracking LMAC for Users at Router;

FIG. 52 is a Flow Chart for Tracking LMAC of Matrix Nodes at Router;

FIG. 53 is a Flow Chart for ASDM at User Module;

FIG. 54 is a Flow Chart for ASDM At Matrix Node;

FIG. 55 is a Flow Chart for Adaptive SDM At Router;

FIG. 56 is a Flow Chart for Handoff at Handed Off User;

FIG. 57 is a Flow Chart for Handoff at Matrix Node or User Module;

FIG. 58 is a Flow Chart for Handoff at Router;

FIG. 59 is a Flow Chart for Handoff at Router (Continued);

FIG. 60 is a Flow Chart for Error Handling at Transmitting Node;

FIG. 61 is a Flow Chart for Error Handling at Router;

FIG. 62 is an illustration of how modules may be organized as vanilla ad-hoc networks. The extra diversity gained through spread-spectrum signalling is an example, other forms of diversity such as frequency, time, polarization, etc. may be used;

FIG. 63 is an illustration of various scenarios in the organization of modules into supervised ad-hoc networks. The extra diversity gained through spread-spectrum signalling is an example, other forms of diversity such as frequency, time, polarization, etc. may be used;

FIG. 64 is an illustration of communication within a mitigated ad-hoc network;

FIG. 65 is s Module database in vanilla ad-hoc network;

FIG. 66 is a Module database in supervised ad-hoc network;

FIG. 67 is a Module database in mitigated ad-hoc network;

FIG. 68 is a Matrix Node database utilized in supervised ad-hoc network control;

FIG. 69 is a Router database utilized in mitigated ad-hoc network control;

FIG. 70 is a Possible module display informing users of ad-hoc network's members;

FIG. 71 is the module's process of joining/starting a vanilla ad-hoc network;

FIG. 72 is the vanilla ad-hoc network's process of allowing modules to join/start the network;

FIG. 73 is an illustration of blocking where module B is not intended for data sent to A;

FIG. 74 is Part 1 of the supervised ad-hoc network start-up procedure (initialization) for building a new local group (continued in Part 2, FIG. 75);

FIG. 75 is Part 2 of the supervised ad-hoc network start-up procedure (initialization) for building a new local group (continued from Part 1, FIG. 74);

FIG. 76 is an outline of procedure for automatic start-up of local groups (supervised ad-hoc networks). This outline is linked to the automatic start-up procedure for mitigated ad-hoc networks shown in FIG. 84;

FIG. 77 is a supervised ad-hoc network procedure for joining a local group;

FIG. 78 is an outline of steady-state communication within supervised ad-hoc networks;

FIG. 79 is an outline of update procedure in supervised ad-hoc networks;

FIG. 80 is an illustration of using a supervisor in a supervised ad-hoc network to relay data around a blocker in a local group;

FIG. 81 is an illustration of using a mobile relay in a supervised ad-hoc network to relay data around a blocker in a local group;

FIG. 82 is an illustration of using unique spread-spectrum codes in a supervised ad-hoc network to transmit data without interfering;

FIG. 83 is an outline of procedure for starting a mitigated group in a mitigated ad-hoc network;

FIG. 84 is an outline of procedure for automatic start-up of mitigated groups (mitigated ad-hoc networks). This outline is linked to the automatic start-up procedure for supervised ad-hoc networks shown in FIG. 76;

FIG. 85 is an outline of procedure for joining a mitigated group in a mitigated ad-hoc network;

FIG. 86 is an outline mitigated ad-hoc network's steady-state operation;

### DETAILED DESCRIPTION OF THE INVENTION

The present invention is a wireless local-area network (LAN) of base stations (or matrix nodes) each equipped with beamforming transceivers from which a subset of matrix nodes are dynamically selected by a centralized router to simultaneously send/receive streams of data to and from a set of users/mobile units. The router is a device that is attached to a high speed wired/optical channel that forms the backbone of the LAN. Access points, in turn, connect the backbone and router to a network of wireless extension points which relay data throughout the network.

A sufficiently dense network of matrix nodes allows the network to spatially “weave” connections to each user around obstacles, other mobile units or sources of interference, providing potentially unprecedented levels performance independent of the number of users in the LAN. Each user in the system is provided with a set of tracking, dynamically allocated Virtual Fiber Connections™ to give true connection-oriented service within the LAN.

Each link in the network can be treated as a separate communication channel, thus any contentions are handled in a contained fashion through the use of localized medium-access control™ (LMAC™). By limiting the number of users involved for each application of medium access control, higher qualities of service can be attained.

0.2 Overview

The proposed wireless LAN architecture is portrayed in IEF DESCRIPTION OF THE DRAWINGS

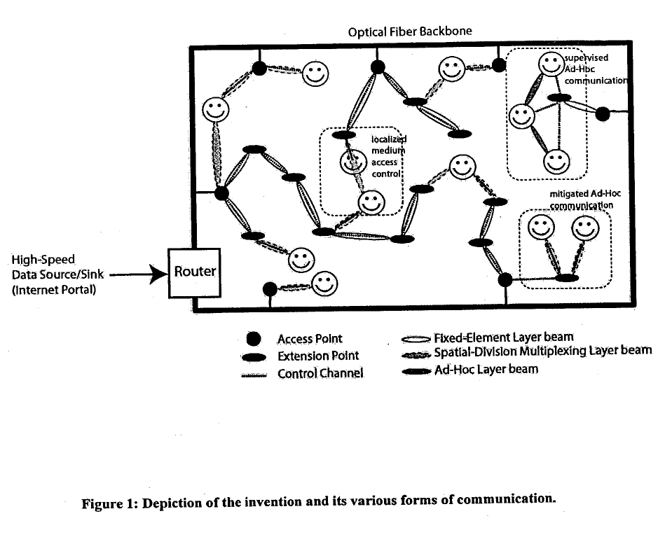

FIG. 1 and incorporates the following novel features:

adaptive beamforming access and extension points equipped with remote programmability and remotely adjustable beamforming/communication processors,

centralized control of dynamic path-planning through the combination of a high-capacity wired/optical channel and specialized router,

coordinated data delivery to a given user from a number of matrix (Spatial Division Multiplexing or SDM),

the formation of private local groups of users and direct data exchange amongst a number of users with possible supervision by fixed network elements (Ad-Hoc Networking),

geometric considerations for optimum network performance,

The network can be viewed in a layered manner in which users/mobile units and the various methods by which they communicate over single-hop links are placed “on top” of the fixed elements (router, backbone and matrix nodes) and the multiple-link data paths leading up to the users. We partition the invention into the Fixed-Element (FE) Layer, the Spatial Division Multiplexing (SDM) Layer and the Ad-Hoc Layer. Each layer is described below. Communication between layers and programming of various network elements is facilitated by a control channel linking the router with every node in the system. The control channel is comprised of the network backbone in addition to a set of wireless routes.

0.3 Hardware

0.3.1 Hardware Overview

The router is a computer and signal processing engine which interfaces to the network through wired or optical means alone (i.e., it does not have the ability to transmit data wirelessly). It oversees the operation of the network, executing the software functions of the various layers in the invention. It is also capable of programming the beamforming and communication processors of the matrix nodes (thus reducing or eliminating the need for processing capability needed at the MNs themselves). It may collect data received by a matrix node and manipulate it. For example, it may perform direction-of-arrival estimation on behalf of any fixed element. The router exerts its control over the network via the control channel, which, as mentioned, includes a “web” of wireless links permeating the network. Thus it is capable of sending data to, or receiving information from, any individual node.

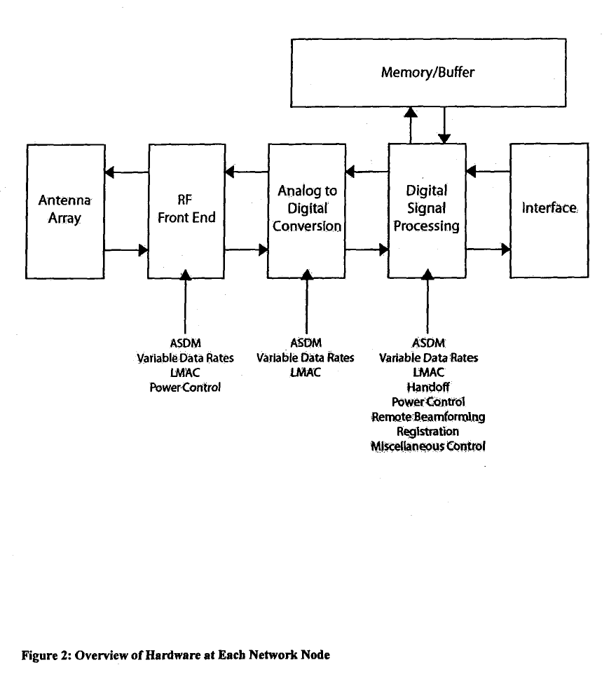

An overview of the hardware required at each network node is shown in FIG. 2. The hardware at each network node consists of an array of antennas with a corresponding array of RF front ends and analog-to-digital converters. This is followed by the Digital Signal Processor (DSP), memory, and interface circuitry.

0.3.2 Antenna Array

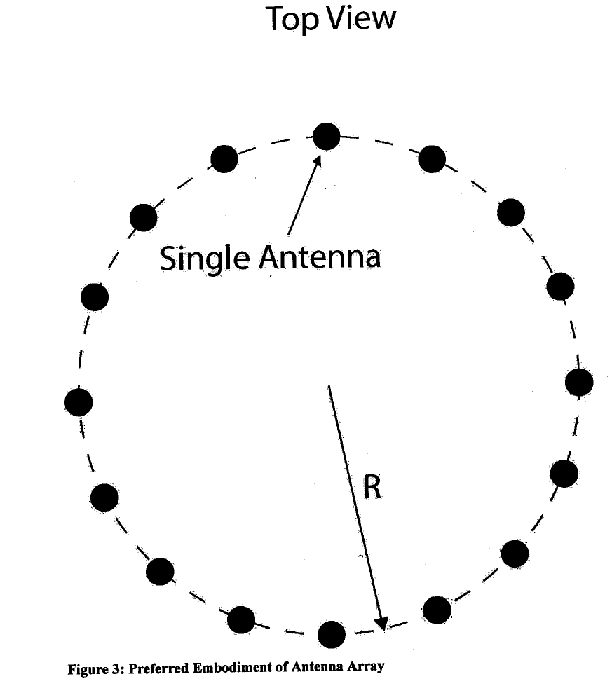

The preferred embodiment of the antenna array is shown in FIG. 3. The purposes of the antenna array are to allow the transmission and reception of RF signals, and to allow for the synthesis of receive and transmit beam patterns (see B. Van Veen, K. Buckley, “Beamforming: A Versatile Approach to Spatial Filtering”, IEEE ASSP Magazine, April 1988, pg. 4-24 for a discussion of beamforming).

The antenna array can be of arbitrary form. The preferred embodiment is a planar circular array, but other structures such as a uniform linear array, two-dimensional linear array, or square array would also work.

0.3.3 RF Front Ends and Data Converters

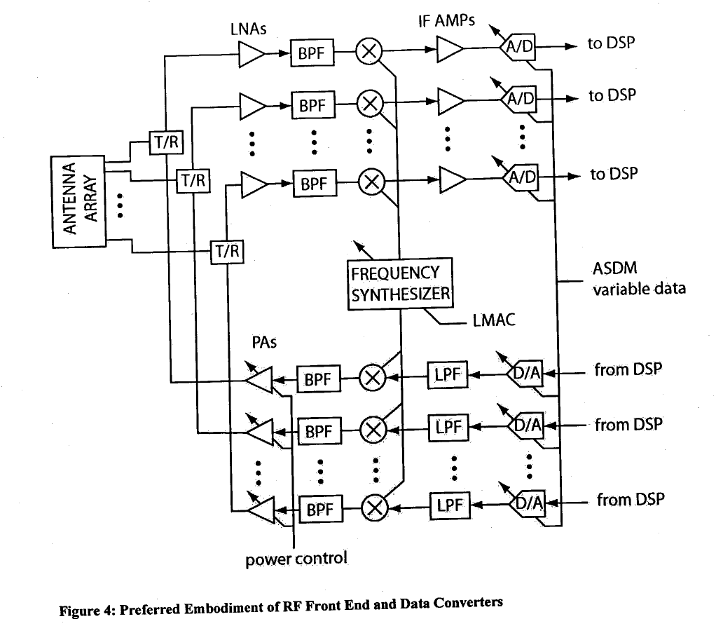

The preferred embodiment for the RF front ends and data converters is shown in FIG. 4. The purpose of the RF front ends is to translate between the radio-frequency signals of the antennas and the analog signals at the inputs/outputs of the analog-to-digital and digital-to-analog converters, respectively. Each antenna has a corresponding receiver and transmitter. Each receiver consists of an RF receiver front-end followed by an analog-to-digital converter, while each transmitter consists of a digital-to-analog converter followed by an RF transmitter front-end. An antenna is connected to either a transmitter or a receiver, under the control of a T/R switch.

Each receiver architecture may be the same and may use any of the well-known radio configurations. Each receiver shown is a low-IF (intermediate frequency) type system that includes an LNA (low-noise amplifier) to help improve SNR (signal-to-noise ratio) followed by a BPF (band pass filter) for image rejection and a down-conversion mixer that translates the incoming signal to a low IF. The LO (local oscillator) signal fed into the mixers through the frequency synthesizer can be varied depending on any of various multiplexing requirements made by the system. This signal is then appropriately amplified by the IF amplifiers and passed on to the A/Ds (analog-to-digital converters) which digitize the incoming analog signal and drive the DSP.

The transmitter is of the single upconversion type that uses D/A (digital-to-analog) converters to translate data from the DSP back into analog signals. The D/A outputs are first smoothed by the LPF (low pass filter) and then mixed up to the appropriate radio-frequencies by mixers (again, controlled by the system through the adjustable frequency synthesizer). The RF signals are then filtered using the BPFs to remove any spurious frequencies and amplified to appropriate levels by PAs (power amplifiers) that drive the antennas. The output power of the PAs is adjustable and depends on systems requirements.

The data converters can use any conventional structure, but must be capable of being clocked at different frequencies to accommodate varying symbol rates.

0.3.4 DSP

The DSP may be contained on a single chip, or distributed across several chips. It must perform physical-layer tasks such as beamforming, modulation and demodulation, encoding and decoding, interleaving and de-interleaving, as well as receive and transmit filtering. The DSP must also perform the functions associated with each of the system layers: the Fixed Element (FE) layer, the Spatial Division Multiplexing (SDM) layer, and the Ad-Hoc layer.

The DSP can be re-configured by several functions. The LMAC, Adaptive Spatial Division Multiplexing (ASDM) and Variable Data Rate functions change the modulation, coding, and filtering performed by the DSP. The Handoff and Registration functions change the network nodes from which the DSP is capable of processing packets. The Power Control function changes values stored by the DSP to control the transmit power of the RF front end. The Remote Beamforming function changes the weights applied to the antenna outputs by the DSP.

0.3.5 Memory

All nodes must have access to some memory to queue packets waiting for transmission, to store data that has been interleaved across several packets, and to store control information used by the DSP.

0.3.6 Interface

On user modules, the interface consists of circuitry that acts as an intermediary between the wireless network protocols and the user module processor. On access points, the interface consists of circuitry that acts as an intermediary between the wireless network protocols and the wired network to which it is attached. There is no interface required for extension points.

1. Fixed-Element Layer

1.0 Introduction

The Fixed-Element (FE) Layer defines the infrastructure for the invention. It lays the foundation of matrix node (MN) inter-communication and router control that supports the user-oriented services of the Spatial-Division Multiplexing (SDM) and Ad-Hoc Layers. Part A) provides a high-level overview of the FE Layer, showing how the matrix nodes, router and backbone are connected, and describes, in gross terms, how these fixed elements function together. Part B) reveals the structure of the invention in both hardware and software. Based on the elemental descriptions of Part B), the detailed operation of the FE Layer is given in Part C).

1.1 Top-Level

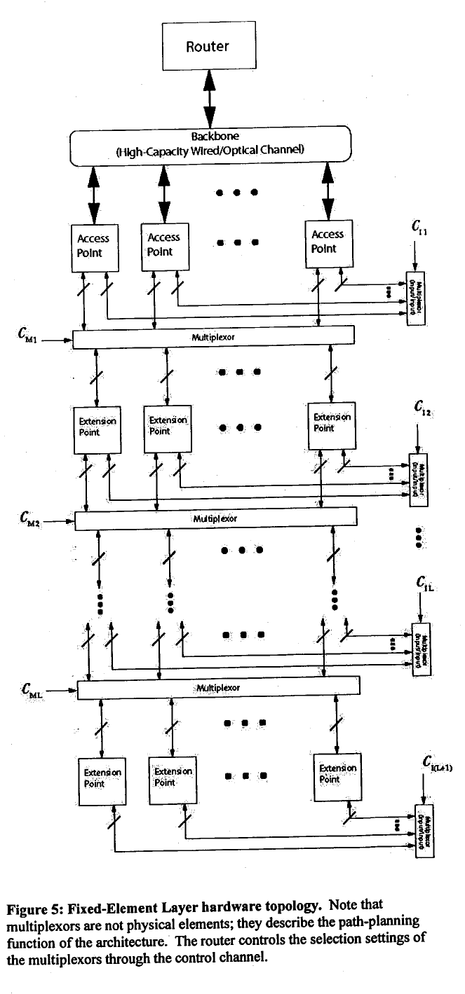

We specify the manner in which the fixed elements (matrix nodes, router and backbone) are connected and discuss some basic operational features of the FE Layer. FIG. 5 depicts the topology of the FE Layer in terms of the hardware components of the network; note that mobile units or users are not included in the diagram.

1.1.1 Topological/Functional Description

In this section, the structure of the FE Layer is formalized mathematically. We begin with the process by which the matrix nodes are organized. Afterwards, geometric placement rules to implement the topological organization are described. Note that the network topology is influenced by geometry (and vice versa), so that topology cannot be decided without any consideration of geometry.

In the following discussion, we are concerned with communication links forming the “main trunks” of data transfer from the AP through descendant EPs. Communication between EPs of the same level is usually decided on an ad-hoc basis via the action of the router, and not necessarily taken into account at the network design stage.

Matrix Node Topology for Planar Data Transmission

We consider an access point, AP₁, and an associated collection of extension points (or access points), denoted by C¹_{EP}. The number of matrix node levels, L₁, is selected. This is determined by the physical size of the area in which the matrix nodes are to be placed and the transmit power levels of the matrix nodes. The minimum number of levels is equal to the minimum number of nodes needed to span the area from the position of AP₁ to the point furthest from AP₁ within the area, such that a connected communication path can be formed from AP₁ to the last node. Note that nodes in the same level are approximately the same distance from AP₁. Next, matrix nodes from C_{EP}¹ are allocated to each level; this is done by considering anticipated zones (within a given level) in which multiple users are to require network access. Matrix nodes can be concentrated at these positions.

We define direct communication between two matrix nodes as communication through a single hop or a single spatial link. We now organize the matrix nodes associated with AP₁ topologically into level sets denoted by Sₖ¹ in which the superscript corresponds to the access point designation and the subscript, k, represents the level number. We define the N₁¹-element set S₁¹ as

S₁¹:={mεC_{EP}¹:m⇄AP₁}, (1)

where “⇄” denotes that direct communication is allowed between the operands. We define the N₂¹-element set S₂¹ as

S₂¹:={mε(C_{EP}¹−S₁¹):m⇄n,nεS₁¹}.

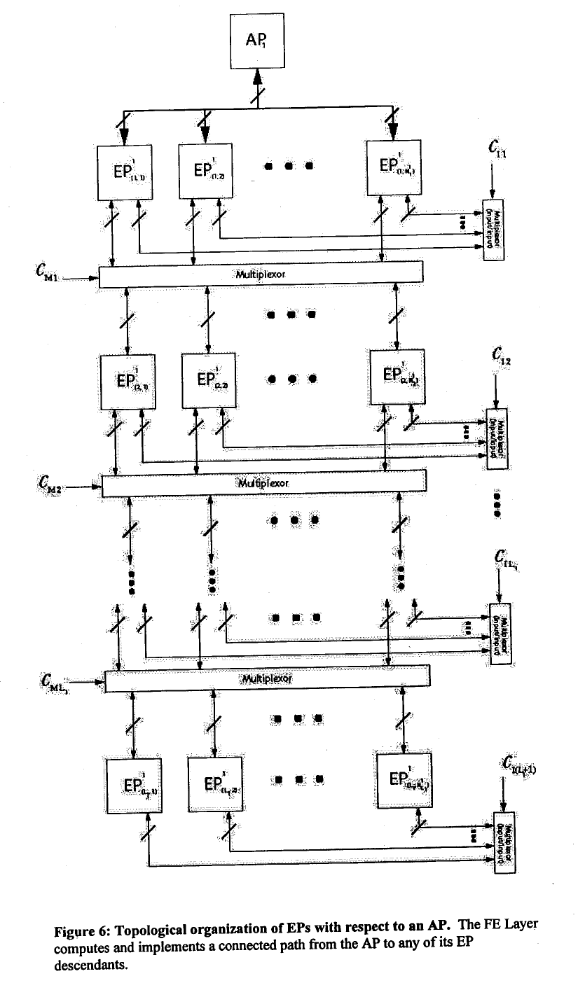

Proceeding sequentially, we define S₃¹, S₄¹, . . . , as

$${S}_{k}^{1} := \{ m ∈ ( {C}_{EP}^{1} - {⋃}_{i = 1}^{k - 1} {S}_{i}^{1} ) : m ↔ n , n ∈ {S}_{k - 1}^{1} \} \qquad ( 3 )$$

in which the number of elements in Sₖ¹ is denoted by Nₖ¹. We continue until each matrix node in C_{EP}¹ is assigned. The generalized topology of extension point organization about AP₁ is shown in FIG. 6.

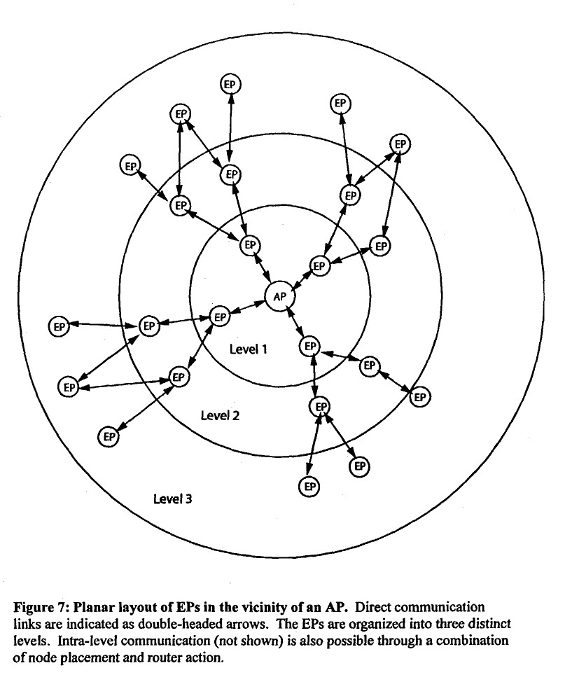

Organization of EPs relative to a source access point in the above manner is consistent with the flow of information from backbone to access points to nearby EPs spreading out towards a user. The organization of the EPs may change as required by fluctuations in the environment, interference levels or user demand. An example of a planar layout of extension points about a single access point is shown in FIG. 7.

1.1.2 Geometric Rules for Planar Layout of Matrix Nodes

We provide an explicit approach for planar layout based on a given network topology. All matrix node locations are specified as vectors in [symbol] ² (the Euclidean plane). Three dimensional layouts can be obtained by combining planes of communication in [symbol] ³ in which each plane is conceived from the development below.

Given an EP or AP with a location represented by the symbol nₗ ε [symbol] ², we define the communication set of n^{l}, denoted by V^{l}, as a convex neighbourhood of nₗ, whose extent is set in terms of a user-selected metric, d: [symbol] ²× [symbol] ²→ [symbol] , over which wireless data transmitted by nₗ is considered valid. Formally,

Vₗ:={nε [symbol] ²:d(nᵢ,n)≦ε,ε>0}. (4)

Thus, nₗ⊂Vₗ⊂ [symbol] ². In practice, the size of Vₗ, given by ε, is a function of the transmit power level of the matrix node.

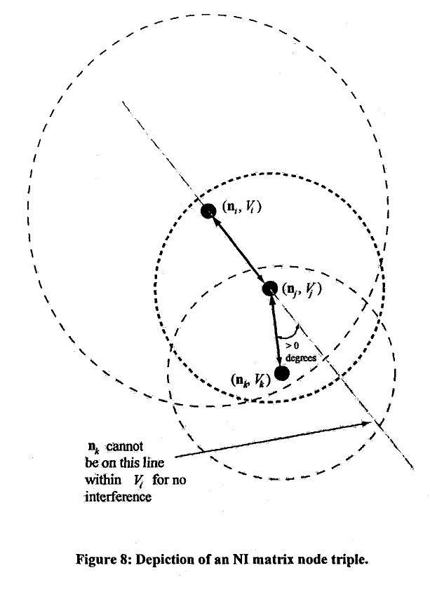

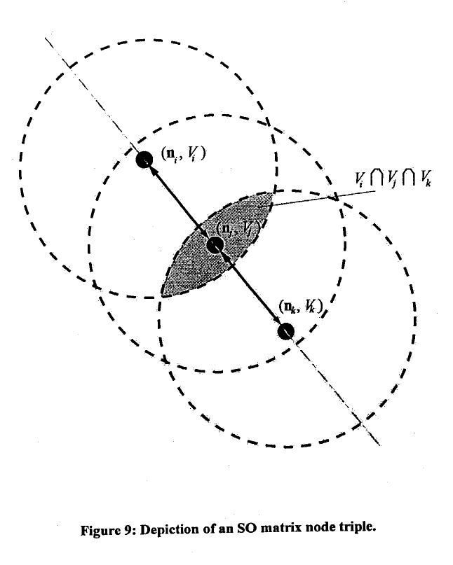

Consider two nodes, nₗ and nⱼ, in direct communication with each other. Suppose that a third node, nₖ, is in direct communication with either nₗ or nⱼ. The three nodes are said to constitute a matrix node triple. We have the following definitions (FIG. 8 and FIG. 9 illustrate these concepts pictorially).

Definition: (Non-Interfering (NI) Triple)

If nₗ, nⱼ and nₖ are positioned such that they are not colinear nor are any two nodes coincident, then the triple (nₗ, nⱼ, nₖ) is said to be non-interfering (NI).

Definition: (Spread-Out (SO) Triple)

If nₗ, nⱼ and nₖ are positioned such that only one of nₗ, nⱼ or nₖ is located within the set Vₗ∩Vⱼ∩Vₖ, then the triple (nₗ, nⱼ, nₖ) is said to be spread-out (SO).

Remarks:

The node triple (delimiting two contiguous communication links) is the basic working unit for planar layout of matrix nodes.

For densely packed network geometries, matrix node triples can be NI and not SO.

For minimum interference, a triple should be both NI and SO.

Essential Layout Guidelines

A layout strategy for the matrix nodes must, at a minimum, embody the following principles:

1. Any two contiguous (beamformed) wireless communication links in the FE Layer of the network must be formed by EPs or APs constituting either an SO or NI matrix node triple.

2. The angular separation amongst NI matrix nodes must (in practice) exceed the (angular) beamwidth associated with the EPs and APs.

Planar Matrix Node Placement About a Source Node

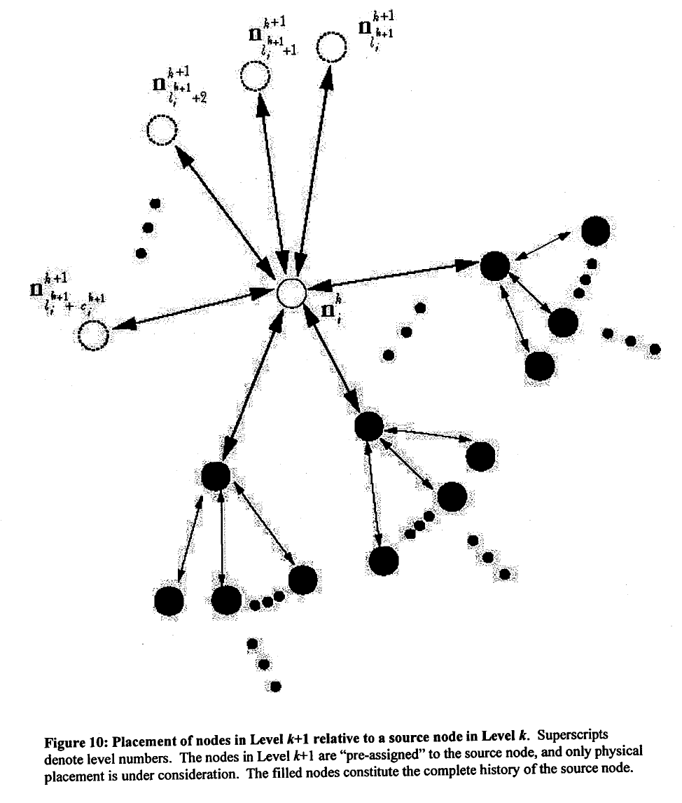

We now describe an approach for placing a set of “child” nodes in Level k+1 relative to a “parent” or source node (denoted by nₗ^{k}) in Level k. FIG. 10 illustrates the node placement problem under consideration. The techniques described here, in which new nodes are placed in direct communication with existing network nodes, are the basis for the generation of entire levels, which, in turn, are the building blocks of complete networks.

We specify a function class AttachMNs( ) (whose parameters include the source node as well as the set of matrix nodes to be placed) as follows. We refer to the set of all nodes on any connected path terminating at nₗ^{k} as the history set of nₗ^{k}, denoted by Hᵢ^{k}. The start index of the nodes in Level k+1 corresponding to nₗ^{k} is given by lₗ^{k}, and we assume that there are a total of cₗ^{k}+1 children. A member of the function class AttachMNs( ) must satisfy the following criteria:

1. Each child node must be placed “sufficiently close” to nₗ^{k}, that is, nₗ^{k}, nⱼ^{k+1}εVₗ^{k}∩Vⱼ^{k+1}; for all jε{lⱼ^{k+1},lₗ^{k+1}+1, . . .,lₗ^{k+1}+cₗ^{k+1}}.

2. Interference-free direct communication should be possible between the source node and its children in Level k+1. Therefore, (nₗ^{k},nⱼ^{k+1},m) must be an SO or NI triple for any jε{lⱼ^{k+1},lₗ^{k+1}+1, . . . ,lₗ^{k+1}+cₗ^{k+1}} and for any mεHₗ^{k}.

3. If there is a beamwidth resolution parameter, Δφ (specified in degrees or radians), for the beamforming arrays in the network, the angular separation amongst the children (relative to an origin at the source node) must be equal to or greater than Δφ.

Preferred Embodiment of AttachMNs( )

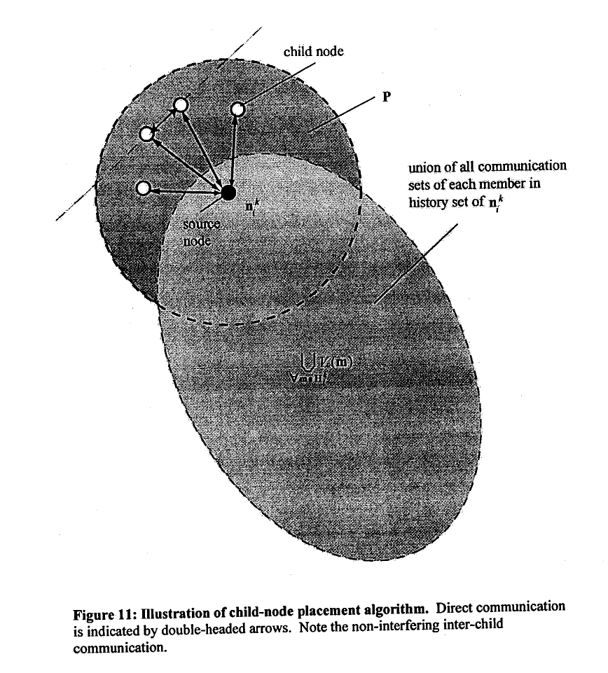

An explicit function of the class AttachMNs( ) can be described as follows. FIG. 11 provides a graphical representation of the technique. Consider a circle (all points in the corresponding closed disc are denoted by D) centered at nₗ^{k} that is contained within Vₗ^{k} but not contained within

$${⋃}_{∀ m ∈ {H}_{i}^{k}} V ( m ) ,$$

in which the notation V(m) denotes the communication set corresponding to matrix node m. Therefore, any node placed within the region of the circle that is outside

$${⋃}_{∀ m ∈ {H}_{i}^{k}} V ( m ) ,$$

which has a sufficiently small communication set, is “spread out” from any member of the history set of nₗ^{k}. This helps simplify placement considerably, although node packing may not be extremely dense. Also note that in order to ensure that at least a portion of the circle is outside

$${⋃}_{∀ m ∈ {H}_{i}^{k}} V ( m ) ,$$

the transmit power of the source node has to be sufficiently great.

We now define the set P as the set

$$D - ( D ⋂ ( {⋃}_{∀ m ∈ {H}_{i}^{k}} V ( m ) ) ) .$$

As long as the angular separation between the children is sufficiently large, and the radial distances of the children from the source are small enough to allow direct communication with the source, the designer is free to place the matrix nodes anywhere within P. However, in order to ensure that communication amongst specified children is possible, the designer must also ensure that the appropriate SO or NI conditions are met within Level k+1; the can be done with a cut-and-try approach. The network router is capable of determining NI inter-child communication automatically, therefore, this step is not critical.

Subnetwork Construction

We now demonstrate a technique to place multiple levels of matrix nodes in the vicinity of a source node through the iterative application of a function in the class AttachMNs( ). Such a structure is referred to as a “subnetwork” and can be used to position EPs in the vicinity of an AP. The subnetwork consists of a number of levels, with each level containing varying numbers of MNs. We are given:

the source node position n₁⁰ and its associated communication set V₁⁰,

the number of levels in the subnetwork, L,

the minimum angular separation of matrix nodes relative to a source node, Δφ,

the topological structure of the subnetwork, including the number of matrix nodes assigned to each level (the number of nodes at level i is given by Nᵢ), the number of children for node i in Level k, specified as cₗ^{k}+1, and the start index for the children in Level k for node i, given by lₗ^{k}.

We also assume that storage is available for the history set information (perhaps in the form of tree data structure) of each node. We define the procedure

Place (<source node>, <list of children>, <history set>)

as a member of the class AttachMNs( ). The algorithm for subnetwork generation is

for k←1:L

for i←1:Nₖ₋₁

Place(nₗ^{k}, {nₗ_{ₗ}_{^{k}}^{k},nₗ_{ₗ}_{^{k+1}}^{k}, . . . ,nₗ_{ₗ}_{^{k}}_{c}_{ₗ}_{^{k}}^{k}┘,Hₗ^{k})

end i;

end k;

Overall Network Construction

Network construction proceeds straightforwardly from the foregoing. A group of subnetworks can be merged if they share a set of matrix nodes. Access points may assume the positions of any node in a subnetwork to provide improved quality of service. Subnetworks may also be concatenated and may not necessarily share nodes, in order to provide a larger network layout.

1.2 Structure of Software Subsystem

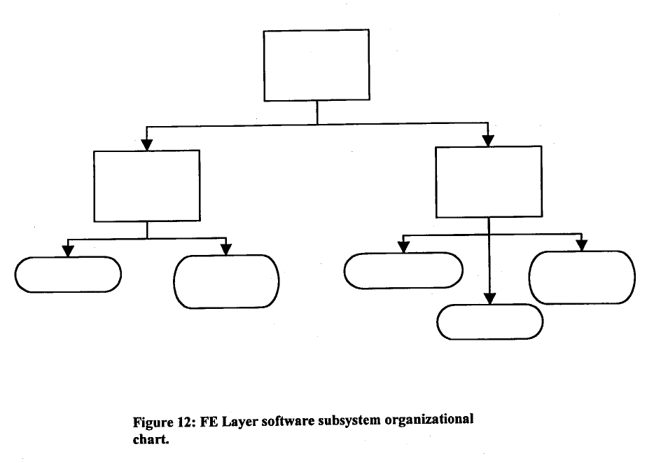

We partition the FE Layer software control subsystem as shown in FIG. 12. The end points of the tree correspond to function libraries whose algorithms are described in detail below. Background processes are those which operate with regularity according to, for example, a master clock signal. Event-driven processes are called as needed and are otherwise inactive.

The system is initialized through functions in the Administration library, which also handle the addition of new fixed elements to the network. The Housekeeping library updates database information and checks the integrity of the fixed elements. Errors generated by any function in the layer are sensed by the Error/Interrupt Checking system and appropriate functions are called to handle the event. The Communication library supports the exchange of control and data between fixed elements. Path planning and localized medium access control functions are performed by the Interface/Error Handling library, which provides many services to the SDM and Ad-Hoc Layers.

This structure is suggested to facilitate the design of control software and supports the intended use of the architecture. The software designer must keep in mind that the libraries are meant to complement each other so that any new functions that are added to one library may require the development of matching functions in other libraries.

1.2.1 Databases

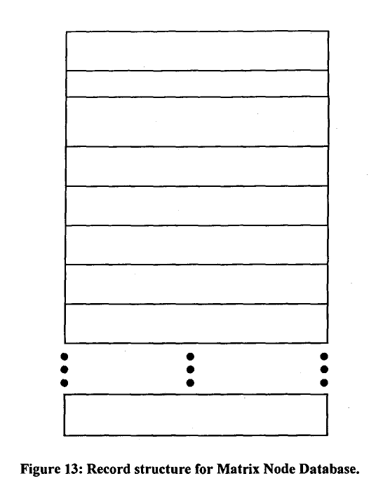

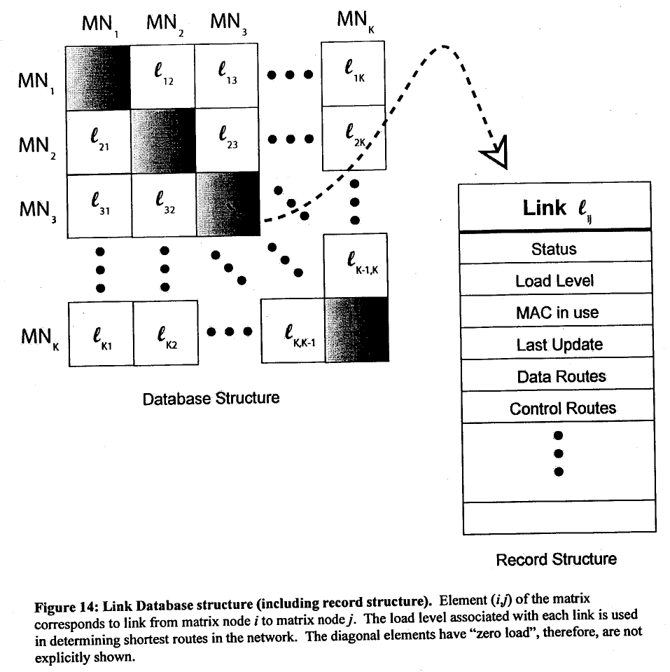

There are five basic databases required by the FE Layer. The Matrix Node Database provides status information for each matrix node and contains an associated routing table showing possible “next” node transmission (and the corresponding load or cost). The record structure corresponding to each AP or EP is shown in FIG. 13. The status of all single-hop links in the network is provided in the Link Database, which takes the form of a two-dimensional matrix of link records, as shown in FIG. 14. Separate records for each direction of a given link are maintained. This database is used to determine shortest-path routes (described in the Route Planning library, below).

The Network Map provides a “bird's eye view” of the complete network, indicating the relative placement of fixed elements. The map is not necessarily to scale, but captures relevant angular information used to determine contentions in path planning.

The record-keeping system of the FE Layer includes a Preferences database specifying the desired settings for various parameters in the system. The network administrator can set the values to customize network operation. Such parameters include priority settings indicating, for example, whether localized MAC or re-routing should take priority in handling a communication error associated with a given link.

Finally, the Error/Interrupt Look-Up Table stores “remedies” for a number of contingencies to allow the Error/Interrupt Checking library to direct operation to an appropriate function (often in the Error/Interrupt Handling block).

In addition to this record-keeping system stored at the router, the matrix nodes themselves contain memory which is used to keep track of control information (in particular, the control channel route(s) the matrix node is to use) and beamforming data.

1.3 Operation

Now that the structure of the FE Layer and its constituent parts have been defined, we can consider each function specified in Part B) in greater detail. We begin with an overview of the system before providing flowcharts of key procedures.

1.3.1 Overview

The FE Layer encompasses the network router, backbone and matrix nodes but excludes users/mobile units. The communication links up to the matrix node in direct communication with a user module are within the domain of the FE Layer. However, links from matrix nodes to users and between users are the concerns of the SDM and Ad Hoc Layers.

The FE Layer is responsible to initialize the network infrastructure and provide the multiple-link lines of communication between backbone and matrix nodes and amongst matrix nodes. The maintenance, organization and planning of these paths are handled by the procedures disclosed below.

1.3.2 Function Flowcharts

We provide process flows for the core functions in each Library discussed above. Library sub-categories are indicated by underscored headings.

1.3.2.1 Housekeeping

This library maintains current information on the status of all fixed elements. Should any parameter be outside the desired operating range (as specified in the Preferences database), errors or interrupts are generated. Each function is executed centrally at the router; network elements provide any required information through the wireless control channel or backbone. The main functions in this layer include RouterCheck( ), MNCheck( ), LinkCheck( ), and BackboneCheck( ), which verify that the router, matrix nodes (APs and EPs), single-hop links and wired/optical backbone, respectively, are operating properly.

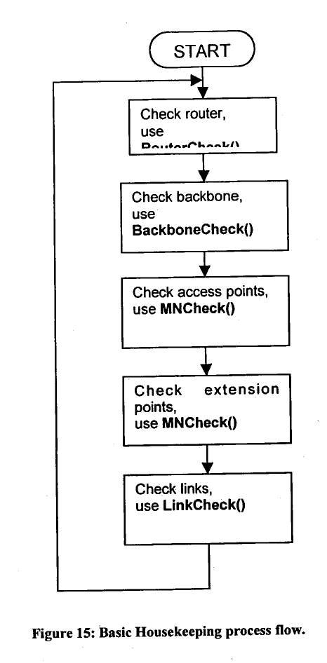

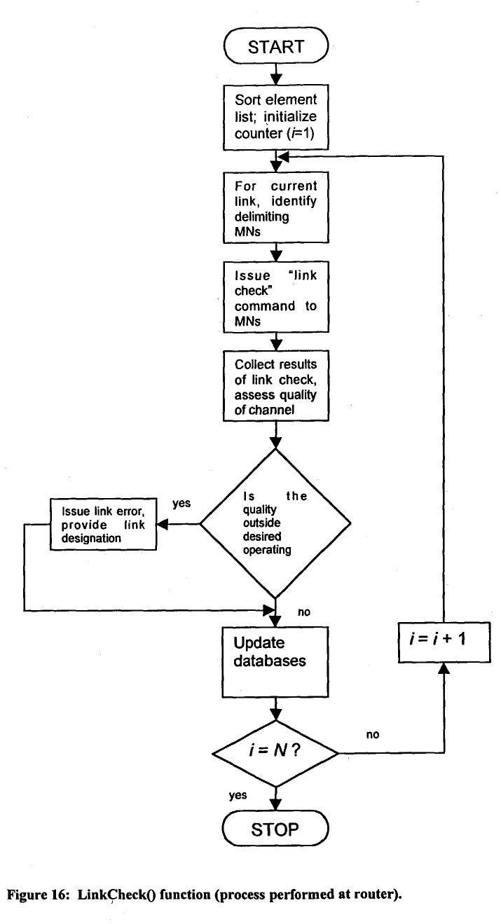

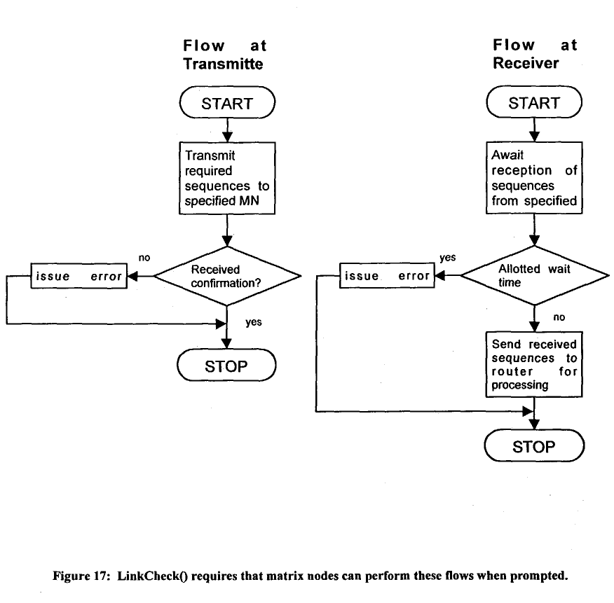

The basic Housekeeping background process flow is given in FIG. 15. We provide flowcharts for LinkCheck( ) at the router and matrix nodes in FIG. 16 and FIG. 17, respectively. The RouterCheck( ) and BackboneCheck( ) functions do not make direct use of the wireless control channel and are therefore not described in detail.

The MNCheck( ) function requires that status information stored at each matrix node (in the parameter list passed to the function) is collected via the control channel. If the information for any node cannot be retrieved, the appropriate errors are generated and action is taken by the error-handling library (for example, the control channel may be re-routed to allow the check to proceed).

1.3.2.2 Error/Interrupt Checking

This main function of this library is to “listen” for error or interrupt events and direct operation to appropriate functions within other libraries. In most cases, a solution to an error can be found in the Error/Interrupt Handling library, which employs Route Planning and LMAC algorithms. Based on the Error/interrupt Look-Up Table, many events can be processed simply by looking up the appropriate action. In some cases, additional information may be required to determine a solution. Thus the library is equipped with functions to investigate certain events in more depth.

1.3.2.3 Communication

This library is primarily concerned with the exchange of control-related information between source and destination fixed elements. Any data associated with the various programmable aspects of the matrix nodes or that is simply designated as being control-oriented, is “marked” as such (usually in a packet header) and handled by a function in this library. There are two main types of control scenarios that we consider:

1. control information originating from the router (bound for a matrix node), and

2. control information originating from a matrix node.

The functions corresponding to each of these cases are ControlRMN( ) and ControlMNR( ), respectively. These functions include control data within their parameter lists, and are described in detail in Figure. Note that the latter function must be executed at a matrix node.

Error-coding techniques (such as forward error correction) or acknowledgement-based methods of communication (conventionally known) are applied in the wireless control channel to help ensure that control information if properly conveyed.

1.3.2.4 Administration

This library handles initialization of the FE Layer and also the addition of fixed elements to an existing network.

Initialization

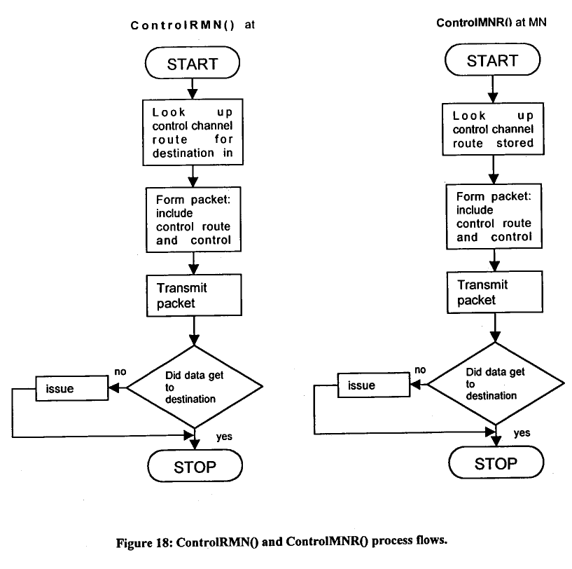

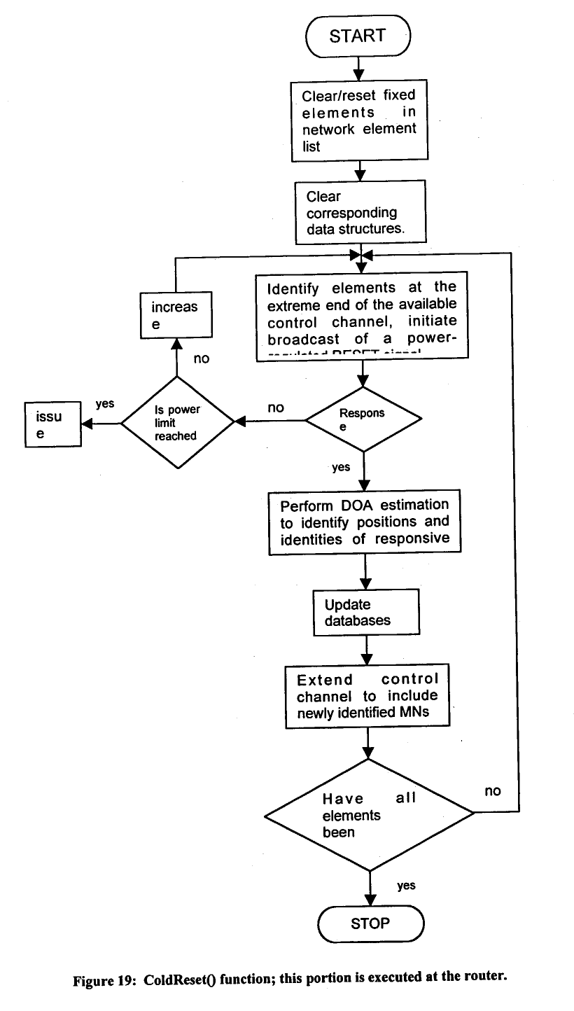

This sub-library contains procedures for setting up all (or a subset of) FE Layer elements and software. In addition, the wireless portion of the control channel is initialized. The two main algorithms in this library are ColdReset( ), revealed in FIG. 18 and FIG. 19, and WarmReset( ). The latter function is a simplified version of the first in which an existing control channel is used for coordination. Both functions restore database entries and direction-of-arrival (DOA) estimates for the matrix nodes passed in via their parameter lists.

Scaling

This set of functions is responsible for the addition of fixed elements, most notably matrix nodes, to the network. The principal function in this library is AddMNs( ), which proceeds much the same way as a reset; new elements transmit low power broadcast signals in the vicinity of an existing network and are registered by calls to functions in the Initialization library. The addresses or serial number of the nodes to be added are passed in the function as parameters.

1.3.2.5 Interface/Error Handling

This library provides functions which respond to requirements from other layers and provide mechanisms for dealing with communication errors.

Route Planning

This set of functions handles data path planning based on requests issued by other functions or layers. For example, a communication error may require re-routing to avoid a blocked link. Or, the SDM Layer may prompt the FE Layer to generate a path from a specific extension point to the backbone; thereafter, all of the user's transmissions are sent along this path barring hand-off or changes in link cost due to interference.

After the route is planned, it is assembled as a packet segment and forwarded to the requesting source. The route is “attached” to the source through record-keeping. This allows the network to provide each user with a fixed or Virtual Fiber Connection™ within the FE Layer. Route planning is accomplished through the use of the Link Database. This data structure is updated through either Housekeeping functions or errors generating new information concerning link status.

In general, routes are generated centrally at the router. Shortest path routing algorithms, such as the well-known Bellman-Ford-Moore algorithm or Dijkstra's algorithm, may be employed to create paths based on the Link Database. Functions in this library include:

PlanPath(<address 1>, <address 2>)

computes a shortest-path route between fixed-element address 1 and fixed-element address 2 using conventional algorithms.

PathCheck(<path designation>)

checks where a planned path may give rise to interference and implements LMAC between affected nodes.

Interchild(<child 1>, <child 2>)

checks for interference conditions between nodes in the same level; the algorithm uses the Network Map (with its angular information) to determine possible interference problems.

Localized Medium Access Control

Functions in this block are applied on a link-by-link basis. Treating each link separately improves the overall efficiency of the network by minimizing the number of users involved in any application of medium-sharing protocols. MAC techniques such as dynamic TDMA, CDMA or FDMA are selected in each case as deemed appropriate or are specified in the function call. Any one of the communication/beamforming processors associated with a MN can be placed into LMAC mode via the adjustment of its settings (through the control channel).

2. Spatial Division Multiplexing (SDM) Layer

2.1 Introduction

The SDM layer sets up and performs communication between matrix nodes and users. This involves beamforming between users and matrix nodes, tracking of users, handoff of users between matrix nodes, addition/deletion of users from the network, power control, error handling, and Localized Medium Access Control (LMAC) when two users are occupying the same spatial channel.

2.2 Structure

The main functions of the SDM layer will now be outlined. These functions are described in detail in Section 2.3.

2.2.1 Functions

The SDM Layer has two basic sets of functions: event-driven functions triggered by events in the network, and background functions.

2.2.1.1 Event-Driven Functions

Scaling

Registration of New Users

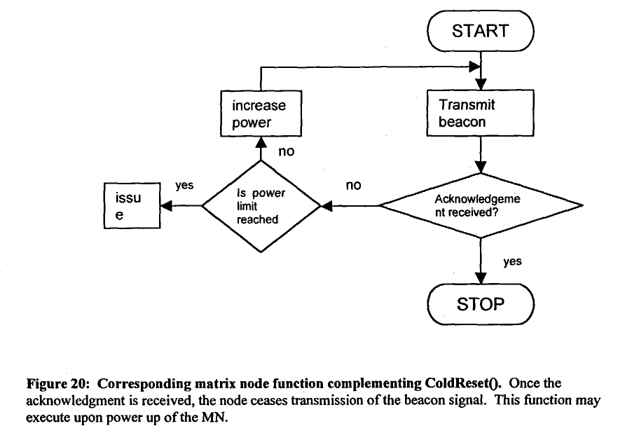

When a new user enters the network and wishes to communicate, as shown in FIG. 20, the network must first identify who the user is, and which matrix nodes the user will be served by. Once this is determined, the user and its associated matrix nodes must beamform to one another. These tasks are all encompassed in the registration process.

LMAC

Localized Medium Access Control (LMAC)

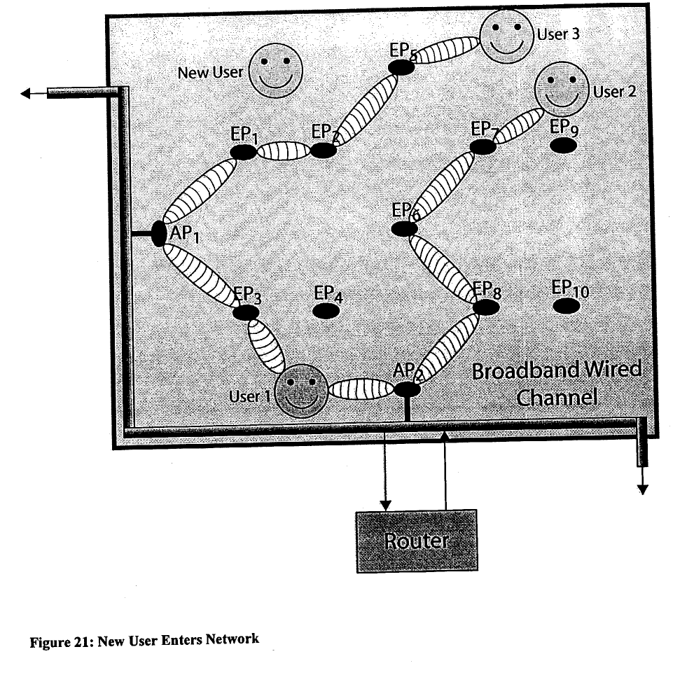

If two or more users are located in space such that a matrix node with which they are both associated cannot resolve them into two separate non-overlapping beams, then they require some form of Medium Access Control (MAC). An example of this situation is shown in FIG. 21, where User 2 and 3 have overlapping spatial channels with Extension Point 7. Because the MAC only affects one spatial channel at one matrix node, it is referred to as Localized MAC (LMAC), a feature that, to the author's knowledge, is novel.

Control

Power Control

An example of a network using power control is shown in

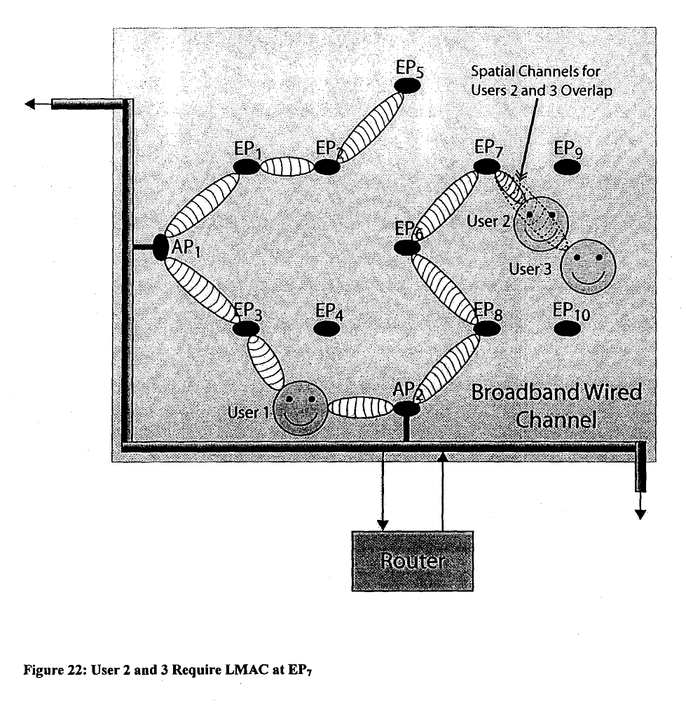

FIG. 22. Power control allows the system to adjust the RF transmit power of various nodes in the network, depending on the required data rates and the transmitter-receiver separations. Power control gives the network flexibility in terms of the separation between matrix nodes. Power control also reduces interference by “turning down” the transmit power of nodes that are transmitting over short distances, and “turning up” those nodes that require high data rates or are transmitting over a large distance.

Unlike conventional power control techniques, this system allows for matrix nodes to simultaneously transmit at different powers in different directions (i.e. on different spatial channels) using beamforming. This feature is, to the author's knowledge, novel.

Adaptive Division Multiplexing (ASDM)

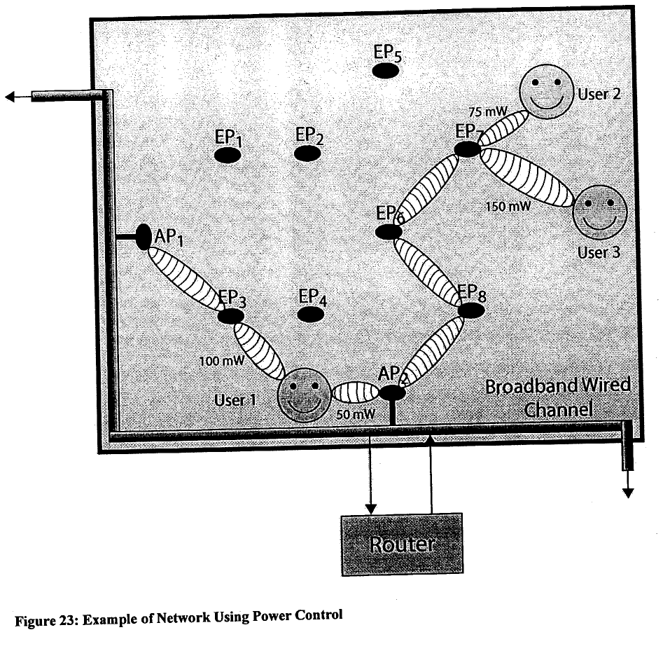

In this invention, data transmission is accomplished by breaking up a single data stream into several parallel data streams, each of which is beamed to the user via a separate extension point. An example of this technique is shown in FIG. 23. At the receiver, beamforming is applied to the received signals to isolate each data “sub-stream”, all of which are combined to recover the original data stream.

In addition, when a data stream is transmitted from the user to the network, the data is again broken up into several parallel data streams, each of which is transmitted to a different matrix node using beamforming. Each receiver matrix node beamforms to the user to recover the data stream, and then forwards the packet to the router through the fixed element network.

The idea of multiplexing data transmission in this manner, using beamforming at both the user and matrix nodes in the context of a Wireless Local Area Network (WLAN) seems to be novel itself, especially where the data is multiplexed in both directions (i.e. on the uplink and downlink).

In addition to multiplexing data transmission into sub-streams, this invention includes the ability for the network to adapt the data rate transmitted on each sub-stream, according to the conditions present on each spatial channel. This is illustrated for User 1 in FIG. 23, where a higher data rate is supported from EP₃, since its channel has lower interference. This aspect of the invention also seems to be novel.

Error Handling

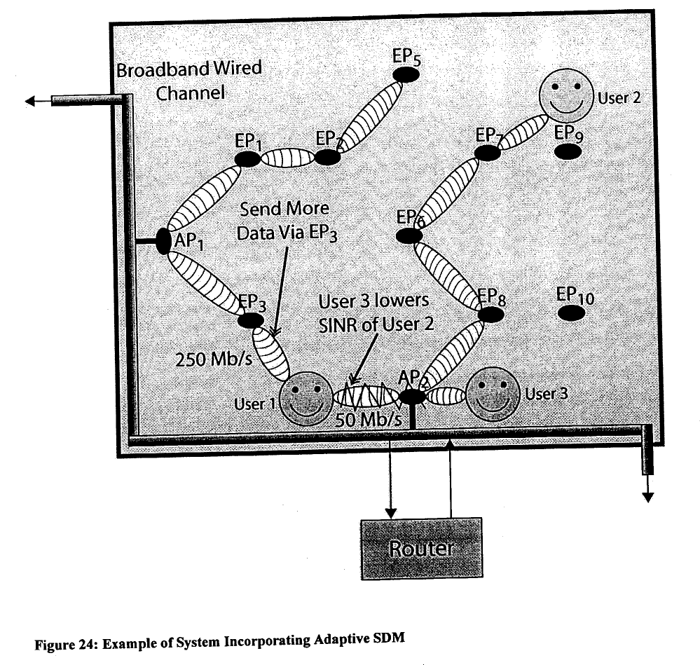

For various reasons, a link between a user and a matrix node could become corrupted, either temporarily (due to multipath fading), or for an extended period of time (due to the introduction of an obstacle, as shown in FIG. 24). In this case, the system must have some means for determining that an error has occurred, as well as a procedure for recovering from the error. This is dealt with by the error handling function. This invention includes an error handling mechanism that takes advantage of the spatial multiplexed nature of the network, a feature that, to the knowledge of the authors, is novel.

Quality of Service and PC/ASDM

Depending on user data-rate requirements, the system can assign different users to two different modes of operation: Power Control (PC) mode, and Adaptive Spatial Division Multiplexing (ASDM) mode. In PC-mode, the system minimizes the transmit power on each of the user's spatial channels subject to a minimum required SINR at the receiver. This mode minimizes the interference generated by the user, but limits achievable data rates. In ASDM-mode, the system maximizes data rates on each of the user's spatial channels, subject to a minimum SINR at the receiver. This mode produces more interference but allows the user to achieve higher data rates.

Data

Data/Control Packet Transmission Between Users and Matrix Nodes

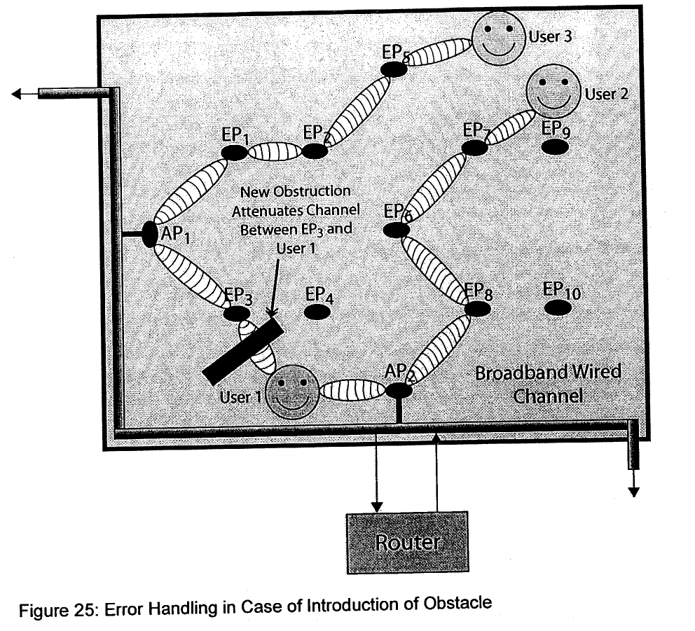

The algorithm used for packet transmission is outlined in FIG. 25. Packet transmission between users and matrix nodes proceeds on the assumption that the beamforming weights required at the transmitter and receiver are up to date (i.e. the tracking function is doing its job correctly). The transmitter simply chooses the set of beamforming weights associated with the destination address from a table frequently updated by the tracking function, and uses these weights to process the data transmitted out of each antenna in its array.

At the receiver, the beamforming processor responsible for forming a beam on the node that is currently transmitting will detect the presence of a signal, and will demodulate and decode the received data stream. There will be negligible presence of the transmitted signal at the output of the other beamforming processors, since they all place nulls in the direction of the transmitting node to reduce interference with the node they are beamforming to.

2.2.1.2 Background Functions

Housekeeping

Remote Beamforming and Tracking of Users

Once a user has been registered, the system must track their movements through the network, as shown in

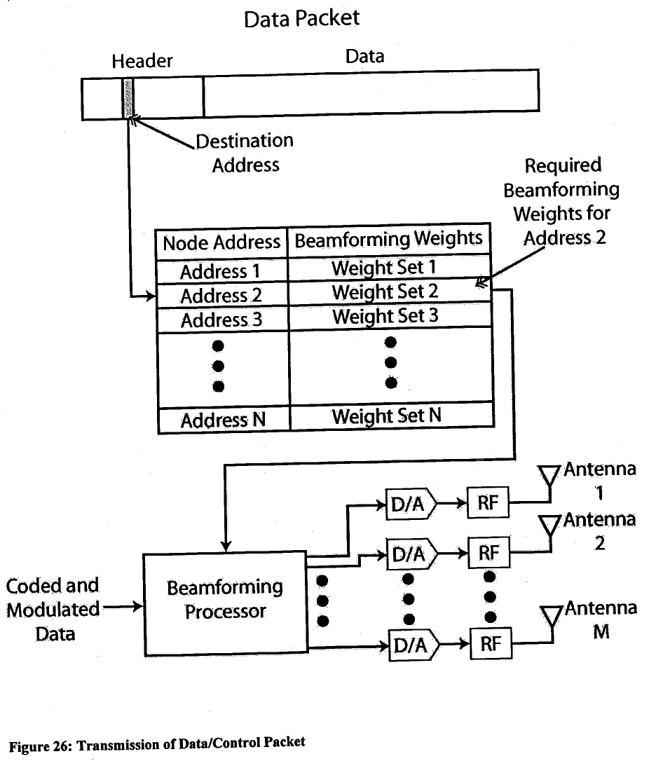

FIG. 26. This involves ensuring that matrix nodes and their associated users maintain a beam on one another, which is referred to as tracking.

All beamforming in the invention is done remotely using data collected at the node of interest, which, to the authors' knowledge, is novel. Essentially, the intensive calculations required in the calculation of beamforming weights are done at a single centralized processor in the router. This reduces the cost and complexity of the matrix nodes and user modules, and conserves battery life.

Handoff

While tracking allows users to remain in contact with the network while moving over relatively short distances, handoff allows users to roam over the entire network without having to re-register. An example of handoff is shown in

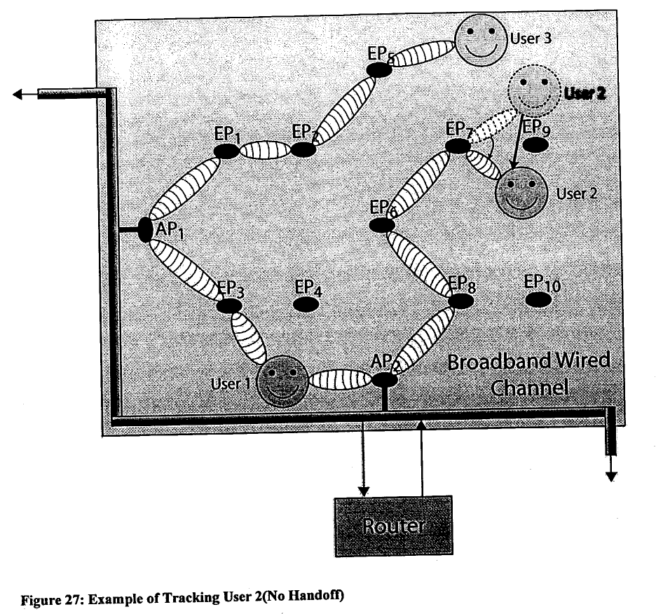

FIG. 27. The handoff function is in charge of assigning users to new matrix nodes as they move out of range of the ones they are currently assigned to. The soft handoff technique used, which is adapted to a network incorporating spatial multiplexing, is, to the author's knowledge, novel.

2.2.2 Databases

The databases required for the operation of the network will now be described. The databases at the router are discussed first, followed by the databases at the matrix nodes and user modules (which are virtually identical in content).

2.2.2.1 Router Databases

The router databases are summarized in

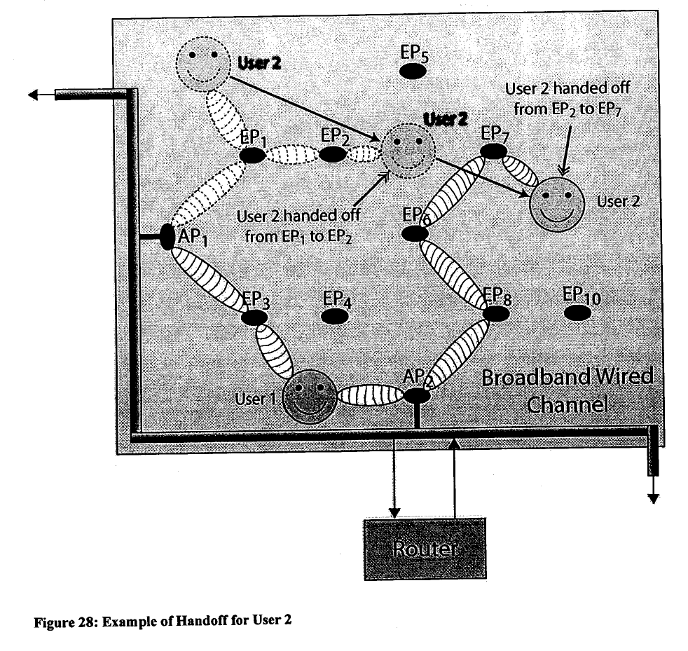

FIG. 28.

Node Assignment

For each node in the network, the router maintains a list of the addresses of all the associated nodes. The associated nodes are Extension Points (EPs), Access Points (APs), or user modules that that are registered with the node. The router also stores the value of N_{channel}_{_{—}}ₘᵢₙ, which is the minimum number of associated matrix nodes the network deems appropriate for a single user.

Node Tracking

For each node in the network, the router maintains a table indicating the beamforming weight sets required to communicate with each of the associated nodes, as well as the angles at which they lie relative to the f. The router also stores the values of T_{update}_{_{—}}ᵢ, which is used to calculate the rate at which node i has its beamforming weights updated. The router also stores the values T_{update}_{_{—}}ₘₐₓ and T_{update}_{_{—}}ₘᵢₙ, which are the maximum and minimum values that T_{update}_{_{—}}ᵢ can take, respectively. The router also stores the value of N_{BF}, which is the number of samples taken at each antenna when a node is collecting data for remote beamforming.

LMAC

For each node in the network, the router maintains a table indicating whether the node must use LMAC when communicating with each one of its associated nodes. The router also stores the value of Δθ_{BF}, which is the minimum angular separation two associated nodes must have relative to a given node to avoid having to using LMAC.

Node SINR

For each node in the network, the router maintains a table indicating the latest receiver SINR measurements from each of the associated nodes. In addition, the router stores a list of possible operating SINRs and the corresponding achievable data rates. It also stores the value SINRₘᵢₙ, which is the minimum received SINR required for communication at the lowest data rate on the network. The router stores the value of N_{drop}. If a user's receive SINR from one of its associated nodes remains below SINRₘᵢₙ N_{drop} weight updates in a row, the user is dropped from the associated node.

Transmit Power

For each node in the network, the router maintains a table indicating the current transmit power used when communicating with each of the associated nodes. In addition, the router maintains a list of all possible transmit powers.

Data Rates

For each node in the network, the router maintains a table indicating the current transmit and receive data rates for each associated node. In addition, the router maintains a list of all possible data rates, and how they are achieved (i.e. coding, modulation, symbol rate, etc).

Operation Mode

The router maintains a table indicating what mode (PC or ASDM) each user is operating in.

Routing Information from Fixed Element Layer

For each user in the network, the router maintains a table indicating the required header information for a packet to be sent to the user via each one of its associated matrix nodes.

2.2.2.2 User and EP/AP Databases

The node databases are the same as the router databases, except that only information pertaining to the node is maintained. The node databases are summarized in

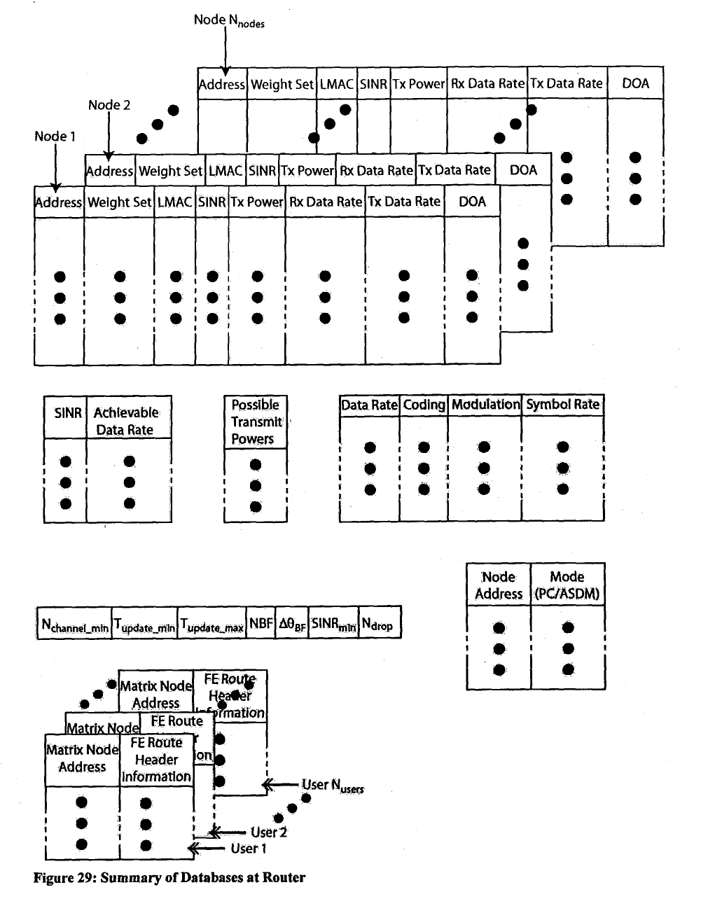

FIG. 29.

Node Assignment

Each node in the network maintains a list of the addresses of all its associated nodes. Each node also stores the value of RSSₘᵢₙ, which is the minimum received signal strength from a new user's Request For Access (RFA) that will cause the node to forward an RFA Response packet to the router, and thus attempt to register the new user. Each node also stores the value of T_{RFA}_{_{—}}_{Monitor}, which is the time between successive tests for the presence of an RFA (and hence a new user in the vicinity). User modules also store values for T_{RFA}_{_{—}}_{Talk} and T_{RFA}_{_{—}}_{Listen}, which is the length of each RFA transmission, and the time between successive RFA transmissions, respectively.

Node Tracking

Each node in the network maintains a table indicating the beamforming weight sets required to communicate with each of its associated nodes, as well as the angles at which they lie relative to themselves. Each node also stores the value of N_{BF}, which is the number of samples taken at each antenna when the node is collecting data for remote beamforming. The user modules also store the value of T_{RFH}, which is the length of the Request For Handoff (RFH) signal transmitted when the user wishes to find new associated nodes.

LMAC

Each node in the network maintains a table indicating whether the node must use LMAC when communicating with each one of its associated nodes.

Node SINR

Each node in the network maintains a table indicating the latest receiver SINR measurements from each of its associated nodes.

Transmit Power

Each node in the network maintains a table indicating the current transmit power used when communicating with each of its associated nodes. In addition, each node stores a list of all possible transmit powers.

Data Rates

Each node in the network maintains a table indicating the current transmit and receive data rates for each of its associated nodes. In addition, each node maintains a list of all possible data rates, and how they are achieved (i.e. coding, modulation, symbol rate, etc).

Error Handling

Each node in the network stores the value of Nₑᵣᵣₒᵣ, which is the number of re-transmissions that will be attempted on a link before giving up.

Operation Mode

Each user keeps track of which mode (PC or ASDM) it is operating in.

Routing Information From Fixed Element Layer

Each user in the network maintains a table indicating the required header information for a packet to be sent to the router via each one of its associated matrix nodes.

2.3 Operation

The operation of the invention will now be described.

2.3.1 Registration of New Users

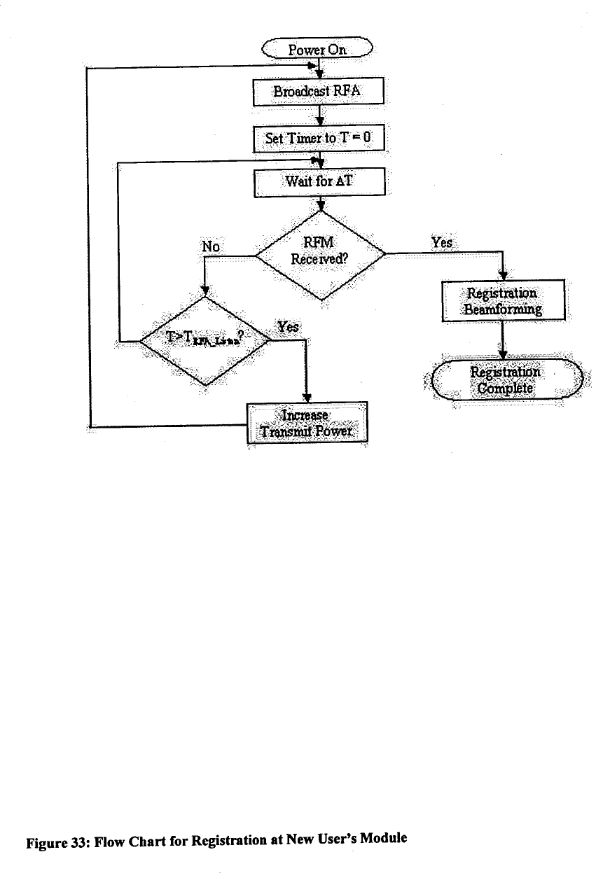

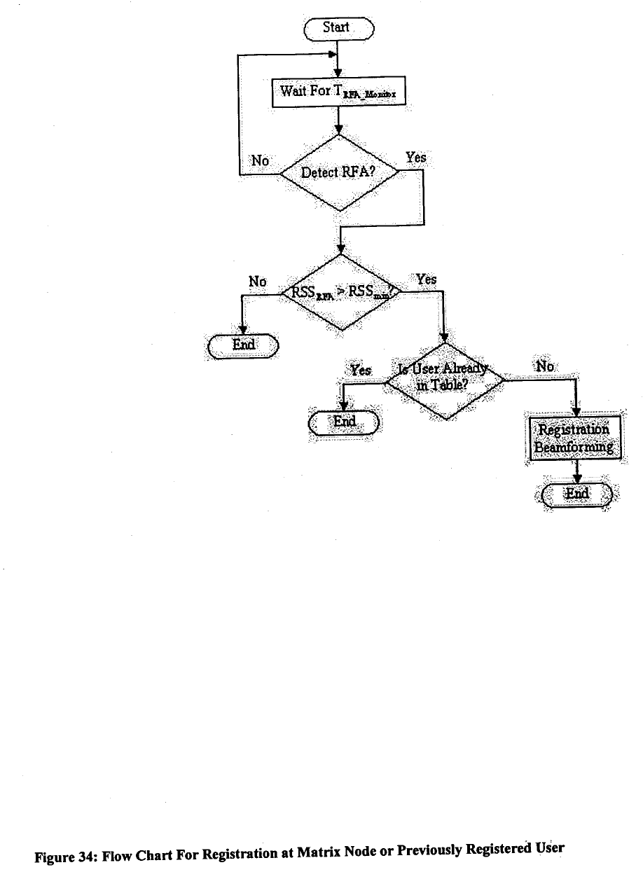

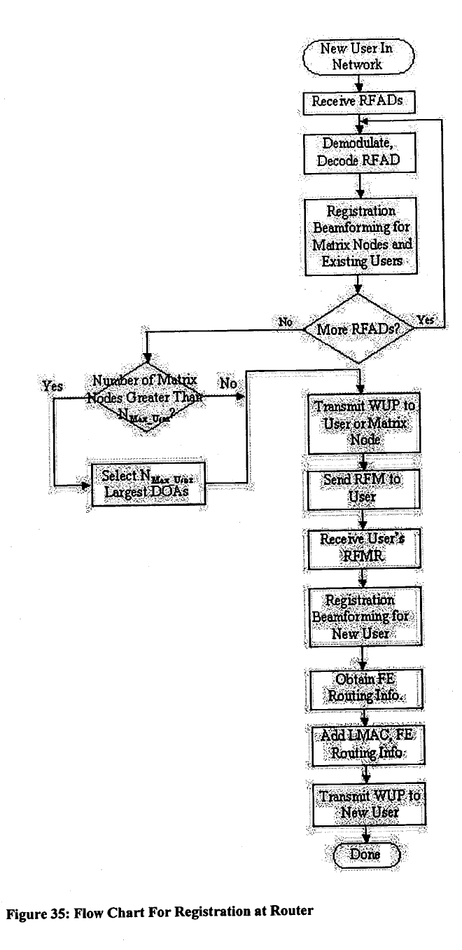

The flow charts for the registration process are shown in FIG. 33, FIG. 34, and FIG. 35 for the new user's module, surrounding matrix nodes and users, and the router, respectively.

Request for Access Signal

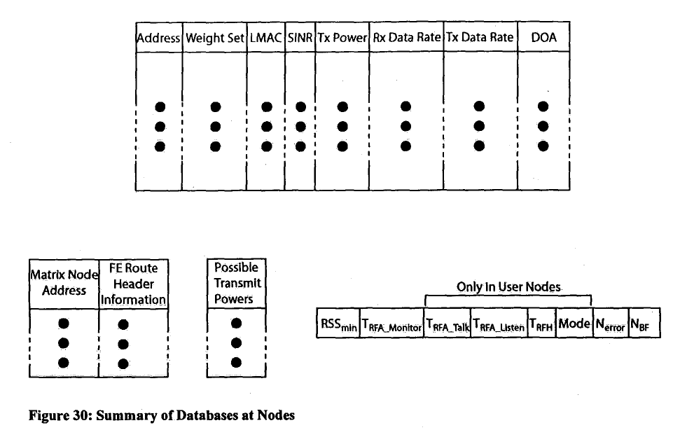

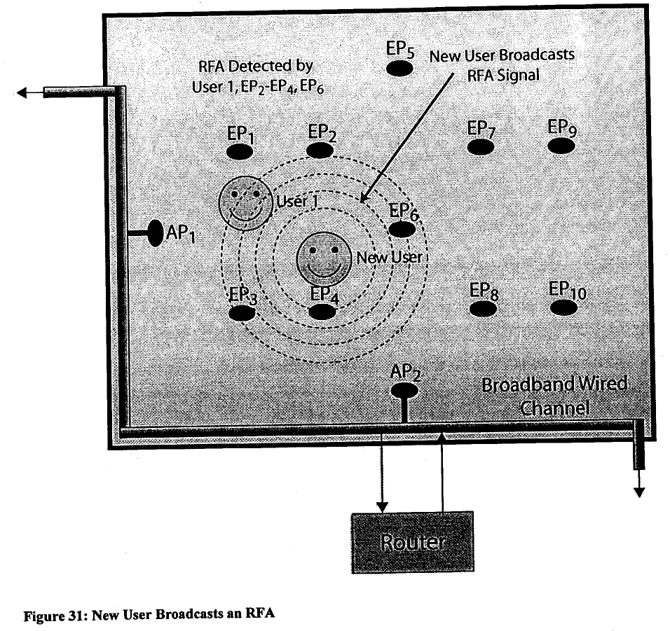

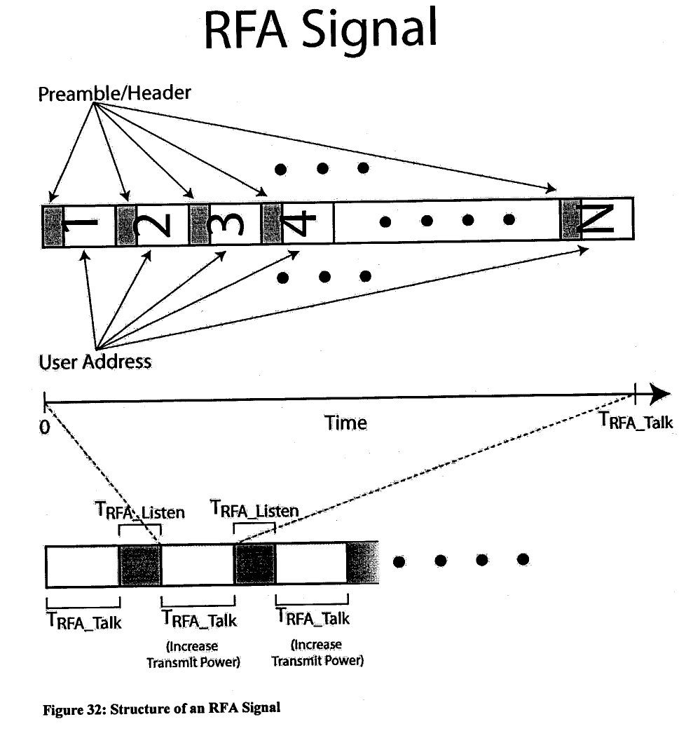

When a new user enters the network and activates their device, they must register with the network before they can communicate. This is facilitated by introducing a Request For Access (RFA) signal, which is broadcasted by the new user in all directions using a single antenna, as shown in FIG. 30. The RFA signal, shown in FIG. 32, is a repeating sequence of the new user's address, spread by a spreading code that has low cross-correlation with any other spreading codes that may be used on the network. If users on the network are synchronized, orthogonal spreading codes (maximal-length sequences, Walsh sequences, etc), otherwise low cross-correlation codes should be used (e.g. Kawami sequences, Gold sequences, etc). For a review of spreading codes see E. Dinan, B. Jabbari, “Spreading Codes for Direct Sequence CDMA and Wideband CDMA Cellular Networks”, IEEE Communications Magazine, September 1998, pg. 48-54. This RFA spreading code is shared among all users. The RFA is broadcast for a fixed length of time (T_{RFA}_{_{—}}_{Talk}), after which the mobile unit waits for a response from a matrix node for a fixed length of time (T_{RFA}_{_{—}}_{Listen}). If no response arrives, the user increments their transmit power by one level and transmits another RFA signal (see FIG. 33).

Detection of RFA Signal by Matrix Nodes and Nearby Users

Each node monitors the output of N_{RFA} of their antennas. The output of each of the N_{RFA} antennas is correlated with the RFA PN sequence. All signals except those spread by the RFA PN sequence are reduced to noise, while the RFA signal produces periodic spikes at the output of the correlator with a period equal to the length of the FRA PN code.

The node can use a single antenna to detect the RFA (N_{RFA}=1), or can employ diversity combining techniques using several antennas.

Each matrix node monitors the channel for an RFA every T_{RFA}_{_{—}}_{Monitor} seconds. If an RFA is present, the RFA timing recovery circuitry locks to the periodic spikes at the output of the correlator (see B. Bing, High-Speed Wireless ATM and LANS, Boston: Artech House Publishers, 2000, pg. 24-39) and the correlator is sampled at the peak of each spike. The matrix node then calculates the mean square value of these samples to determine the Received Signal Strength for the RFA (RSS_{RFA}). If the RSS_{RFA} is larger than some threshold (RSSₘᵢₙ), the matrix node decodes the RFA signal to find the new user's address (see FIG. 34). It then checks whether it is currently associated with the new user (this is done to facilitate handoff, as described in Section 2.3.6). If it is not associated with the user (it will not be if the user is new) the matrix node begins storing samples at each antenna output. After collecting N_{BF} samples, the matrix node places them in a packet, along with RSS_{RFA} value and its own address, and sends the packet to the router. This packet is called the RFA Detected (RFAD) packet.

Meanwhile, nearby users, who are equipped with similar RFA monitoring circuitry, detect the RFA signal. If the RSS_{RFA} is large enough, these users send an RFAD signal back to the router via a nearby matrix node after the RFA has stopped (see FIG. 34).

Alternatively, the user could transmit the RFA using frequency-hopped spread spectrum (FHSS), or the system could have a narrow bandwidth reserved for RFA signals (frequency division multiplexing, or FDM).

Processing of RFAD Packets by Router

The RFADs are processed by the registration beamforming function as described in Section 2.3.2.1 to update existing weight sets, and to add a weight set allowing each node to beamform to the new user. Finally, the function calculates the weights required by the new user to communicate with each of its associated matrix nodes, as shown in FIG. 35.

The resulting beamforming weights are used to generate the user's table. The function calls on the FE Layer to determine the header information required to send information from the new user back to the router, as well as from the router to the new user. The weights are sent to the user in a Weight Update Packet after adding LMAC and FE routing information.

2.3.2 Remote Beamforming and Tracking of Users

In order to reduce the cost and power consumption of the matrix nodes and of the user modules, all calculation of beamforming weights is done at the router. The router distributes the weights to the users and matrix nodes, where they are used to perform a weighted sum of all the antenna signals, as shown in Equation 1.2.1.

$${y}_{n} = {\sum }_{k = 1}^{N} {x}_{k , n} {w}_{k}^{*} \qquad Eq . 1.2 .1$$

Where yₙ is the n'th beamformed output sample, x_{k,n} is the n'th output sample from antenna k, and wₖ is the beamforming weight for antenna k.

There are two distinct operation modes for remote beamforming in this invention. The first is registration-mode remote beamforming, which is the process by which matrix nodes and new users first beamform to one another. The second mode is tracking mode, where matrix nodes and users maintain beams on one another while the users move through the fixed network.

2.3.2.1 Remote Beamforming at Registration

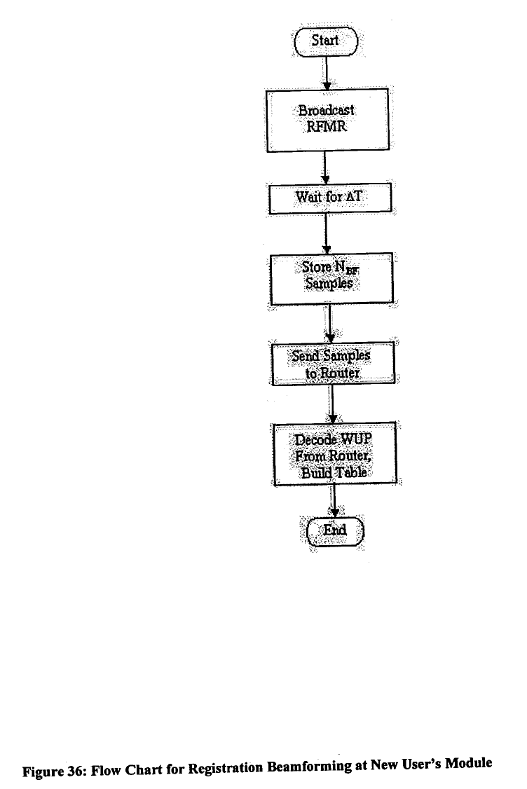

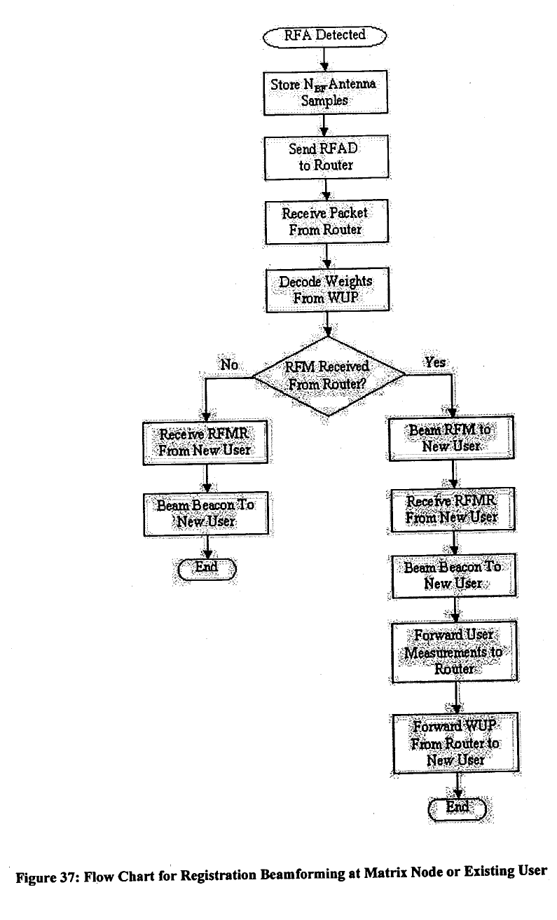

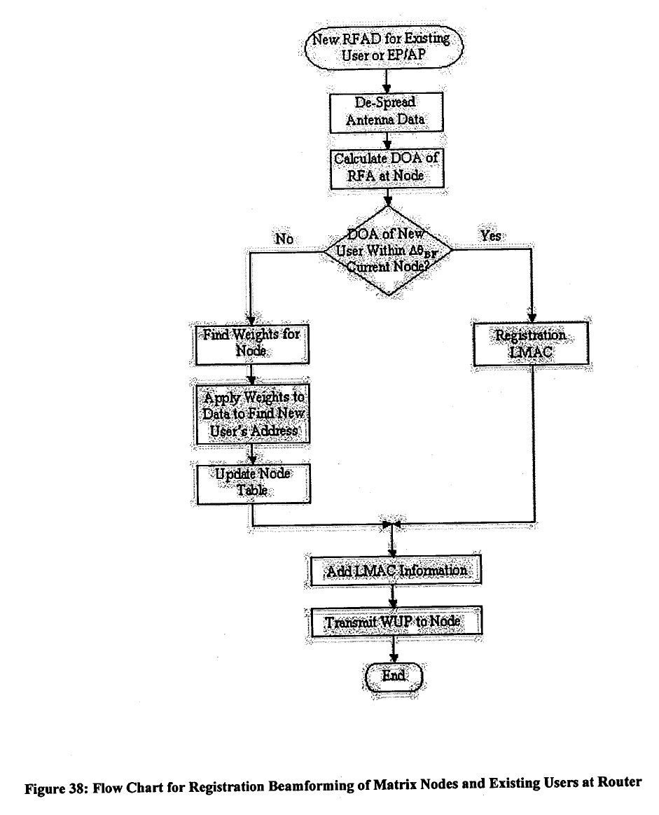

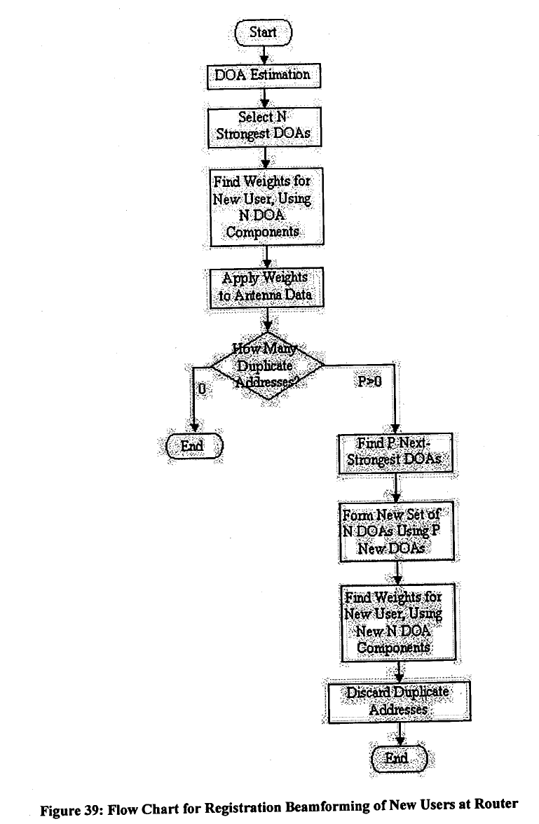

The flow charts for remote beamforming at registration are shown in FIG. 36, FIG. 37, FIG. 38, and FIG. 39 for new users, surrounding users and matrix nodes, the router with respect to the new user, and the router with respect to surrounding nodes, respectively.

a) Updating Beamforming Weights for Existing Users and Matrix Nodes

If a new user becomes active, the user module broadcasts an RFA, causing several users and matrix nodes to send N_{BF} samples of each antenna to the router in an RFAD packet. The value of N_{BF} depends on what beamforming algorithm or DOA estimation algorithm is used, in that different algorithms require different numbers of samples to reach steady state.

For each RFAD received (from node i, which for now we assume is a matrix node), these sets of N_{BF} antenna samples are each decoded by the router, which then correlates each antenna output data stream with the RFA spreading code. This has the effect of reducing signals other than the RFA to noise (assuming the RFA spreading code has low cross-correlation with all other spreading codes in the system), leaving only the RFA signal on each antenna. These processed antenna signals are then fed into a processor that implements a DOA estimation algorithm such as ESPRIT or MUSIC (refer to H. Krim, M. Viberg, “Two Decades of Array Signal Processing Research”, IEEE Signal Processing Magazine, July 1996, pg. 67-94 for a review of DOA estimation techniques). If this DOA is too close to that of another node (fixed or user) currently associated with node i then a Localized Medium Access Control (LMAC) algorithm is invoked (see FIG. 38), as described in Section 1.2.3.3a. For this section, it will be assumed that the new user has a wide angular separation from all other users and matrix nodes.

Once the DOA of the new user is known, it is added to the table for node i. To calculate the beamforming weights to allow node i to communicate with the new user, the router references the DOA information stored in node i's table. The DOA can be used in conjunction with a beamforming algorithm such as Linearly-Constrained Minimum Variance (LCMV). In this case, the router could minimize the output power of node i's antenna array, subject to the formation of a lobe with a specified gain in the direction of the new user, and the formation of nulls towards all other users or matrix nodes with which node i communicates (refer to B. Van Veen, K. Buckley, “Beamforming: A Versatile Approach to Spatial Filtering”, IEEE ASSP Magazine, April 1988, pg. 4-24 for a review of beamforming techniques). In addition, the beamforming weights to communicate to other nodes must be altered so that a null is formed in the direction of the new user, in addition to any existing nulls and lobes in the beam. Once all the new weights have been calculated, they are transmitted to node i, where they are stored in its database (see FIG. 38).

If node i is a user module, a similar procedure is followed at the router. If the system allows users to communicate directly with one another, a new set of weights must be added node i's table (a set of beamforming weights that allow node i to communicate directly to the new user) and all existing sets of beamforming weights must be adjusted to add a null in the direction of the new user. Otherwise, no new weight sets are added, and the existing weight sets are adjusted to form a null in the direction of the new user.

b) Calculating Beamforming Weights for New User

Once the surrounding nodes (users and matrix nodes) have beamformed to the new user, the router sends a Request For Measurement (RFM) signal to the user via a nearby matrix node. Upon receipt of the RFM, the user broadcasts a RFM Response (RFMR) signal in all directions (see FIG. 36). Upon receipt of this signal, each node that has the new user's address in its table beams a beacon at the user. This beacon consists of the address of the source repeated a specified number of times.

The user saves N_{BF} samples of each antenna, starting some amount of time after transmitting the RFMR signal (this delay allows for all users and matrix nodes to begin sending their beacon). After the beacons end, the user places the antenna samples in a packet, and sends it to the router via a nearby matrix node (see FIG. 36). The user addresses the packet with the source address of the RFM (ie. the address of the matrix node that sent the RFM to the new user). This ensures that, although all nearby users and matrix nodes will receive the packet, only one matrix node will return the packet to the router.

When the router receives the user's packet, it must determine which matrix nodes and existing users the new user will communicate with, and what beamforming weights the user will need for each of them. This can be accomplished by the following steps (see FIG. 39):

i) Perform DOA estimation on the received data using some suitable algorithm (MUSIC with spatial smoothing, MUSIC with beamspace processing, Weighted Subspace Fitting, etc.), and extract the N strongest DOAs, where N is the number of beamforming processors on each user module.

ii) Next, calculate N sets of beamforming weights using some suitable beamforming algorithm (LCMV, GSC, etc), such that weight set j forms a lobe on DOA j, and a null on all others. Finally, apply each weight set to the received signal to determine the node addresses arriving from each DOA.

iii) If any of the DOAs from part 1) are the result of pure multipath, then some of the DOAs will be from the same EP/AP address. If P of the DOAs are from duplicate addresses to the remaining N-P distinct addresses, then find the P next strongest DOAs, and repeat part ii), substituting the new P DOAs for the duplicate ones from the original set. If any of the DOAs in this new set turn out to be from duplicate addresses, then for each set of duplicates, select the strongest DOA and discard the rest.

2.3.2.2 Remote Beamforming for Tracking of Users

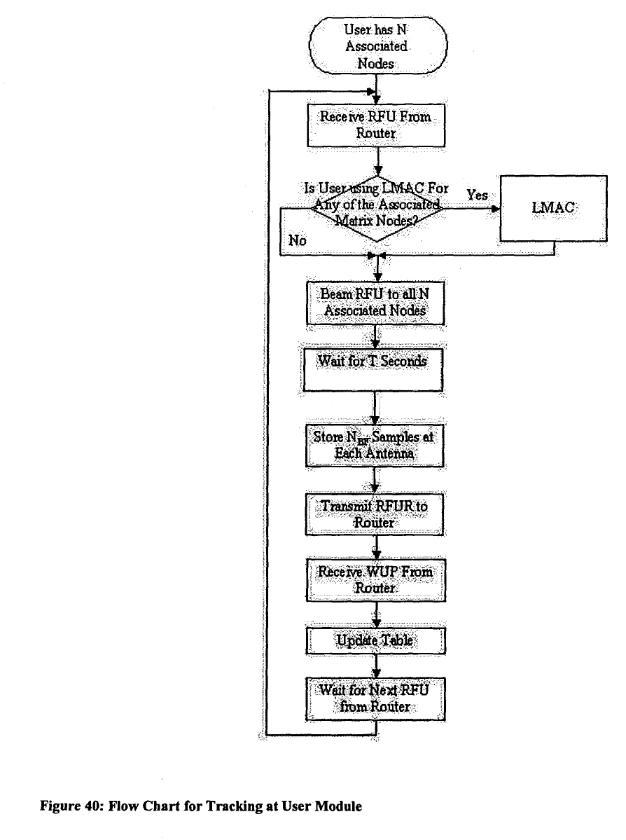

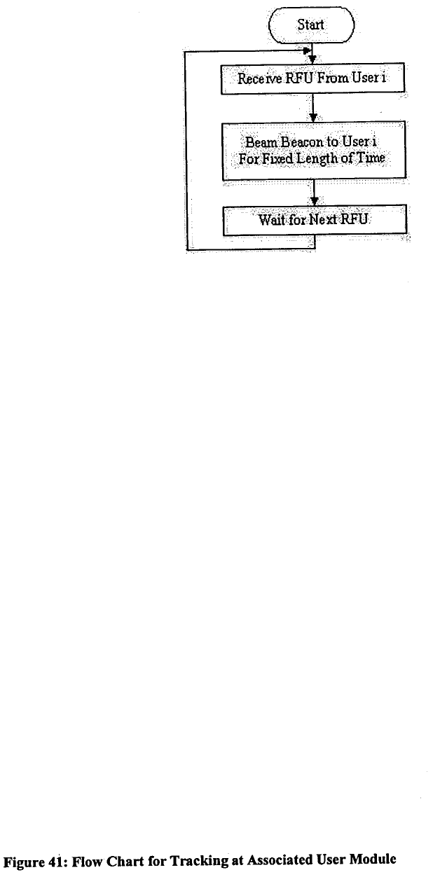

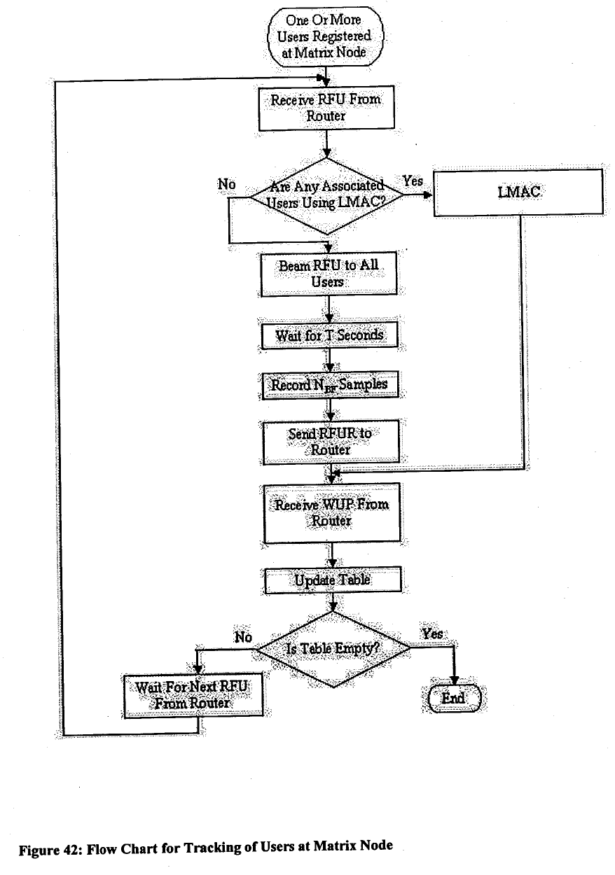

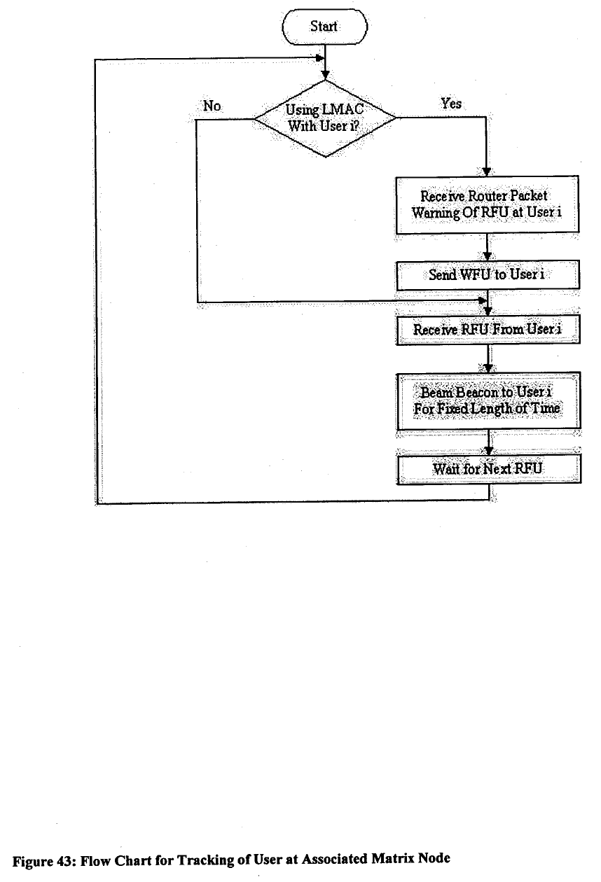

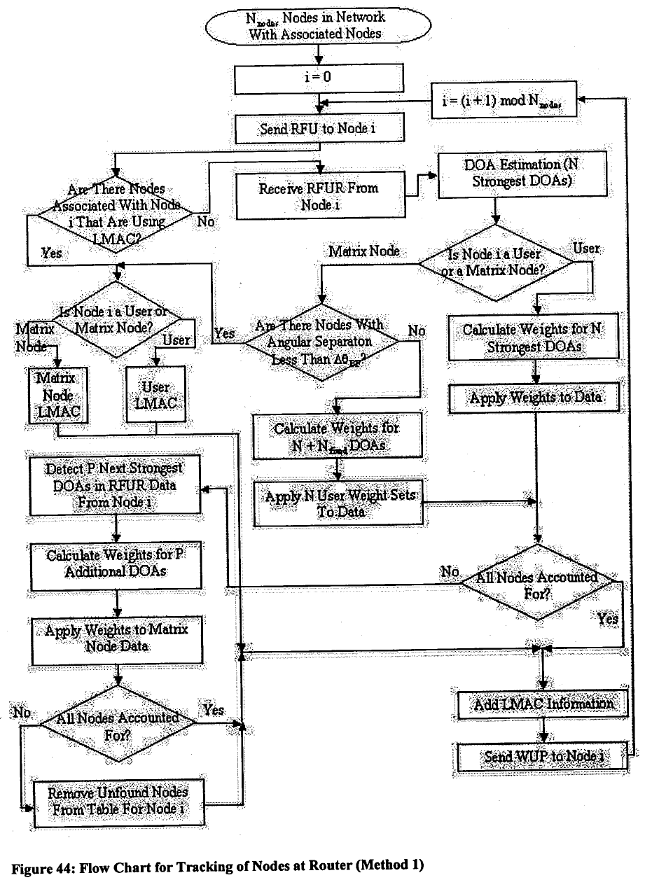

The flow charts for remote beamforming for tracking are shown in FIG. 40, FIG. 41, FIG. 42, FIG. 43, and FIG. 44 for a user module being updated, a user associated with the node being updated, a matrix node being updated, a matrix node associated with the user being updated, and the router, respectively.

Once a user is registered and is assigned to a group of matrix nodes, the system must track the user, to ensure that all nodes are supplied with up-to-date beamforming information, which changes depending on where the user is located.

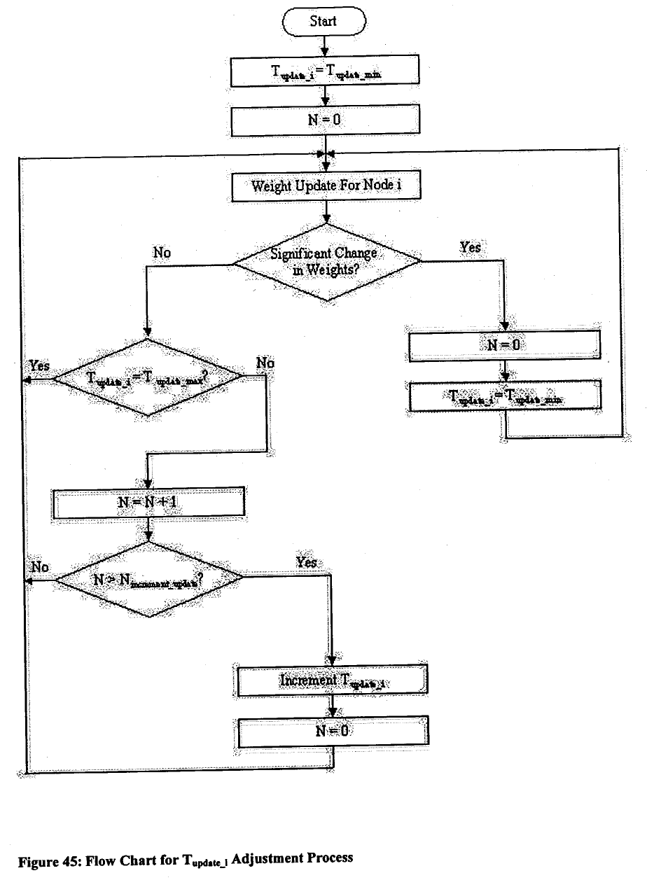

The system updates the nodes in the network by sweeping through each node that has associated users one at a time, at such a rate that node i is updated every T_{update}_{_{—}}ᵢ seconds. The flow chart for the process of controlling the value of Tupdate_i is shown in FIG. 45. If the beamforming weights for node i have not changed significantly in a large number of updates (N_{increment}_{_{—}}_{update}), then T_{update}_{_{—}}ₗ is incremented. T_{update}_{_{—}}ᵢ eventually saturates at T_{update}_{_{—}}ₘₐₓ if it is incremented many times. If T_{update}_{_{—}}ᵢ is not equal to its minimum value and a significant change occurs in the weights of node i, T_{update}_{_{—}}ᵢ is reset it its minimum value.

Tracking beamforming proceeds in two possible ways, depending on whether node i is a user or a fixed node.

a) Updating of Matrix Node Weights

To initiate the updating process, the router sends a Request For Update (RFU) packet to the matrix node. For this discussion, assume that the matrix node has N_{fixed} associated matrix nodes. The matrix node, after completing all unfinished packet transmissions, simultaneously beams all associated users an RFU packet (see FIG. 42). Upon receipt, each user beams a beacon consisting of its address repeated a fixed number of times to the matrix node. After waiting for a pre-determined amount of time, the matrix node records N_{BF} samples of each antenna output, and forwards them to the router in an RFU Response (RFUR) packet. If the matrix node has associated nodes using LMAC, a tracking LMAC function is started upon receipt of the RFU at the router, instead of the above steps (see FIG. 42).

When the router receives the RFUR packet, it must calculate the beamforming weight sets for the matrix node (which has N associated users and N_{fixed} associated matrix nodes). This can be accomplished in several ways, including (but not limited to):

1) Preferred Embodiment (see FIG. 44)

i) Perform DOA estimation on the received data using some suitable algorithm (MUSIC with spatial smoothing, MUSIC with beamspace processing, Weighted Subspace Fitting, etc.), and extract the N strongest DOAs, where N is the number of users the matrix node is assigned to. Note that the associated matrix nodes do not transmit beacons during the weight update, since their DOAs remain constant.

ii) Next, calculate N+N_{fixed} sets of beamforming weights (i.e. a set to allow the matrix node to beamform to each of its N associated users and N_{fixed} associated matrix nodes) using some suitable beamforming algorithm (LCMV, GSC, etc), such that weight set j forms a lobe on DOA j, and a null on all others. Finally, apply each weight set to the received signal to determine the user addresses arriving from each DOA. If any of these DOAs lie too close to one another or are to close to any matrix node DOA, a Local Medium Access Control (LMAC) algorithm is initiated for the users and matrix nodes at these angles, as described in Section 2.3.3

iii) If any of the users associated with the matrix node do not turn up in this process, then the router reads in the next P strongest DOAs (where P is some fixed number), and re-calculates the weights taking these additional P DOAs into account. The P new weight sets are applied to the received signal, and the resulting signals are decoded. Any users that have not turned up at this point are disassociated with the matrix node and are removed from the table.

2) Alternative Embodiment 1

i) Use beamspace processing to limit the angle over which the DOA estimation algorithm searches (thus reducing computational complexity), and apply a suitable DOA estimation algorithm to the resulting processed signal. This process is repeated for each user. For a description of this technique refer to K. Buckley, X. Xu, “Spatial-Spectrum Estimation in a Location Sector”, IEEE Transactions on Acoustics, Speech, and Signal Processing, November 1990, pg. 1842-1852.

ii) Once the DOAs are known, proceed with step 1 ii).

3) Alternative Embodiment 2

i) Avoid the DOA estimation step altogether by using reference-signal based beamforming. This can be done, since the router already knows each beacon signal. All beacons must be chosen to have low correlation in order for this technique to work properly. Refer to B. Van Veen, K. Buckley, “Beamforming: A Versatile Approach to Spatial Filtering”, IEEE ASSP Magazine, April 1988, pg. 4-24 for a description of reference-signal based beamforming.

Whichever DOA/beamforming algorithm is used, the resulting beamforming weights are used to update the matrix node table, and the router transmits the new weights to the matrix node in a Weight Update Packet (WUP) after adding LMAC information.

a) Updating of User Weights

As in the case of the matrix node, the router sends a Request For Update (RFU) to the user to initiate the update process. For this discussion, assume that the user has N associated nodes (matrix or user). The user, after completing all unfinished packet transmissions, simultaneously beams all N associated nodes an RFU packet (see FIG. 40. Upon receipt, each node beams a beacon consisting of its address repeated a fixed number of times to the user. After waiting for a pre-determined amount of time, the user records N_{BF} samples of each antenna output, and forwards them to the router in an RFU Response (RFUR) packet. If the user has associated nodes using LMAC, a tracking LMAC function is started upon receipt of the RFU at the router, instead of the above steps (see FIG. 40).

When the router receives the RFUR packet, it must calculate the beamforming weight sets for the user. This can be accomplished in several ways, including (but not limited to):

1) Preferred Embodiment (see FIG. 44)

i) Perform DOA estimation on the received data using some suitable algorithm (MUSIC with spatial smoothing, MUSIC with beamspace processing, Weighted Subspace Fitting, etc.), and extract the N strongest DOAs, where N is the number of nodes the user is assigned to. Note that the associated nodes do transmit beacons during the weight update, since their DOAs may change.

ii) Next, calculate N sets of beamforming weights using some suitable beamforming algorithm (LCMV, GSC, etc), such that weight set j forms a lobe on DOA j, and a null on all others. Finally, apply each weight set to the received signal to determine the node addresses arriving from each DOA

iii) If any of the nodes associated with the matrix node do not turn up in this process, then the router reads in the next P strongest DOAs (where P is some fixed number), and re-calculates the weights taking these additional P DOAs into account. The P new weight sets are applied to the received signal, and the resulting signals are decoded. Any nodes that have not turned up at this point are disassociated with the user and are removed from the table. The user is then also removed from their tables.

Whichever DOA/beamforming algorithm is used, the resulting beamforming weights are used to update the user table, and the router transmits the new weights to the user in a Weight Update Packet (WUP) after adding LMAC information.

2.3.3 Localized Medium Access Control (LMAC)

Under normal operation, the network provides each user with one or more spatial channels that do not interfere with any other user. However, depending on the orientation of users relative to a matrix node, two or more users may have overlapping spatial channels, as shown in FIG. 21. In such a case, some sort of LMAC process is required to mediate between the interfering users and the matrix node.

There are two cases that the LMAC function must cover: the first is the case of a new user wishing to register with the network while standing in an interfering location, while the second covers a registered user roaming into an interfering location. A third case is when a user is handed off to a new matrix node in such a way that they are now interfering with another user. This case is dealt with in the same manner as in registration.

a) Registration of an Interfering User

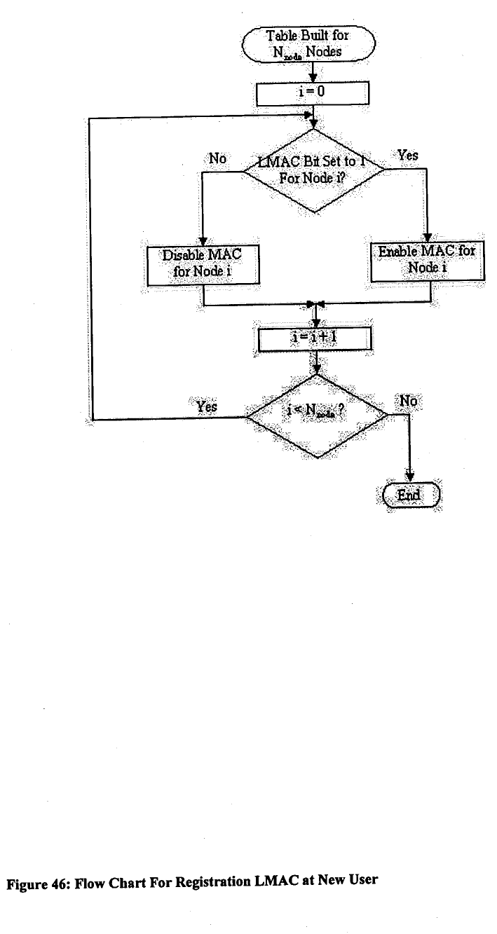

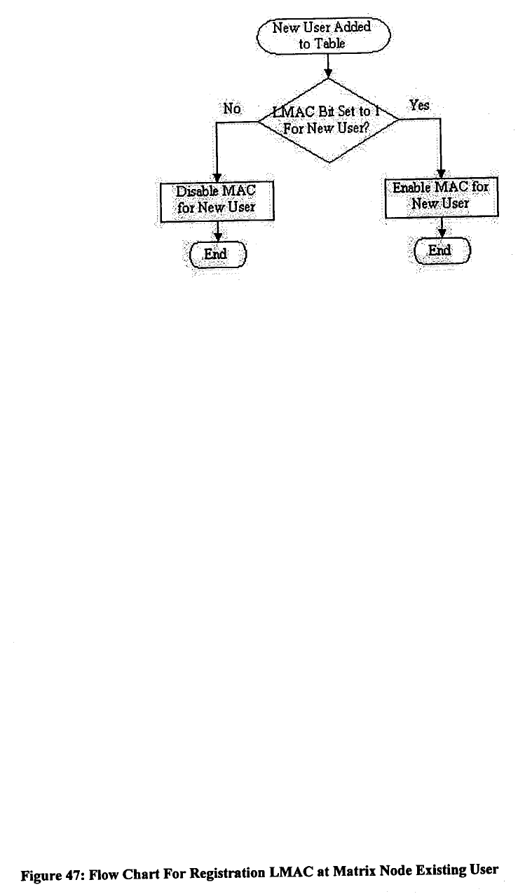

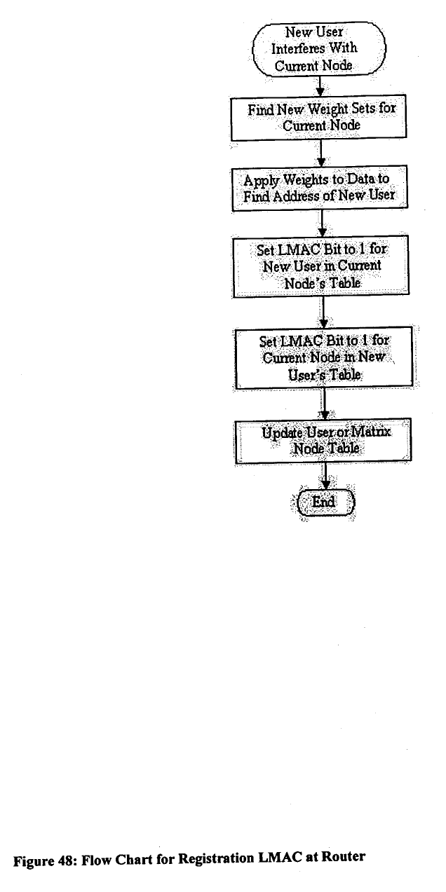

The flow charts for registration LMAC are shown in FIG. 46, FIG. 47, and FIG. 48 for a user module, matrix node or existing user, and the router.

In this case, the new user broadcasts an RFA (Request For Access) signal, which is detected by all surrounding nodes (users and matrix nodes), including the matrix node where LMAC will have to be performed (EP/APᵢₙₜ). This EP/APᵢₙₜ records samples of each antenna output and sends these to the router in an RFAD (RFA Detected) packet. Shortly thereafter (after the RFA signal has stopped) the interfering user will also send an RFAD to the router as well.

When the router performs DOA estimation on the EP/APᵢₙₜ packet, it will check if the DOA of the new user coincides (lies within a range Δθ_{BF}) with the current DOA of any other users at EP/APᵢₙₜ. If it finds an interference condition, it will indicate that EP/APᵢₙₜ should incorporate LMAC when communicating with any of the affected users, whose addresses will be included in the message.

The interfering user's RFAD packet is similarly processed, and the router sends the user their updated weights. In the same packet, the router indicates to the user that they must use LMAC when communicating with EP/APᵢₙₜ.

The beamforming weights are then calculated through the normal registration process. However, when the router sends the new user its weight sets, it also indicates to the user must use LMAC when communicating with EP/APᵢₙₜ.

The LMAC function can use any well-known MAC technique (TDMA, FDMA, CDMA, modified CSMA-CA as in IEEE 802.11, etc.). The only difference is that the MAC algorithm is localized to a specific spatial channel, so that while a user may need to use an LMAC in one direction (i.e. on one spatial channel), it may not need to on others. Also, the LMAC may only be temporary if the users are in motion. If, on the next weight update at EP/APᵢₙₜ it is found that EP/APᵢₙₜ is able to resolve the two interfering users (i.e. their angular separation is greater than Δθ_{BF}), the router indicates to the interfering users and EP/APᵢₙₜ that LMAC is no longer required, since the users have their own separate spatial channels to EP/APᵢₙₜ.

b) LMAC and Tracking

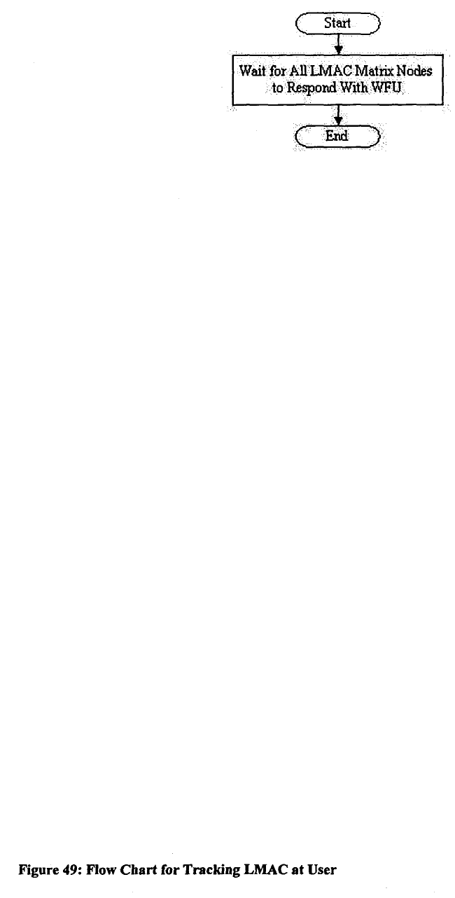

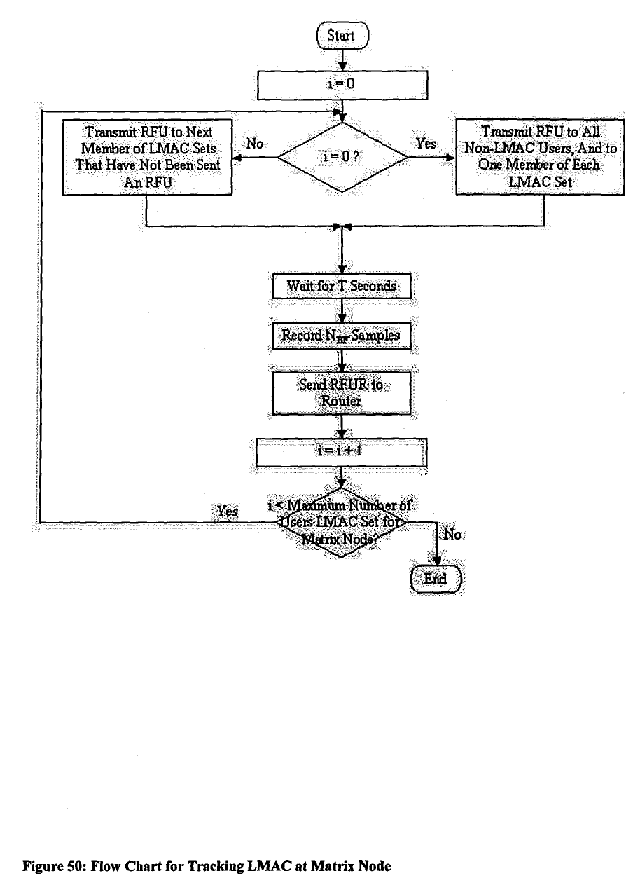

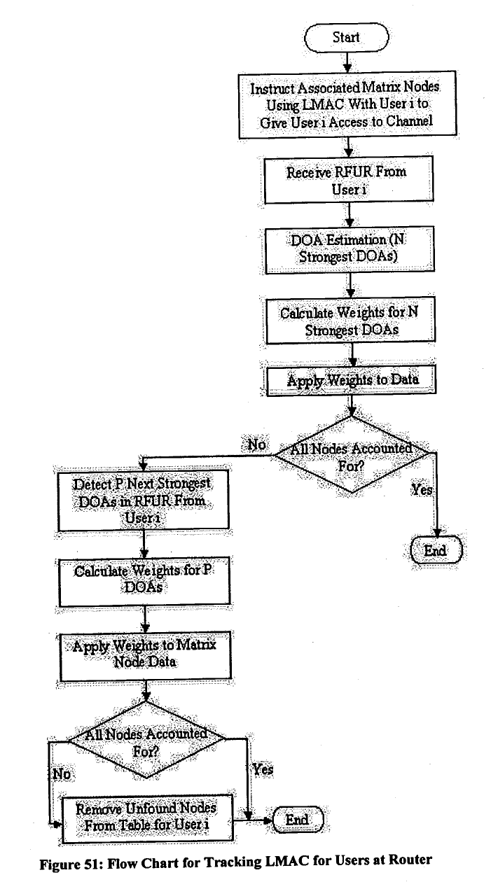

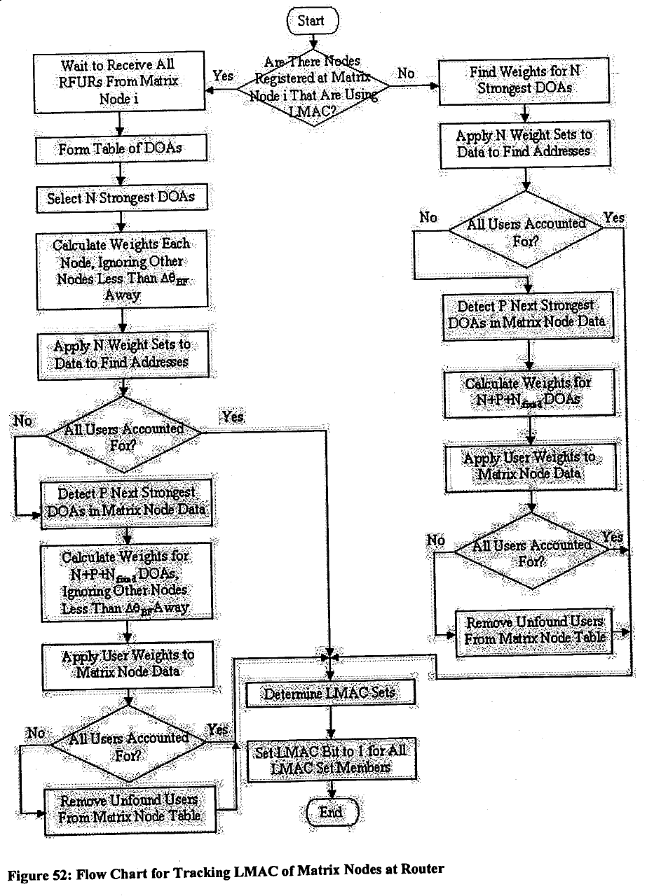

The flow charts for Tracking LMAC are shown in FIG. 49, FIG. 50, FIG. 51, and FIG. 52 for a user module, a matrix node, the router when updating a user with LMAC, and the router when updating a matrix node with LMAC, respectively.

If two non-interfering users move into positions relative to an extension/access point EP/APᵢₙₜ such that their spatial channels with EP/APᵢₙₜ overlap, the system must instruct these nodes to start communicating with LMAC.

The system checks whether it needs to invoke LMAC each time it updates the weights for a matrix node. The router sends its RFU (Request For Update) to the matrix node, which instructs it to send it an RFUR (RFU Response) packet containing samples of from each of its antennas.

Once the RFUR arrives, the router calculates the new beamforming weight sets for the matrix. This can be done in one of three ways, as described in Section 2.3.2.2. The LMAC initiation will now be described for each method:

Method 1) (Preferred Embodiment, see FIG. 51 and FIG. 52)

If Method 1 is used (straightforward DOA estimation, followed by beamforming), and no users are currently using LMAC, the router must check all the estimated DOAs to ensure that they will be able to be resolved by the beamformer. If any group of users has an angular separation of less than Δθ_{BF} relative to a matrix node, then the router will inform the users and matrix node that they are to use LMAC when communicating with each other. If a matrix node has any users that are currently using LMAC, then the matrix node will send out several RFUs in succession. The first RFU will be beamed sent to all registered users not using LMAC, as well as one user from each LMAC set. An LMAC set is a group of interfering users that operate using the same LMAC instance. Each LMAC set operates independently, since no members of different LMAC sets interfere with one another.

Once the first RFUR is received and forwarded to the router, the second set of RFU's is beamed to a second user in each LMAC set. When the RFUR for this group of users has been received and forwarded to the router, the matrix node transmits a third RFUR to a third user in each LMAC set. This process continues until all users have sent an RFUR (see FIG. 50).

Once all the RFURs for the matrix node (which has N associated users and N_{fixed} associated matrix nodes) have arrived at the router, the router proceeds to update the weights for the users. The process is as follows (see FIG. 52):

i) The router forms a table of all DOAs from all RFUR packets.

ii) The router selects the N strongest DOAs from this table, where N is the number of registered users for the current matrix node.

iii) The router calculates the N+N_{fixed} set of beamforming weights for the current matrix node. In this case, weight set i forms a lobe on DOA i and nulls on all DOAs that are greater than Δθ_{BF} away from DOA i.

iv) The N sets of user beamforming weights are each applied to the RFUR antenna data that the given DOA was detected in, in order to determine the user addresses arriving at each DOA. The DOAs for the associated matrix nodes are assumed constant, and are not measured.

v) If not all user addresses have been found, the next P strongest DOAs are added to the previous N strongest DOAs, and steps iii)-iv) are re-applied to this new set. Any user address that has not been detected by this point is disassociated with the matrix node.

vi) The router updates the LMAC sets by examining the angular distances between each user. Any node that is in an LMAC set has its LMAC bit set to 1. Those that are not in an LMAC set (and hence do not need to use LMAC) have their LMAC bit set to 0.

Method 2) (Alternative Embodiment 1)

If Method 2 is used (pre-processing in beamspace, followed by DOA estimation, followed by beamforming), the LMAC initiation procedure is the same as for Method 1.

Method 3) (Alternative Embodiment 2)

If Method 3 is used (reference-signal based beamforming with no DOA estimation), the new weights can be directly calculated from the received data, even if several users arrive from the same angle. However, in this case the router does not know any DOAs, so that it cannot determine which users must begin using LMAC. In order to determine this, the router can infer the DOA information from the calculated weights.

When updating the weights for a user that is using LMAC with one or more of its associated matrix nodes (see FIG. 51), these matrix nodes are instructed by the router to give the user access to the channel, thus allowing the user to beam its RFU to the matrix node. Once this is done, weight update proceeds as usual for the user.

2.3.4 Adaptive SDM

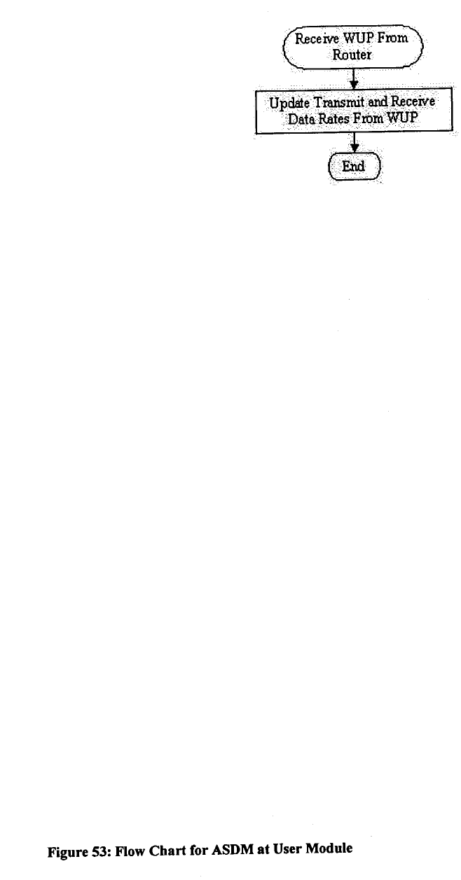

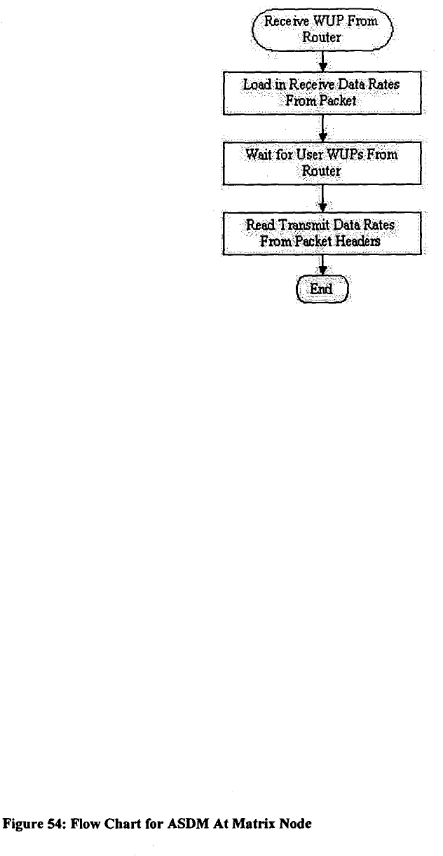

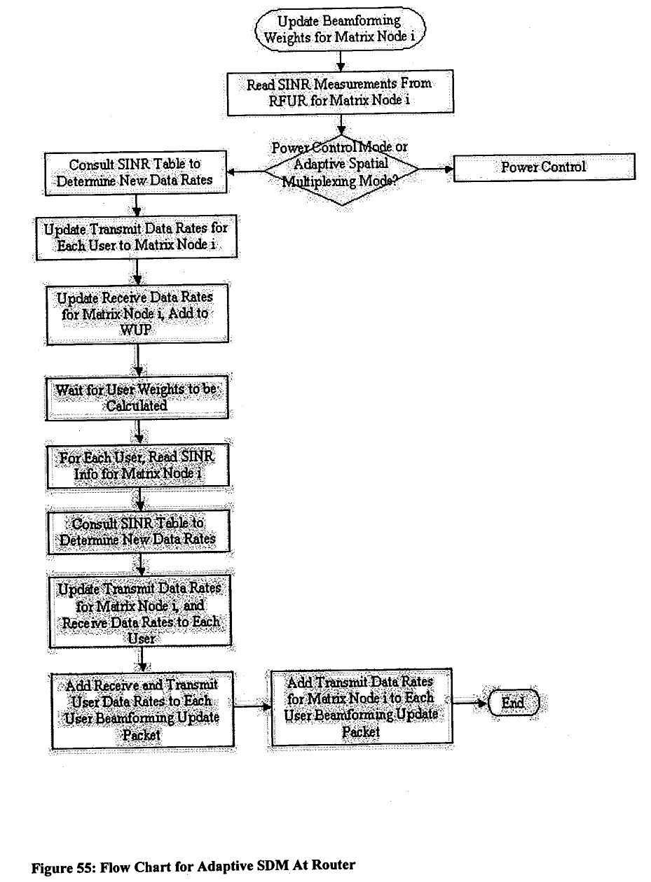

The flow charts for Adaptive SDM (ASDM) are shown in FIG. 53, FIG. 54, and FIG. 55 for a user module, matrix node, and the router, respectively.

On each matrix node weight update, the matrix node returns channel SINR measurement information for each spatial channel, in addition to its antenna samples. Alternatively, the router can calculate the SINR at the matrix node remotely using the antenna data. The SINR can be estimated from received data using training-sequence based methods, eigenvalue decomposition of the received signal, Viterbi decoder-based methods, or other well-known methods (see K. Balachandran, S. Kadaba, S. Nanda, “Channel Quality Estimation and Rate Adaptation for Cellular Mobile Radio”, IEEE Journal on Selected Areas in Communications, July 1999, pg. 1244-1256 for a review of SINR measurement techniques). Based on the values of these measurements, the router can include control information in the WUPs that are sent back to the user and matrix node to instruct them to increase or decrease their information rates on the spatial channel the SINR was measured on. This can be accomplished by modifying the coding gain, the modulation alphabet size, or the symbol rate (See S. Nanda, K. Balanchandran, S. Kumar, “Adaptation Techniques in Wireless Packet Data Services”, IEEE Communications Magazine, January 2000, pg. 54-64 for a discussion of data rate adaptation on wireless channels). In this way, the information rate on each spatial channel for a user or matrix node can be matched to the quality of the channel. In order to decide how to change the SINR on each iteration, the router refers to a table containing SINRs and corresponding data rates. On each iteration, the router would select the largest SINR_{table} that satisfied SINR_{observed}>SINR_{table}, and would use the corresponding data rate in the table (see FIG. 55). This table is stored permanently in the router.

2.3.5 Transmission and Reception of Data/Control Packets

a) Transmission

The algorithm for packet transmission is summarized in FIG. 25.

When a node receives a packet it needs to transmit, it first looks up the destination address, and then references its table containing associated nodes (users or matrix nodes) and beamforming weights. It selects the beamforming weight set corresponding to the destination address, loads these weights into its beamforming processor, and transmits the data. The data for each antenna is weighted by a beamforming weight by the beamforming processor so that the desired beam shape is generated.

In addition, the FE routing information corresponding to the destination matrix node is added to the header, which allows the packet to be appropriately routed through the FE network.

At a matrix node, the packet could be generated on board, or could be received from another node. At a user node, the packet is generated on the module itself.

This invention does not require any specific modulation or coding to operate.

b) Reception

When a node is not transmitting, each spatial channel to which the node is assigned is monitored with a beamforming processor. When a signal appears on the spatial channel, the receiver locks to the header preamble at the output of the corresponding processor and decodes and demodulates the resulting data. Note that more than one beamforming processor can simultaneously receive data in this manner.

2.3.6 Handoff

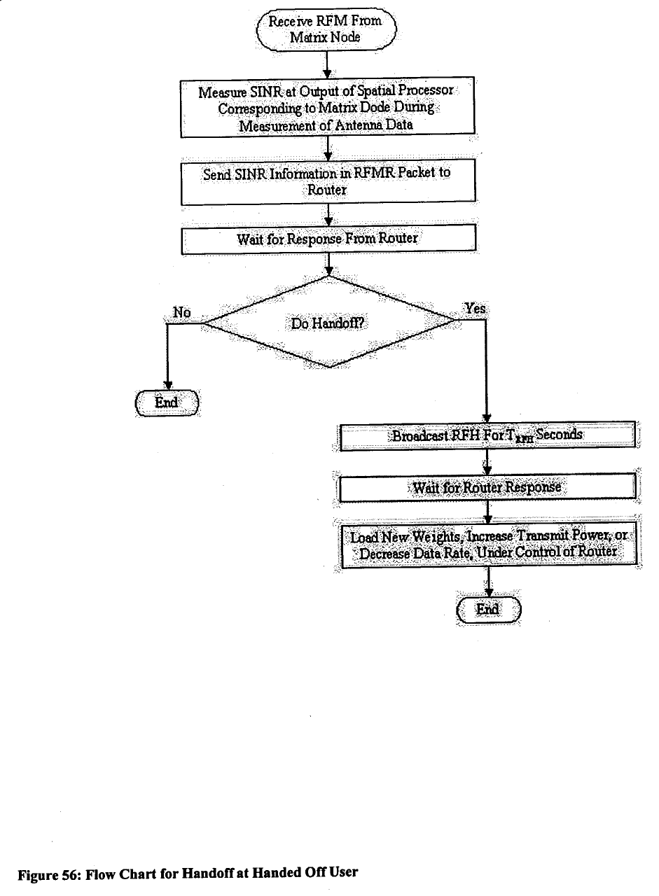

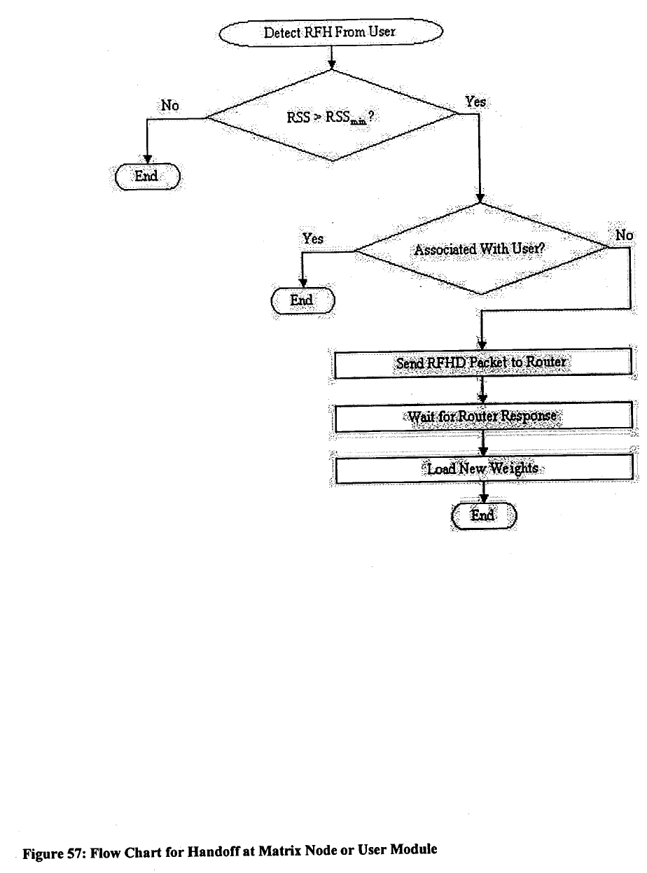

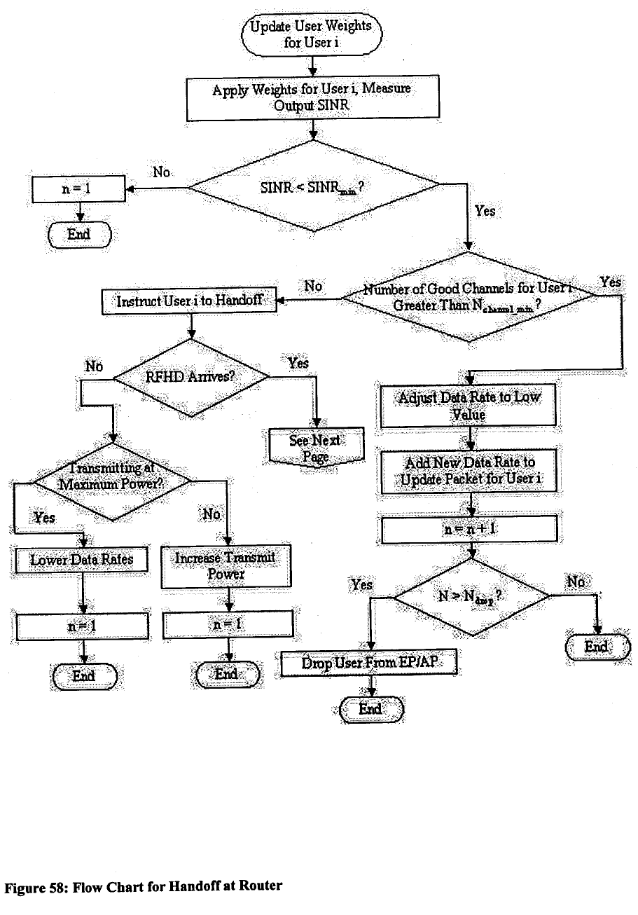

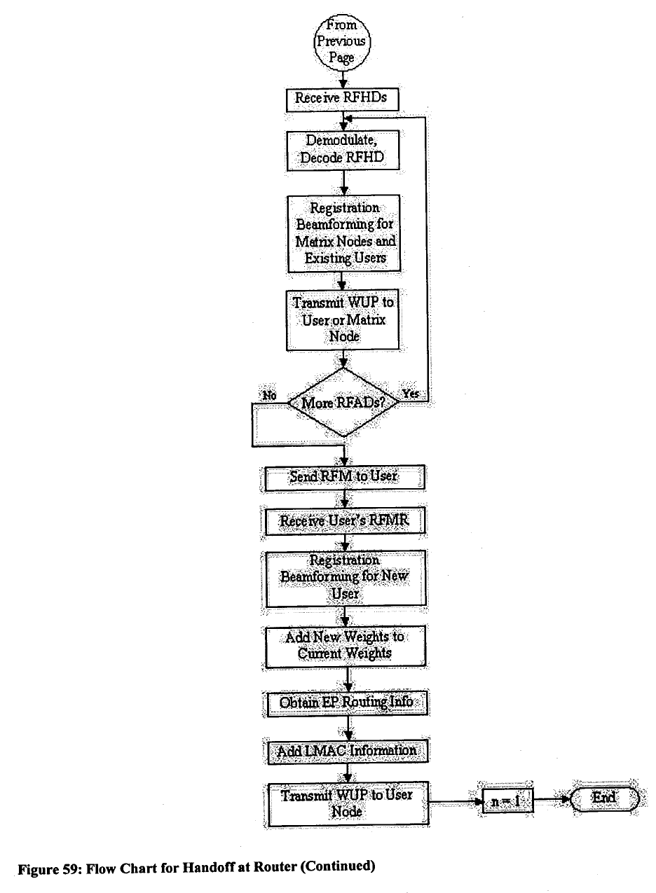

The flow charts for the handoff procedure are shown in FIG. 56, FIG. 57, FIG. 58, and FIG. 59 for the handed off user, a matrix node or user, the router (two flow charts), respectively.

The handoff procedure can be accomplished in several different ways, including the three following techniques:

1. Router-Controlled Handoff (Alternative Embodiment 1)

In this case, the router determines the SINR of the spatial channel between the user and a matrix node when the user's weights are being updated for that matrix node. This is accomplished by processing the antenna samples sent to the router by the user during the weight update process. If the measured SINR is below some threshold SINRₘᵢₙ, the router looks at how many “good” channels the user is associated with currently (i.e. the number of spatial channels whose SINR is greater than SINRₘᵢₙ). If this number is less than some fixed number N_{channel}_{_{—}}ₘᵢₙ, the router will initiate a handoff for the user (see FIG. 58).

If there more channels than N_{channel}_{_{—}}ₘᵢₙ, the router adjusts the allowable data rate on the spatial channel to a very low value (or even 0). The user will continue to send measurements of this spatial channel at every weight update. If the channel SINR remains below SINRₘᵢₙ for N_{drop} successive measurements, the user is dropped from the EP/AP associated with that spatial channel.

2. User-Assisted Handoff (Preferred Embodiment)

This method is the same as Router-Controlled Handoff, except that the SINR measurement is made locally at the mobile unit while collecting its antenna samples during weight update.

3. User-Controlled Handoff (Alternative Embodiment 2)

In this technique, the user performs the SINR measurement locally, and determines whether a handoff is necessary, using the same algorithm as for Router-Controlled Handoff. If it determines that it does need a handoff, it sends a packet to the router requesting a handoff. The router returns a message to the user, initiating the handoff.

Regardless of the technique used (1-3), the handoff, once initiated by the router, proceeds in the same fashion. When the user receives a packet from the router instructing it to do a handoff, it broadcasts a Request For Handoff (RFH) beacon in all directions using a single antenna for T_{RFH} (see FIG. 56). The beacon consists of the user's address repeated a specified number of times, and spread by a spreading code that is orthogonal to any other spreading codes used in the system (although it could be the same as the spreading code used in the RFA beacon).

The beacon is detected by all surrounding nodes, which correlate the output of a single antenna with the spreading code used in the RFH. Once the RFH is detected with a received signal strength that is greater than some threshold, the node decodes the spread-spectrum signal to determine the address of the user sending the RFH. If the node is already associated with the user sending the RFH, it ignores the signal. Otherwise, the node will collect a set of samples on each antenna and send them back to the router in a RFH Detected (RFHD) packet (see FIG. 57). If the same spreading code is used as in the RFA signal, the nodes will not be able to distinguish the RFH from an RFA, so the RFHD will be the same packet as an RFAD.

The router examines the contents of the RFHD in the same way as with the RFAD (see FIG. 59). The router determines the new weight sets for each new matrix node associated with the user in the same way as for beamforming at registration in Section 2.3.2.1a. Any nodes that are already associated with the handed off user have not sent an RFHD, so their weight sets remain unchanged.

Finally, the new weight sets for the handed off user are calculated using the same technique as at registration (see Section 2.3.2.1b). The new weight sets are sent to the user in a WUP, after adding all FE routing and LMAC information.

If the router receives no RFHD packets then there are no new matrix nodes in the vicinity of the user that are capable of servicing them. In this case, the router will resort to instructing the user and its associated matrix nodes to boost their transmit powers in order to maintain an acceptable link quality. If this is not possible (i.e. they are already transmitting at maximum power), then the data rates on each spatial channel between the user and its associated matrix nodes are lowered (see FIG. 58).

2.3.7 Power Control

Power control can be done in either a distributed (at the matrix and user nodes) or centralized (at the router) fashion. Both are described in this section. The goal of the power control function in either case is to maintain the transmit powers of each node in the network at the minimum possible levels that allow each link in the network operate at or above some minimum SINR (SINRₘᵢₙ) below which communication of an acceptable quality cannot occur.

1. Power Control at the Router (Alternative Embodiment)

In this case, the router examines the SINR information sent in the weight update packets to calculate whether the transmit powers for the various nodes should be increased, decreased, or maintained at their current values.

2. Power Control at the Nodes (Preferred Embodiment)

In this case, each link in the network is responsible for performing its own power control. Each matrix node-user pair exchanges SINR information on a regular basis to iteratively adjust their transmit powers. This information can be provided in each packet sent between the nodes, or short packets can be sent between them for the express purpose of communicating power control information. Note that for this technique, SINR measurement must be done at the matrix nodes and user modules, unless each link is assumed symmetric (in which case only matrix nodes need to measure SINR).

In either case, any of the well-known closed-loop power-control algorithms can be used (constrained distributed power control, constrained second-order power control, linear quadratic power control, among others). For a review of these techniques, refer to A. El-Osery, C. Abdallah, “Distributed Power Control in CDMA Cellular Systems”, IEEE Antennas and Propagation Magazine, August 2000, pg. 152-159.

The value of SINRₘᵢₙ can be controlled by the router to allow for varying levels of quality of service from link to link.

2.3.8 Error Handling

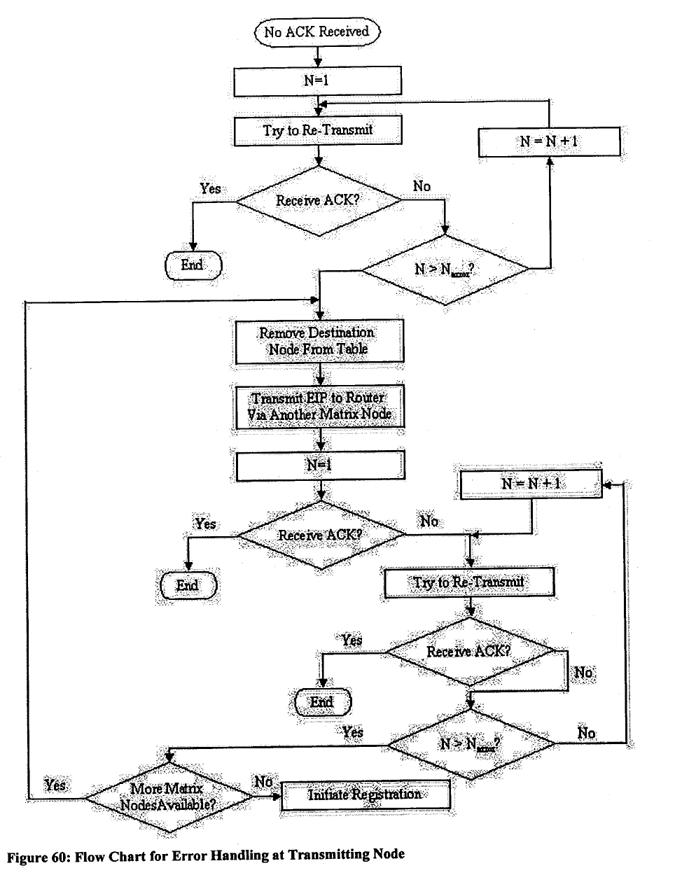

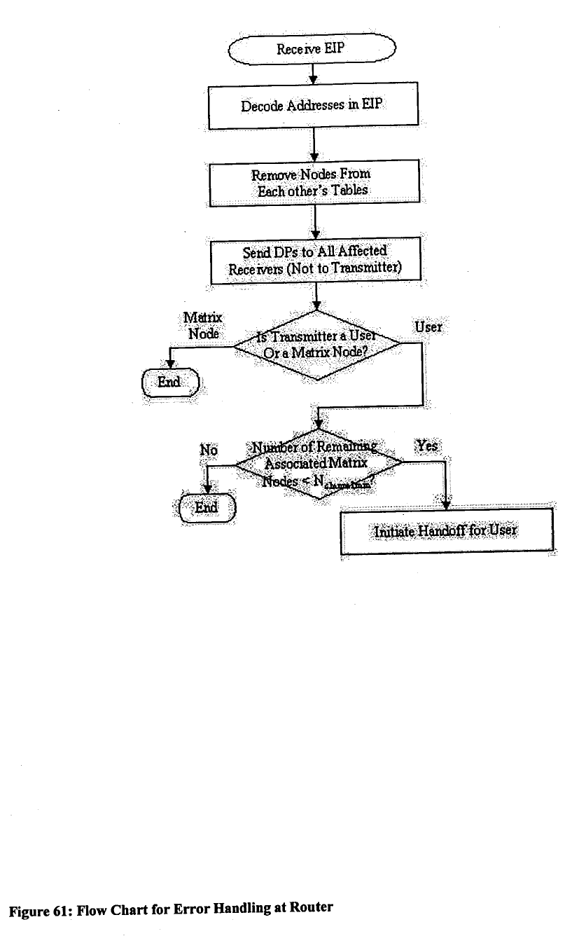

The flow charts for error handling are shown in FIG. 60 and FIG. 61 for the transmitting node and router, respectively.

To reduce errors, interleaving and FEC codes may be used. For each data or control packet transmitted on the network, a standard ACK/NACK system is used, whereby receiver nodes send an acknowledgement (ACK) packet to the packet source. If the transmitting node receives no ACK after a fixed amount of time, it re-transmits its packet. The transmitting node will repeat this process Nₑᵣᵣₒᵣ times, after which it removes the node from its table and sends an Error Indication Packet (EIP) to the router via another link, again using the same ACK/NACK system. If this link is unsuccessful, the transmitting node removes the associated node from its table and tries another, until it either succeeds or runs out of links. If it runs out of links, it initiates the registration process (see FIG. 60).

If the router receives an EIP, it decodes the addresses of the nodes involved and removes them from each other's tables. It then sends control packets (disassociation packets, or DPs) to all affected nodes but the transmitter to instruct them to remove the node from their tables. If the node is a user, the router checks to see if the user has less than N_{channel,min} associated matrix nodes left in its table. If not, it initiates a handoff (see FIG. 61).

2.3.8 Quality of Service and PC/ASDM

Note that the PC and ASDM functions, if run at the same time, would conflict with one another. In PC-mode, the network tries to minimize transmission power subject to a minimum required SINR, so that the data rate on each link is held constant (although this can be adjusted by varying SINRₘᵢₙ). In ASDM-mode, each node transmits with a constant (but adjustable) power, and the data rate is maximized subject to a minimum SINR at the receiver.

This system allows users to be assigned a mode of operation (PC or ASDM), subject to their QoS requirements. Users with heavy data-rate requirements are assigned to ASDM-mode, while users with modest data-rate requirements are placed in PC-mode to minimize interference caused in the network.

3. Ad-Hoc Layer

3.1 Introduction

The purpose of the ad-hoc layer is to ease communication between mobile devices (modules) within the fixed element network and also to allow communication between modules completely outside the network. The ad-hoc layer is split into several level that allow different forms of communication. The levels are as follows:

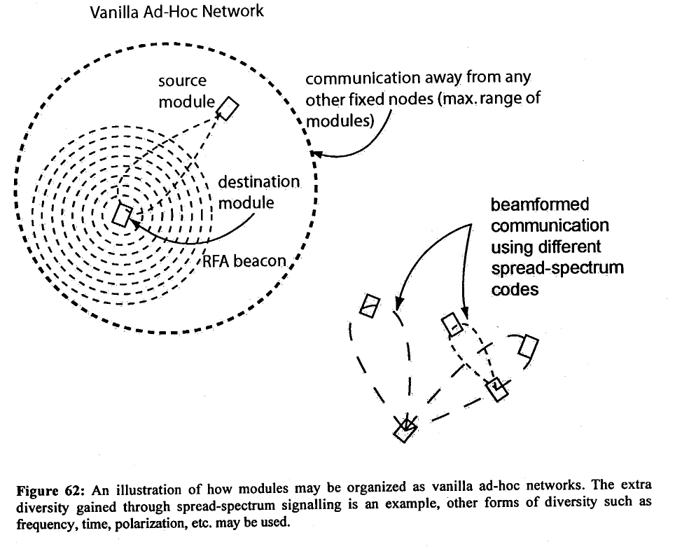

1. Vanilla Ad-Hoc Communication: FIG. 62 illustrates the organization of a vanilla ad-hoc network. Vanilla ad-hoc communication is done between mobile devices outside the fixed network (i.e. out of contact from any matrix nodes). The modules can organize themselves into a network without the need for any centralized monitoring unit.

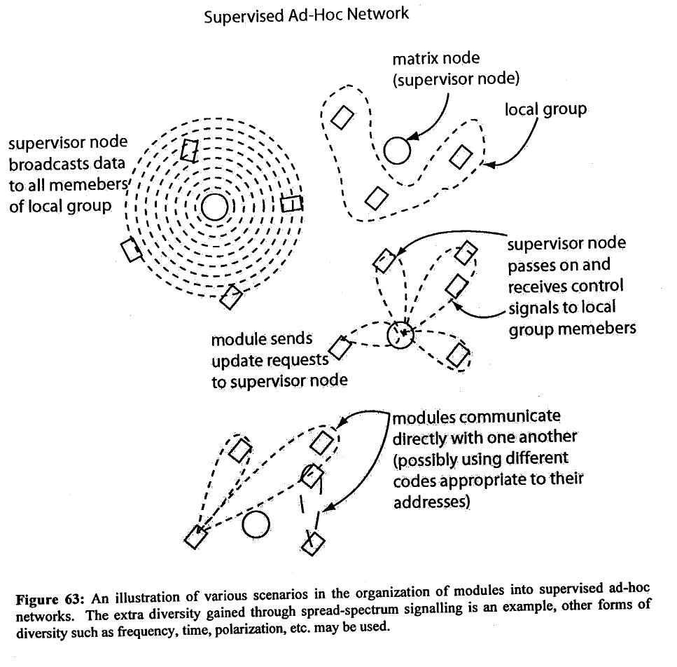

2. Supervised Ad-Hoc Communication: FIG. 63 illustrates the organization of a supervised ad-hoc network. Supervised ad-hoc communication is done between a number of mobile devices clustered together within proximity of a set of fixed matrix nodes. The matrix nodes supervise communication between nearby modules (direct module-to-module communication is possible) by breaking them up into user defined (sub-) networks (local groups) and relaying control and data between members of the local group as needed. Such networks may be manually set-up by users and thus essentially function as on-the-fly VPNs (virtual private networks) or automatically by the router if it notices that breaking a group of users into a sub-network would save on fixed network resources.

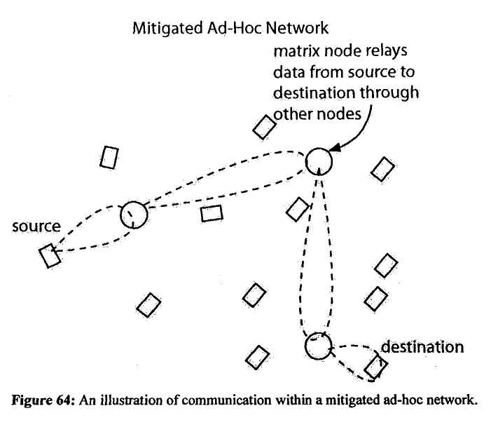

3. Mitigated Ad-Hoc Communication: FIG. 64 illustrates the organization of a mitigated ad-hoc network. Mitigated ad-hoc communication is done between remote modules within the network. When the modules are too far apart to reliably communicate with one another, the router sets-up a connection mitigated by a string of fixed matrix nodes. Under the supervision of the router the nodes optimally relay information from one node to another.

3.2 Structure

3.2.1 Event-Driven Functions (Hardware/Software)

Initialization

Vanilla Ad-Hoc Networks

Join Network

This function is initiated by the user of a module. It instructs the module to look for and join an ad-hoc network in its vicinity by broadcasting a specific beacon signal to which only other modules in search of or belonging to vanilla ad-hoc networks may respond. The beacon is also used to make certain that the module is not within the vicinity of any matrix nodes.

Supervised Ad-Hoc Networks

Start Local Group

This function is initiated by the user of a module. It instructs the module to start a new supervised ad-hoc network that is to be controlled by a nearby matrix node.

Mitigated Ad-Hoc Networks

Start Mitigated Group

This function is initiated by the user of a module. It instructs the module to start a new mitigated ad-hoc network that is to be controlled by the router.

Route Planning

Supervised Ad-Hoc Networks

Relay Routing

This function allows modules within supervised ad-hoc networks to communicate in a multi-hop manner across matrix nodes (i.e. supervisors) and other modules in the network. Matrix nodes and modules act as relays for beamed data allowing devices within a supervised ad-hoc network to communicate around obstacles. Control of the relay routing is done through the router.

Mitigated Ad-Hoc Networks

Router Controlled Routing

This function allows modules spread far apart within a fixed element network to communicate efficiently with one another via a route planned by the router. The router determines the optimal path of matrix nodes needed to wirelessly connect a number of spatially disparate devices.

Scaling

Vanilla Ad-Hoc Networks

Join Network

This function is initiated by the user. It allows modules to enter vanilla ad-hoc networks. Since no central co-coordinating unit is present in this type of network in order for a new module to be included the entire network must be re-built from scratch such that each member of the vanilla ad-hoc network can have a record of the network's state (e.g. users, addresses, etc.) that is consistent with the remainder of the devices in the network. Being allowed to join is contingent on permissions from present network users.

Drop Network

This function is initiated by the user. When applied it causes the module to inform the remainder of the users in the network that the module is leaving without requiring a full network re-set.

Ignore Network

This function is initiated by the user. It prevents the module from unintentionally registering in a vanilla ad-hoc network.

Supervised Ad-Hoc Networks

Join Local Group

This function is initiated by the user. It prompts the device to seek out a nearby matrix node (i.e. a supervisor) through which it could join a supervised ad-hoc network. A module is allowed to join the network base on permissions from the user and the supervisor's ability to support the network. All these negotiations are carried out by the network and a matrix node before the module is given clearance to join the supervised ad-hoc network.

Drop Local Group

This function is initiated by the user. It causes the device to inform a matrix node looking after the user's supervised ad-hoc network that the module's user is leaving the network. The matrix node passes (by beamforming) this message to the remaining members of the local group causing them to update their internal network state databases (lists) (e.g. what users are in the network, relative directions to modules, etc.).

Mitigated Ad-Hoc Networks

Join Mitigated Group

This function is initiated by the user. It prompts the module to register itself through the router into any of a number of mitigated ad-hoc networks running on the fixed element network at the time.

Drop Mitigated Group

This function is initiated by the user. It prompts the module to inform the router that it is leaving a mitigated group. After receiving this message the router instructs the remainder of the modules within the mitigated ad-hoc network to remove the dropping device from their databases.

LMAC

Vanilla Ad-Hoc Networks

Signal Multiplexing

This function is always present in vanilla ad-hoc networks. Since network control is not centralized in the vanilla mode the module-to-module communication scheme augments the spatial diversity afforded by beamforming with any of frequency-, time-, polarization- or code-division multiplexing. The character of the scheme used (e.g. frequency, synchronization, or code) is unique to the network address assigned to the modules (the network address is itself unique). This provides a measure of MAC designed to reduce interference.

Supervised Ad-Hoc Networks

Signal Multiplexing

This function is initiated when a module must communicate with its destination across another module in the supervised ad-hoc network. This function is initiated when no multi-hop link can be set up to route beamed communication around the blocker. As in the case of vanilla ad-hoc networks the multiplexing used corresponds to the unique supervised ad-hoc network address assigned to the receiving module.

Mitigated Ad-Hoc Networks

See SDM layer section for function descriptions of how LMAC is used to deal with interference around matrix nodes (supervisors).

Control

Vanilla Ad-Hoc Networks

Assigning Addresses

This function is initiated whenever a module joins a vanilla ad-hoc network. A module is given a unique network address based on its arrival into the network that also determines other communication properties unique to that address. The network follows an address assigning protocol that prevents different modules from sharing the same address. Contingencies exists within this function if modules are accidentally assigned the same network address. In this case the entire network is re-set.

Re-Set Network

This function can be even-driven or initiated by the user. A user may choose to initiate it in which case the remaining members of the network vote to allow the action or not. The re-set may also be initiated automatically by a module if it cannot improve failing signal quality between it and another module or if a module has an incorrect list of the network's users. Automatic network re-set actions are not polled.

Supervised Ad-Hoc Networks

Assigning Addresses

This function is initiated whenever a module joins a supervised ad-hoc network. The new module is assigned a unique address by the network's supervisory matrix node which has a list of all network members that it oversees and the address that they was assigned. In this way the assigning node prevents network members from sharing the same address.

Data

Vanilla Ad-Hoc Networks

Data Classification (Tagging)

This function is used to identify the type of data (i.e. tags the data) that is set for transmission across the wireless network. This function is initiated automatically and its tags depend on what part of the module generated the data to be sent (e.g. keyboard, speech processor, video processor, etc.) or on the type of service that the module wishes to support the data with (i.e. high-speed, nominal speed, secure, etc.). Typically, the module can discern between content-sensitive data (e.g. text) and bandwidth sensitive data (e.g. video) and delay sensitive data (e.g. steaming audio) and tag the data appropriately. These tags are used by other blocks within the module (e.g. the error encoder) to determine the amount of coding that must be done on them before transmission. Likewise, receiving modules use the data tags to determine the decoding and nature of acknowledgements needed to satisfy communication integrity.

Variable Data Rates

This function is applied as needed. If due to link quality or power issues a module request that the transmitting data rate be changed this function allows the module to respond by increasing or decreasing the transmitted data rate.

Supervised Ad-Hoc Networks

Same as data related functions listed for vanilla ad-hoc networks.

Mitigated Ad-Hoc Networks

Same as data related functions listed for vanilla ad-hoc networks.

Error Handling

Vanilla Ad-Hoc Networks

Variable Error Handling

This function is initiated automatically depending on the type of data that is being sent and received (see the Data Classification function). The modules apply various levels of transmission acknowledgement, error detection, and error correction depending on the data tag assigned to the data they are sending/receiving (e.g. control data, or content sensitive data or bandwidth sensitive data or delay sensitive data).

Acknowledgements

Depending on the classification (type) of data received the module may return an acknowledgement to the transmitter that the data was successfully received.

Supervised Ad-Hoc Networks

Same as error handling related functions listed for vanilla ad-hoc networks.

Mitigated Ad-Hoc Networks

Same as error handling related functions listed for vanilla ad-hoc networks.

3.2.2 Background Functions (Hardware/Software)

Housekeeping

Vanilla Ad-Hoc Networks

User Tracking (Updating Network)

This function is automatically initiated when the communication quality between users degrades below a certain threshold (communication quality is monitored by the Connection Integrity function). If the quality of the link is determined to have sufficiently degraded this function initiates a re-set of the network that prompts all users to recalculate their relative directions to all other users in the network. This function is not initiated if a connection cannot be established between users in the first place.

Connection Integrity

This function runs continuously. It evaluates the quality of the link between devices. Each transmitting device embeds the power levels used to transmit and each receiving device compares this to the RSSI (received signal strength indicator) level monitored for that signal. The ratio of these values helps the receiver keep track of its link quality and the changes in undergoes.

Supervised Ad-Hoc Networks

User Tracking (Updating Network)

This function is automatic. The matrix node overseeing a supervised ad-hoc network periodically beams a request to modules of the network to announce their position relative to the matrix node. These results are calculated (by the router) and stored (by the router and the matrix node). If the user directions have changed significantly enough the supervising matrix node then tells each member of the network to find its relative direction to every other member of the network for the purpose of beamforming. Supervised ad-hoc networks remain within the transmitting range of their supervising matrix node.

Mitigated Ad-Hoc Networks

User Tracking (Updating Network)

User tracking in mitigated ad-hoc network is done in the same way as module tracking which is explained in the SDM layer section. Mitigated ad-hoc network members are free to roam throughout the fixed element network and are tracked and handed-off to the appropriate matrix nodes by the router.

3.3 Databases

3.3.1 Modules

The modules must keep track of a number of events and users throughout their participation in ad-hoc networks. A module's database assists the user in carrying out basic network functions such as selective communication and security. It is through the module's database that a user is aware of the presence of other members on the ad-hoc network. The database allows users to identify other members of the ad-hoc networks they wish to communicate with. The following three sub-sections summarize the databases employed by modules when participating in the three ad-hoc networks available.

Vanilla Ad-Hoc Network Module Databases

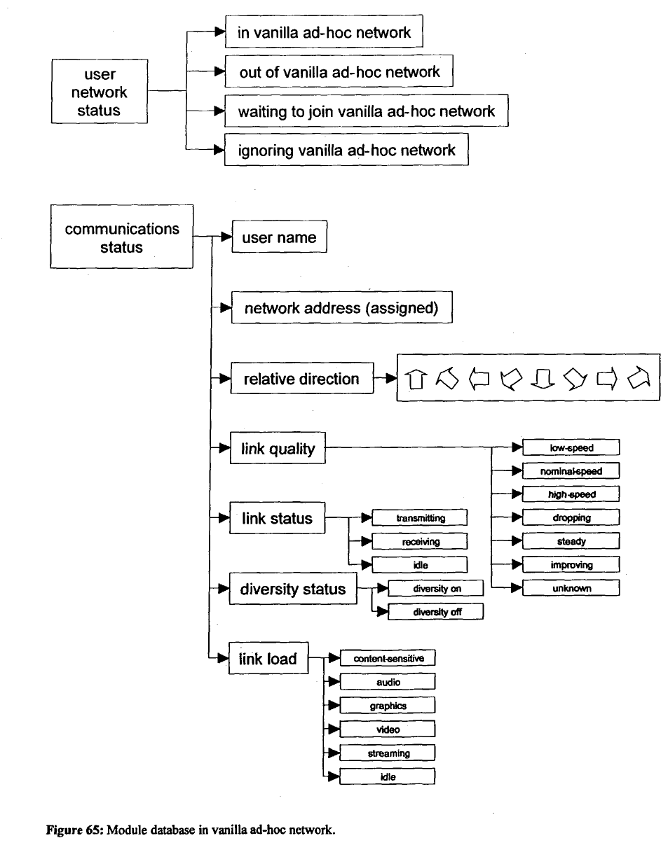

The module's database in the vanilla ad-hoc network is outlined in FIG. 65. The “user network status” state identifies whether or not the user is in, out, ignoring, or waiting to join a vanilla ad-hoc network. The remaining list under “communications status” identifies all the members of the network and their properties/behavior and the known quality of connection relative to the user's module, also referred to as the reference module. (i.e. each module has a unique database which describes the state of the network relative to that module). The information contained within this database is used to update the user's user lists. The database variables are summarized below:

User name: Names of all users in the network.

Network address (assigned): The assigned addresses to all users of the vanilla ad-hoc network.

Relative direction: The relative directions of all vanilla ad-hoc network users to the user's module.

Link quality: How good the link is between a vanilla ad-hoc network member and the reference module.

Link status: The status of communication between the reference module and any other member of the vanilla ad-hoc network.

Diversity status: The type of diversity (e.g. frequency, time, code, polarization) signaling used between the reference module and any other member of the vanilla ad-hoc network.

Link load: The type of data being exchanged between the reference module and the vanilla ad-hoc member it is communicating with.

Supervised Ad-Hoc Network Module Databases

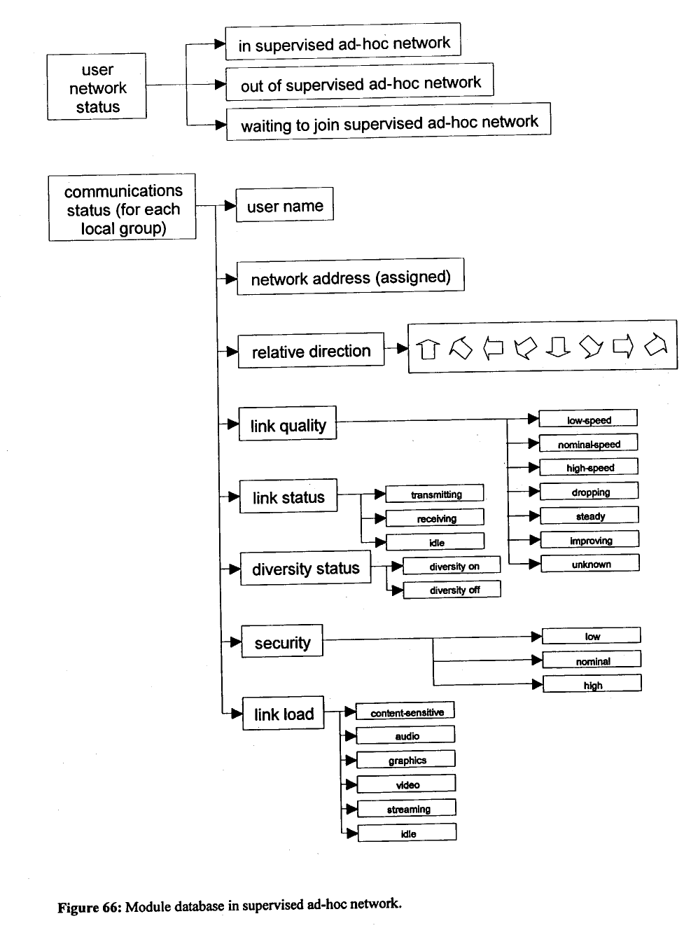

The module's database in the supervised ad-hoc network is outlined in FIG. 66. As was the case for modules in vanilla ad-hoc network the “user network status” identifies whether the module is tied into the network. The “communications status” list is a slightly more expanded version of the one used for vanilla ad-hoc modules as it contains more states and if further partitioned into the particular local groups that supervised ad-hoc members belong to. The information contained within this database is used to update the user's local group lists. The database variables are summarized below:

User name: Names of all users in the network.

Network address (assigned): The assigned addresses to all users of the supervised ad-hoc network.

Relative direction: The relative directions of all supervised ad-hoc network users to the user's module.

Link quality: How good the link is between a supervised ad-hoc network member and the reference module.

Link status: The status of communication between the reference module and any other member of the supervised ad-hoc network.

Diversity status: The type of diversity (e.g. frequency, time, code, polarization) signaling used between the reference module and any other member of the supervised ad-hoc network.

Security: The level of security requested by each user in the supervised ad-hoc network.

Link load: The type of data being exchanged between the reference module and the supervised ad-hoc member it is communicating with.

Mitigated Ad-Hoc Network Module Databases

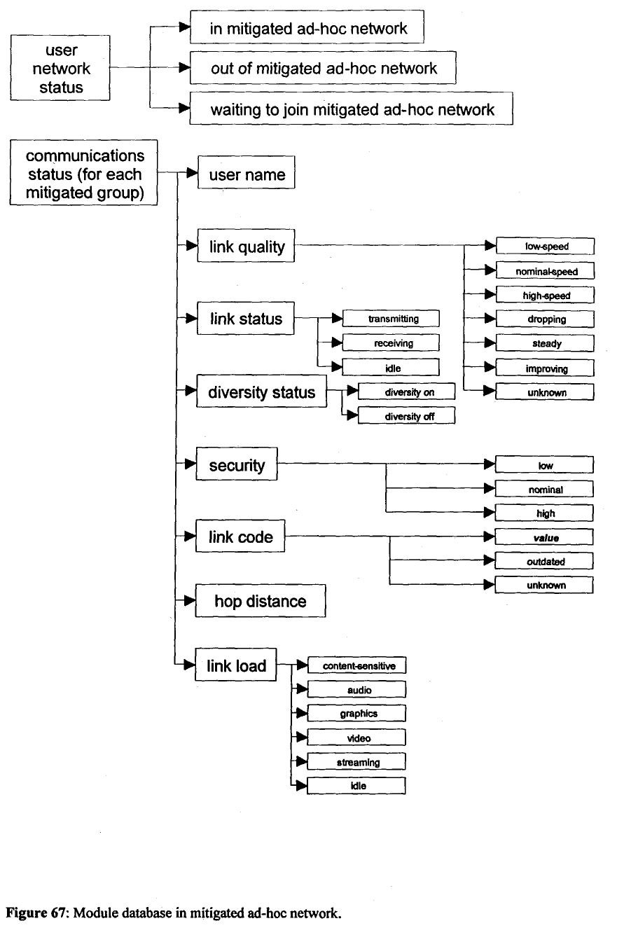

The module's database in the mitigated ad-hoc network is outlined in FIG. 67. As was the case for modules in the supervised ad-hoc network the “user network status” identifies whether the module is tied into the network. The “communications status” list differs slightly from the supervised ad-hoc network to reflect the requirements of the mitigated ad-hoc network. The information contained within this database is used to update the user's mitigated group lists. The database variables are summarized below:

User name: Names of all users in the network.

Link quality: How good the link is between a mitigated ad-hoc network member and the reference module.

Link status: The status of communication between the reference module and any other member of the mitigated ad-hoc network.

Diversity status: The type of diversity (e.g. frequency, time, code, polarization) signaling used between the reference module and any other member of the mitigated ad-hoc network.

Security: The level of security requested by each user in the mitigated ad-hoc network.

Link code: The data describing the route planned between the reference module and the mitigated ad-hoc network user it may communicate with.

Hop distance: The number of matrix nodes across which a connection between the reference module must hop to reach another mitigated ad-hoc network module (determined by the link code).

Link load: The type of data being exchanged between the reference module and the mitigated ad-hoc member it is communicating with.

3.3.2 Matrix Nodes

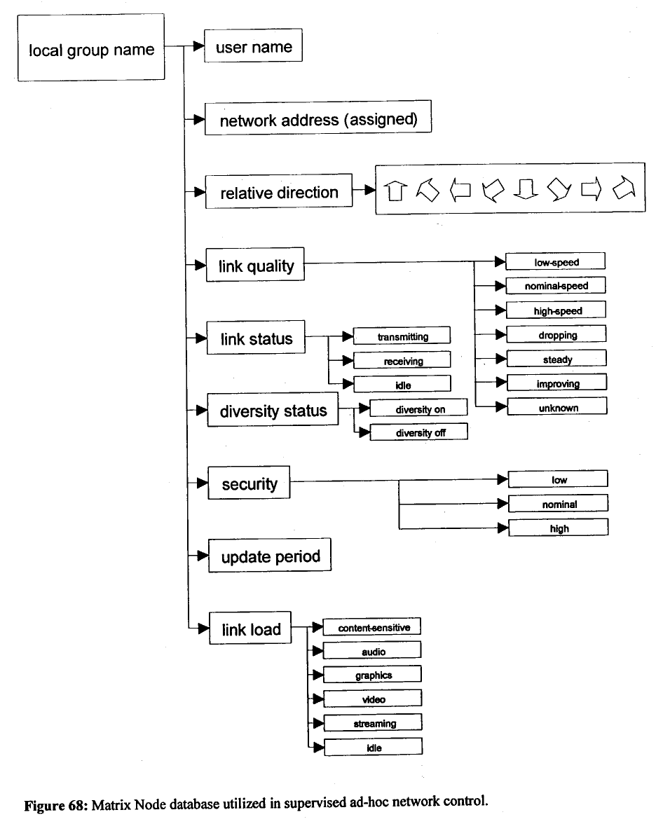

The database used by the matrix nodes as regards supervised ad-hoc networks is outlined in FIG. 68. Matrix nodes are not used in vanilla ad-hoc networks and their databases are most distinctive for supervised ad-hoc networks. A matrix-node may oversee a number of supervised ad-hoc networks (local groups) simultaneously. As shown in FIG. 68 the most important supervised ad-hoc network database variables (for each local group) are:

User name: The name of the user in the matrix node's local group.

Network address (assigned): The assigned address of the local group user.

Relative direction: The relative direction of the local group user to the matrix node.

Link quality: How good the link is between a local group member and the matrix node.

Link status: The status of communication between the matrix node and any other member of the local group.

Diversity status: The type of diversity (e.g. frequency, time, code, polarization) signaling used between the matrix node and any other member of the local group.

Security: The level of security requested by each member of the local group.

Update period: The amount of time the matrix node is to wait before attempting to update the local group.

Link load: The type of data being exchanged between the matrix node and the local group member it is communicating with.

3.3.3 Router

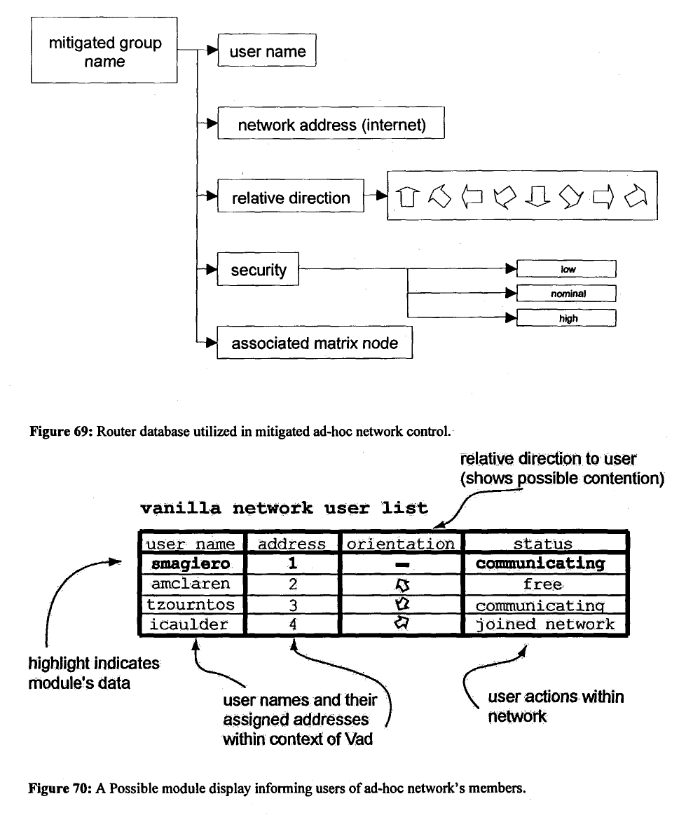

The database used by the router as regards mitigated ad-hoc networks is outlined in FIG. 69. The router helps monitor and control the mitigated ad-hoc networks. The router may oversee a number of mitigated ad-hoc networks (mitigated groups) simultaneously. As shown in FIG. 69 the most important mitigated ad-hoc network database variables (for each mitigated group) are:

User name: The name of the user in the mitigated group.

Network address (Internet): The Internet address of the mitigated group user.

Relative direction: The relative direction of the mitigated group user to the first matrix node it is routing data through.

Security: The level of security requested by each member of the local group.

Associated matrix node: The first matrix node through which a mitigated group member communicates.

3.4 Operation

The operation of the three ad-hoc networks is further detailed in this section. Each network is given a brief overview, followed by more detailed descriptions of their initialization, steady-state operation, scaling, and contingency handling capabilities.

3.4.1 Vanilla Ad-Hoc Network (Vad)

Main Features

The Vad is intended to support users who wish to form small, independent communications networks with their wireless modules. Typically, the users would be organized within the transmission range of each device and out of the range of any network matrix nodes. A major distinguishing feature of this network is that it does not rely on a central unit or a master unit to organize the data flow; all members of the network participate in setting up and communicating within the Vad.

Modules are prompted by their users to perform any of a number of network functions (e.g. search for, join the network, leave the network, allow a user to join a network, communicate, etc.). These actions are assisted by a visual network status which informs the user of the state of the module and the network through a user list as shown in FIG. 70. The user list example shown in FIG. 70 would typically cull its information from some of the variables stored in a module's database (see the Database section) and can include even more data in needed. The user address is an important concept within the user list. This is an address specific only to the Vad and the order in which a module joined the Vad. It is not based on any other properties of the device. The scheme used for assigning address to users of Vads is explained in more detail in the Initialization section. Using their display the user can choose any of a number of possible network functions by entering an option in the status field of the user list.

The plug-ins to the modules are all equipped with antenna arrays which allows the devices to beamform dedicated paths to one another. In this way the Vad is a point-to-point network (since no centralized controller is used) with minimized need for medium access control (MAC).

Initialization: Starting-up and Scaling Vad Networks

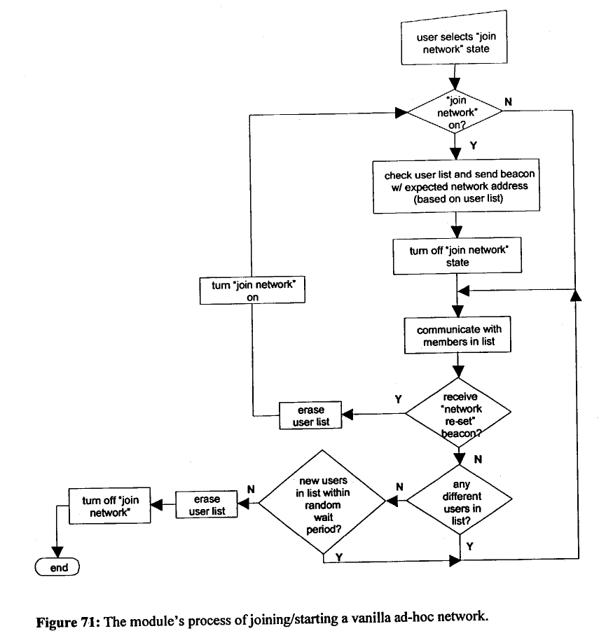

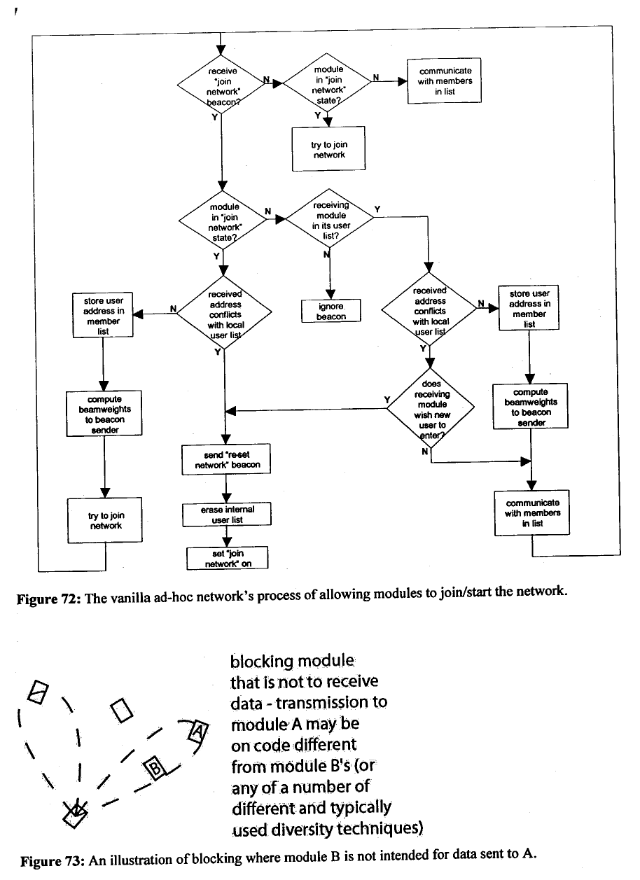

The initialization of vanilla ad-hoc networks actually includes both building-up (from scratch) and scaling the network to include new users. The function of the network does not differentiate between the two approaches. The way a module joins (helps build) the network is summarized in the flowchart shown in FIG. 71 while the way a network introduces (deals with) new modules joining (helping build) the Vad is explained by the flowchart shown in FIG. 72. An written explanation of the initialization process from all levels (i.e. module and network) is as follows:

The user indicates that he/she wishes to join a vanilla ad-hoc network by selecting the “join network” option available through the user module's network software (e.g. through the user list interface shown in FIG. 70. Once the “join network” option has been selected the module waits for a random amount of time before broadcasting a request for access to vanilla network (RFAV) beacon. The RFAV is a dedicated spread spectrum signal that uses the same code as the RFA beacon explained in the SDM layer description and is the same as the RFA save for slight differences in their information content. Immediately before broadcasting the RFAV signal the module makes sure it is not receiving any other RFAV broadcasts, if it is then the module backs-off from sending its RFAV beacon for another random amount of time. Once a beacon is sent the “join network” state is turned “off” and the device does not attempt to send any more RFAVs (unless the “join network” state is re-initiated by the user).

The RFAV broadcast is intended to make sure that there are no nearby matrix nodes with which the module could potentially interfere. If a matrix node were to pick up an RFAV beacon from a module attempting to join an ad-hoc network (as requested by the user) it would send a reply automatically overriding the users request to join/create a Vad. Any module that picks up the beacon and that has not been prompted by its user to join a Vad ignores the message.

On top of being used as a sensory signal (to locate matrix nodes) the RFAV broadcast is also used as a “join network” request. Any other module that receives the beacon and is in a Vad or is attempting to join a Vad (i.e. “join network” state has been set by the user) recognizes the signal as an attempt by another module to join the network. The smart antenna and processing technology within the plug-in is then used to estimate a direction of arrival from the user.

Besides identifying the relative direction of the user (that sent the RFAV) a receiving module must have a consistent means (for all devices in the network) of attributing a Vad specific address to the device from which it received the beacon. In this case as well the RFAV beacon plays an important role in communicating information.

The broadcasting module structures the information within the RFAV packet such that it contains:

1. An identifier stating that the RFAV packet was sent in search of a Vad

2. The user name of the RFAV sender

3. The presumed Vad address of the RFAV sender

The first two points are user defined (the first by virtue of the “join network” state, where “join network” refers to a vanilla ad-hoc network specifically) while the third point is an automatic even-driven operation. In order to assign itself a Vad address a module checks its Vad user list. If no members are present it assigns itself the first address of a set of N possible Vad addresses stored in the module's memory. If k users are already present in its user list the module assigns itself the k+1 of a set of N possible Vad addresses stored in its memory. With these three properties set the module loads the RFAV packet and prepares to broadcast it.

As already mentioned, once any module that has joined the network (i.e. its user name appears in its user list along with a network address) or any module attempting to join the network (“join network” state is “on”) receives the beacon it can estimate a direction of arrival; with the information loaded into the RFAV by the sender it can also attempt to scale the network. The receiving module does this by first recognizing that the RFAV is a Vad joining request (point 2, above). It then extracts the network specific address proposed by the user. If the address does not conflict with any of the stored addresses and has an order that immediately follows the last address stored in the list then the receiving module adds the new address and user to its user list and calculates the beam weights required to communicate with it.

If the beacon's proposed address is the same as any that has already been assigned by the module (as recorded by the module's user list) or does not sequentially follow the last address stored in the module (e.g. the module contains k members in the user list and proposed address is the k+2) a couple of alternatives exist (as shown in FIG. 72). If the receiving module's “join network” state is “on” (i.e. it is attempting to, but has not yet succeeded in registering on the Vad itself the device assumes that an error occurred during a network initiation and broadcasts a re-set vanilla ad-hoc network (RVA) beacon which prompts all modules that received it who are in or attempting to join a Vad to erase their user list and set their “join network” state back “on” (thus attempting to re-build the network). The RVA beacon is broadcast using the same spread-spectrum code as the RFAV. If, on the other, hand the receiving device already joined the network (i.e. it has a reference to itself in its user list) then it assumes that a new device is attempting to join an established network. In this case the module gives the receiving user the option to allow the requesting user to enter the network or not. If the user does not wish to allow the request the module does not update the user list. If the user does wish to allow the requesting module onto the network is sends out an RVA.

Some users may not wish to join a network—in this case, if an RVA is received and the device had no members in the user list and had the “ignore network” state “on” the RVA beacon is ignored.

If a module has sent out an RFAV beacon (thus assigning itself an address) and is the only member of its user list it waits for a certain amount of time (deterministic or non-deterministic) for other users to join. If at the end of this time period no other users join the module assumes that it cannot make contact with any other modules, there are no other modules within its range, or that it has not been allowed to join an existing Vad. Thus, it erases its user list and sets its “join network” state to “off”.

Steady-State Operation: Maintaining Communication

Communication between members of a vanilla ad-hoc network can be done in a point-to-point fashion because of the beamforming capability of the modules. To communicate with any of a number of specific members of the group the user highlights the modules shown on the user list to which data is to be sent. Since the module is aware of its relative direction to all other members on the user list it is capable of correctly computing the beam weights to these devices. Depending on the type of data that was transmitted the sending module may await for acknowledgements to be returned by the receiving devices indicating that the data reached its destination (e.g. content-sensitive data may require a constant set of acknowledgements while bandwidth sensitive data such as full-stream video may require a reduced set of acknowledgements).

On top of the spatial diversity afforded by the plug-in's beamforming antenna arrays the modules may communicate using different signal multiplexing techniques (i.e. frequency division multiplexing, time division multiplexing, or code division multiplexing). Since each device receives a unique network address that is know to all other members of the Vad then a unique character can be assigned to the multiplexing scheme used (i.e. frequency, synchronization, or spread-spectrum code). The type and character of multiplexing scheme can be stored in memory and assigned to a corresponding address (also stored in the module's memory as mentioned above). Hence, when a module wishes to communicate to another module, on top of forming a unique beam pattern it may also diversify the data with a multiplexing technique unique to the destination module. This helps the Vad further avoid co-channel interference and support a more dense group of users.

Contingencies

A number of contingency scenarios exist in the vanilla ad-hoc network:

1. Tracking Users:

The modules in a Vad keep track of each other's movement by monitoring the quality of their links. When devices communicate with other modules within a Vad they include a power level indicator in the packets they send which denotes the power used by the transmitting module to send its data. Similarly, receiving devices logged into a Vad measure the signal strength of the incoming data and keep an internal log of the ratio between sent and arrived signal powers. The modules create an internal database using these ratios as indicators of the relative quality of their links to every other module they have communicated with. If the power ratio begins to drop quickly the modules follow a certain procedure (related to the estimated power ratio) to help improve communication:

1. Send request to sender asking for improved error correction.

2. Send request to sender for increased transmission power.

3. Send request for reduced data rates.

4. Send out “re-set network” beacon (RVA).

2. Module Cannot be Reached:

Modules must be able to deal with units that may be severely blocked or have left the network without a clear announcement. If a transmitting module does not receive any acknowledgement from a destination (note: the character of acknowledgements is dependent on the type of data sent) after a number of packets or frames have been sent (again data dependent) it warns the user that the module cannot be reached. The module then prompts the user if they wish to:

1. Drop the destination from their user list: The dropped user's field is made unselectable by the user (that sent the original message), but the address is not re-assigned.

2. Re-try communication: The sender's module attempts to retransmit to the user one more time.

3. Re-set the network: The module sends out an RVA beacon. If the user attempts to manually re-set the network (under this or any other circumstance) the user's module automatically sequentially polls every module in its user list to ask if they are willing to allow a network re-set. The modules which receive the message prompt their users to reply. If any user replies “no” the network is not re-set. If the all users reply “yes” the RVA beacon is sent. No reply from a user after a particular number of polls (to that user) is interpreted as a “yes” reply.

3. Module Blocked:

FIG. 73 illustrates this scenario. If a module has more than one Vad member at similar relative directions one (or more) of whom are to be excluded from a transmission in that direction it must make sure that a diversity scheme unique to the actual destination modules is used. This is taken care of by the fact that modules have a unique diversity signaling scheme associated with their Vad specific addresses (e.g. a unique frequency band for frequency diversity, a unique spread-spectrum code for code diversity, a unique polarization for polarization diversity, etc.).

Scaling

Scaling-up the network is part of the initialization function, see the Initialization section for vanilla ad-hoc networks. If the network is to be scaled-down (i.e. a user wisher to drop-out of the network) the user indicates sets the “drop network” state of the module on. This prompts the device to broadcast a request for drop (RFD) beacon which the other members of the network recognize and use to initiate a sequence which erases that user from their user lists.

3.4.2 Supervised Ad-Hoc Network (Sad)

Main Features

The Sad is intended to support users clustered into a stand-alone network that is supervised by a matrix node. Such an ad-hoc network of users is also referred to as a local group. The matrix node helping control the local group is referred to as a supervisor. The supervisor stores the relative directions to each member of the local group and organizes the network such that each member of the local group (i.e. each module) knows the relative directions to every other module (in the context of beamforming). Thus, knowing the relative directions to every other member of the local group each device can directly beamform a communication link to any member(s) of its choosing. As in the case of the vanilla ad-hoc network users within a supervised ad-hoc network are kept informed of the networks status by using a local group list which is updated by the supervisor.

The supervisor regularly updates the network (updates could be periodic and/or based on user requests and/or based on estimated QoS (quality of service) and/or for security reasons) to find valid directions for new or moved local group members. The supervisor also interrupts local group communications if changes (updates) need to be made.

In this way the supervisor acts more to help the data get started and to ease the networks response to various contingencies by helping adapt the communication routes. The supervisor is not needed to relay data, this can be done strictly from device-to-device on a point-to-point basis.

Initialization

The initialization of the supervised ad-hoc network can be done manually by the users gathered around a supervisor node or automatically by the router if it recognizes that users of the network are exchanging data locally. These alternatives are outlined below.

Starting up a Local Group: Manual

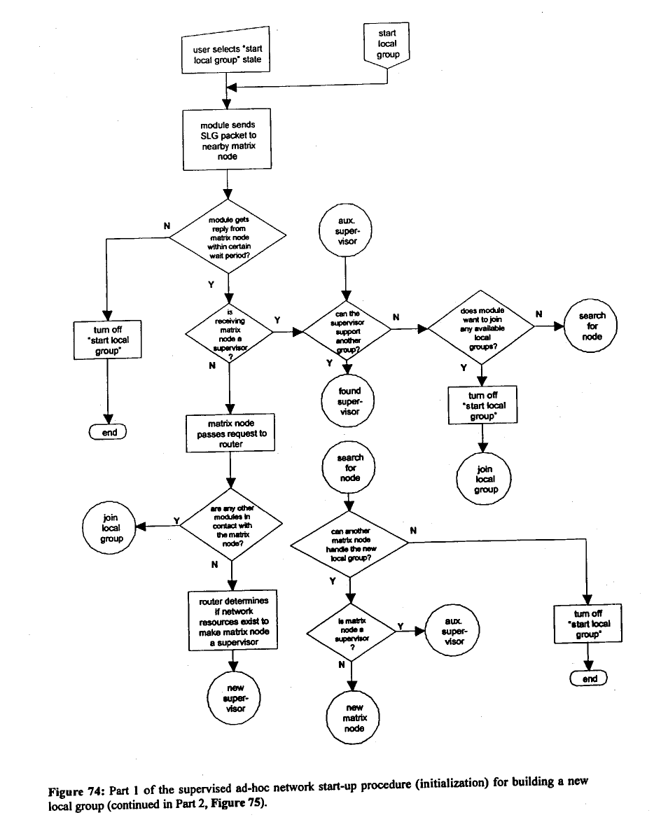

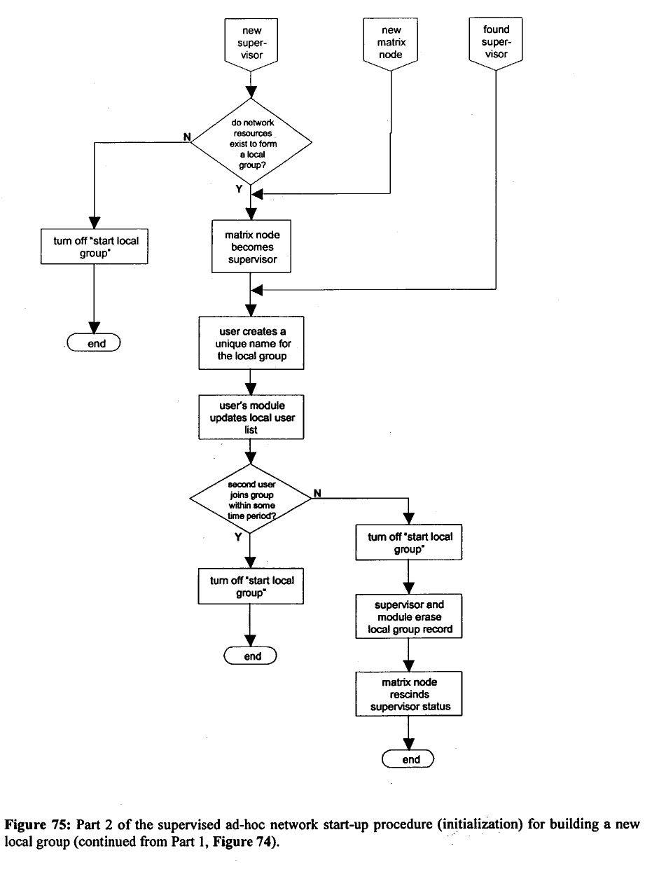

Manual start-up is illustrated in FIG. 74 and FIG. 75. In the simple manual start-up mode the modules are assumed to already be registered with a matrix node (see the SDM layer description for further details on the registration of a module with a matrix node). Thus, the matrix node has all the modules that it can communicate with stored in its memory along with the data required to beamform to them in any combination. The user prompts the module to send a request to the matrix node to form a local group by putting the module into a “start local group” state. The request is embedded in a packet referred to as an SLG (start local group) packet. The SLG includes the address of the module along with data identifying the packet as a specific request to start a group. After sending the SLG the module waits a certain amount of time before giving up on hearing any acknowledgement and informing the user that a connection could not be made.

If the matrix node that receives the SLG is not in charge of any local group it passes along the request to the router. The router replies and first tells the matrix node to query any other modules it is communicating with (within the SDM layer) to see if they wish to join this new local group. The router then figures out if the network resources exist to allow the applying matrix node to be a supervisor. This decision is based on many factors including:

1. The number of users responding “yes” and “no” to the matrix node's query.

2. The volume of traffic being sent to modules through the matrix node.

3. The separation from, availability, and obstructions to adjacent matrix nodes.

4. The integrity of the wireless channel (from matrix node to the modules and between matrix nodes themselves).

If the network resources do exist the router informs the node that it may become a supervisor. Otherwise the router informs the matrix node that a local group cannot be set-up.

Upon receiving the router's response, the matrix node switches to supervisor status and registers the first module by assigning it a unique Sad address (on top of the actual module address it already stored after receiving the SLG). A set of unique Sad addresses exist for each local group supervised. The Sad address that a module receives depends on the order in which it joined a local group. The modules which responded “yes” when asked by the supervisor if they wish to join the network are treated as if they attempted to join a local group a procedure explained in the sub-section titled Joining a Local Group.

The supervisor also asks the module which sent the SLG to assign a unique name to the local group. The supervisor then informs the router of the local group name it is supervising and the module address (not network address) of the user in that group. The router can, thus update its internal module information (i.e. that a particular module has a particular matrix node as a supervisor).

The supervisor then waits for a certain amount of time for a second user to join the local group. If no other user joins the local group within that time the supervisor informs the current member of the local group that not enough users have joined the network and disconnects the module from the local group by sending a CLG (cancel local group) packet. Upon receiving the CLG packet the module erases the contents of its local group list. After sending out the CLG the supervisor informs the router that the local group has been disbanded and then proceeds to leave supervisor mode and commences operation as a pure matrix node.

If the matrix node that receives the SLG is already in charge of a local group (i.e. is already a supervisor) it checks to see that it can support another group. This decision is based on the number and size of the local groups that the supervisor is already in charge of and the array size and processing power of the supervisor. If the supervisor can support another group then a manual local group start-up procedure, as outlined above, is followed. If the supervisor cannot support another local group it sends a message to the router informing it of this. The router checks if network resources are available for a nearby matrix node (within range of the module starting a local group) to support a new local group. If the resources are available the router allows the requesting module to start a local group with that matrix node.

If neither of these options are successful (i.e. supervisor cannot support a new local group and another matrix node cannot be found) the supervisor gives the user a chance to join any of the local groups that it supports. If the user decides to join any of the supervisor's existing local groups then the procedures outlined in the section Joining a Local group are followed.

Starting up a Local Group: Automatic

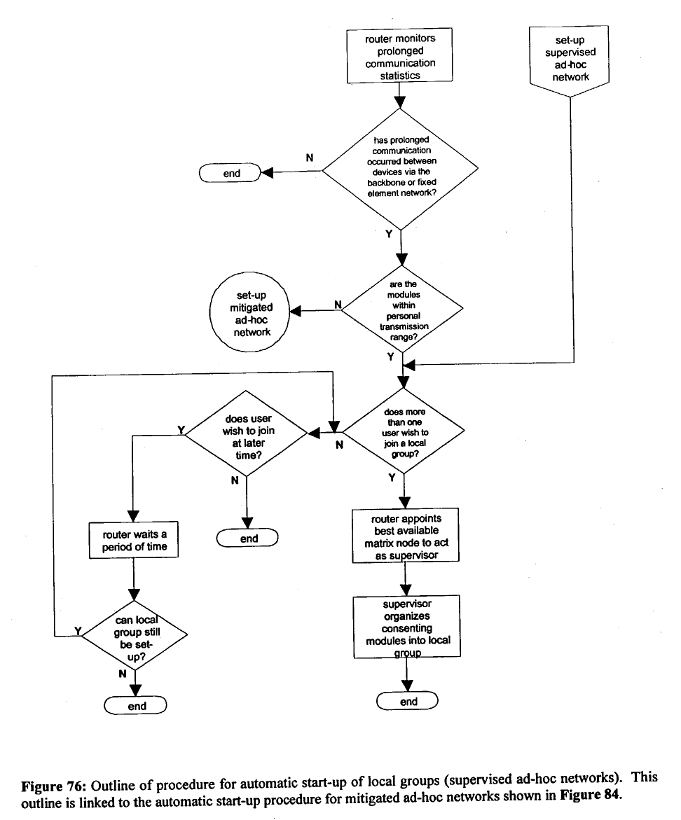

The procedure for automatic local group set-up is shown in FIG. 76. For the router to automatically set-up a Sad, it first monitors if prolonged communication has occurred between two or more modules in the network. This could be communication via the backbone network or a mitigated ad-hoc network (see the Mitigated Ad-Hoc Network section,). If the modules are within personal transmission range of one another and the network resources exist to support a Sad they are then prompted by the router, via the most suitable matrix nodes, if they wish to form a local group. If any one of the users does not wish to form a local group the router does not alter the communication set-up and prompts the users if they wish to be asked again at some later time. If any of the users respond that they do wish to be informed later the router will continue monitoring the network and make another request to create a local group (if still applicable) after some random wait period. If all the users do wish to form a local group the router appoints the best suitable matrix node to act as the supervisor. With the supervisor and local group users identified the local group communicates as described below (in the Steady-State Operation section).

Joining a Local Group

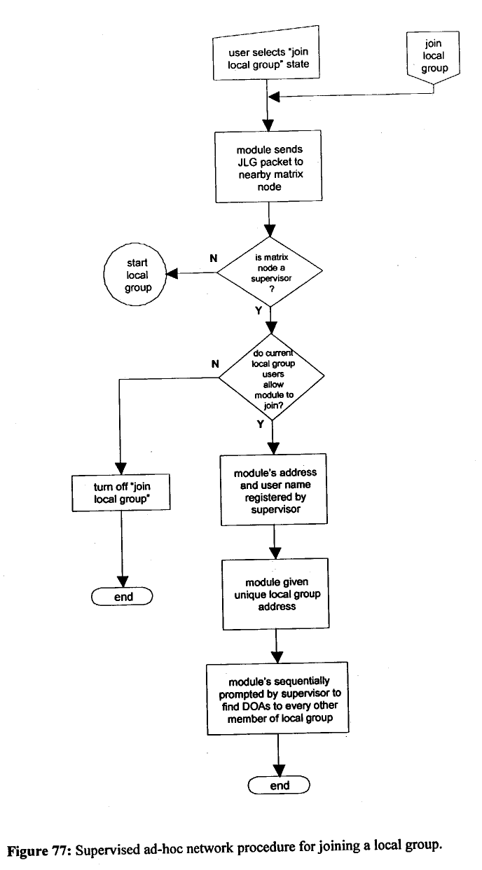

The procedure for joining a local group is outlined in FIG. 77. As in the case outlined in the sub-section titled Starting the Local Group: Manual a module attempting to join a local network is assumed to already be registered with the supervisor (but not the Sad) (contingencies regarding the procedure of joining a local group are outlined in the Contingencies sub-section). The module is prompted to make an attempt at joining a local group when put into the “join local group” state by the user. Upon entering this state the module sends out a join local group (JLG) packet. If the matrix node that receives the JLG is not a supervisor then the packet is interpreted as an SLG and the procedure outlined in the sub-section Starting a Local Group: Manual is followed. The supervisor sends the module the local group name(s) and the list(s) of members in the local group(s) it is helping to supervise. The module then sends a request to the supervisor if it wishes to join the local group(s) shown. A module may attempt to join only one local group per JLG signal it sends out.

Depending on the security measures that are in place (agreed to earlier by all current members of the local group) the supervisor prompts the current members of the local group to give consent to the module's request to join the local group. The default security procedure requires only one member to give consent for a new user to be allowed to enter the network and only one user to decline acceptance for the new user to be refused entry into the network.

If the current users accept a new applicant into the local group the supervisor registers the requesting module's address. The supervisor also assigns it a unique Sad address by beamforming an assign supervised address (ASA) packet to the requesting module (as mentioned at the beginning of this sub-section the module and supervisor are assumed to have already established a connection and hence have stored the beam weights appropriate for generating direct beam patterns to one another). The supervisor then gets all modules within all local groups under its supervision to find their relative direction to every other node within the local groups under the supervisor's supervision. In this way the modules update their individual local group lists. This is done by the supervisor individually prompting (one local group at a time) every user in a local group (in order of entry into the group, and hence dependent on the user's Sac address) to broadcast a request for access to a supervised ad-hoc network (RFAS) beacon. The RFAS is a dedicated spread spectrum signal that uses the same code as the RFA beacon explained in the SDM layer description and is the same as the RFA save for slight differences in their information content.

The broadcasting module structures the information within the RFAS packet such that it contains:

1. An identifier stating that the RFAS packet was sent in search of a Sad

2. The user name of the RFAS sender

3. The presumed Sad address of the RFAS sender (loaded into the module when the supervisor prompted it to send and RFAS)

Again, the supervisor contains a list of all members specific to each local group that it oversees and has assigned them all unique Sad address codes that it propagates to the member modules via the ASA packet.

Upon receiving an RFAS packet, a module determines whether it came from a member of its local group (by looking at the address). If the RFAS belongs to a module in the receiving device's local group then the module stores the user name and Sad address in its local group list and beams the received signal to the supervisor which relays it to the router for direction-of-arrival (DOA) estimation. This information is returned to the module (again, via the supervisor) and used by the module to compute beam weights to the RFAS sender. If the RFAS does not belong to a module in the receiving device's local group then the beacon is also processed, but no beam weights are computed. By sequentially (in order of their Sad addresses) prompting each device in the local group (by using the ASA packets) to broadcast an RFAS signal the supervisor helps each module find its relative direction to every other module in its local group.

Steady-State Operation

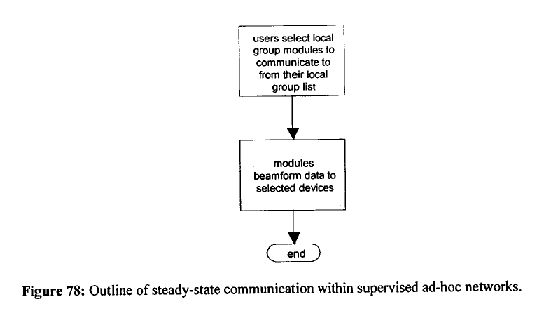

The steady-state operation of supervised ad-hoc networks is outlined in FIG. 78. As mentioned, the supervisor contains a list of addresses and beam weights to every module in a local group. Also, every module in the local group contains the address and beam weights to the supervisor node and every other module in the local group (described above). To communicate with any member of the local group the user indicates the members he wishes to communicate with by selecting them in its local group list. Since the beam weights to each member of the group are available the module can beamform to members of the local group in any combination. On top of the beamformed spatial diversity each member can communicate using a diversity signaling scheme unique to the address that it was provided with by the supervisor (and which is know to the remaining members of the group). A module is aware of the addresses and relative directions to members of other local groups controlled by the same supervisor, but cannot actually communicate with those devices unless is too is a part of the same local group.

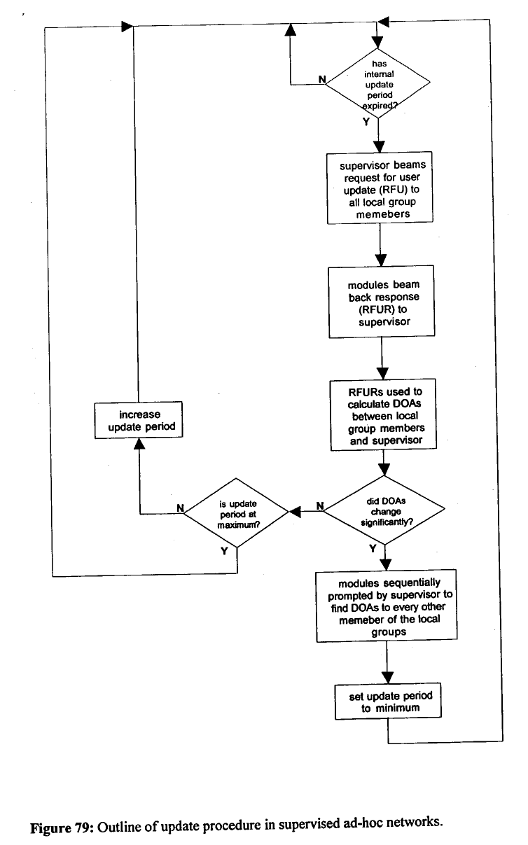

An important aspect of steady state operation is the procedure to update local groups. The update procedure for supervised ad-hoc networks is outlined in FIG. 79. The supervisor looks at and updates the local groups it is controlling at regular intervals (the wait-to-update period). The update involves a measurement of the relative direction between a supervisor and all the members of its local groups. The purpose of the update is to note if modules in local groups have moved. If no significant movement is noticed (i.e. if the relative module directions to the supervisor change less than a certain threshold) then the wait period until the next update is increased. If a significant movement is noticed (i.e. if the relative module directions to the supervisor change by equal to or greater than a certain threshold) then the wait period is reduced to its minimum value.

The update procedure begins when a request for user update (RFU) is simultaneously beamformed from the supervisor to all members of a local group. Upon receiving this update beacon the modules beam a request for user response (RFUR) back to the supervisor. The supervisor returns these responses to the router which calculates the DOAs and informs the supervisor of the relative directions of the modules to the supervisor and the beam weights necessary to beamform to them. From the DOA data the supervisor judges if the Sad has changed significantly enough to force each member of the local group to update their directions relative to every other member. If so the supervisor beamforms ASA packets to modules thus causing them to broadcast RFAS beacons that are used to update the relative directions (as explained in the sub-section Joining a Local Group). It also sets its wait-to-update period to a minimum value. The wait-to-update period is incrementally increased up to a maximum value each time no significant DOA changes have been observed.

Contingencies

A number of contingencies exist during start-up, joining, and communicating within supervised ad-hoc networks.

1. Too Many Members in Local Group:

If a supervising node cannot handle any more users within a local group it sends a message back to the requesting module that the local group cannot accommodate any more users.

2. Setting a Security Level:

Users within a local group can set the level of security personal security they wish to have in the network. This can range over a number of levels such as:

Low: User does not require any consent for new module to join local group.

Nominal: User requires majority consent for new module to join local group, otherwise user wishes to drop local group.

High: User requires unanimous consent for new module to join local group, otherwise user wishes to drop local group.

3. Module has More Than One Unit at the Same DOA:

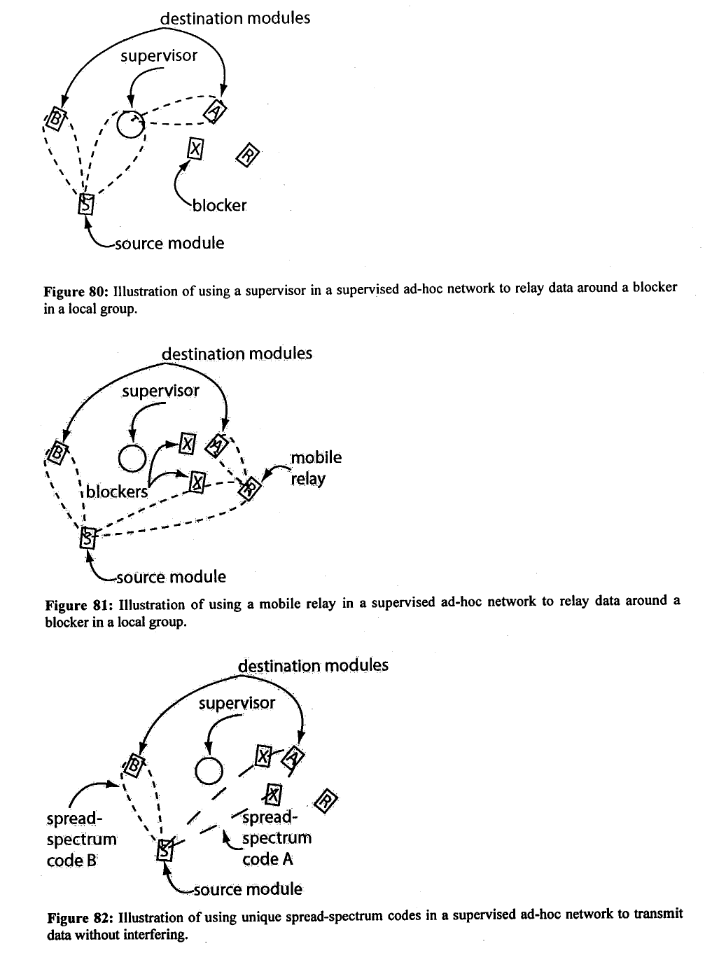

If the users are intended to receive the same data from the supervisor then the transmitting module can beam to both of them directly. If the users are not intended to receive the same data or the transmission may interfere with another module's communication the transmitting module asks the supervisor to relay the data to the receiving module. This is one aspect of the network's relay routing functionality. This scenario is illustrated in FIG. 80. If the supervisor is blocked from directly relaying the data it searches (with the help of the router) for any suitable members of the local group to act as mobile relays. Mobile relays can transfer the data between the source and the destination modules. If a mobile relay is found the supervisor informs the original transmitting module which device to attempt to relay data through. This scenario is illustrated in FIG. 81. If no module is available to relay data, the sending module uses another signal diversity technique (on top of the spatial diversity afforded by beamforming) unique to the local group address of the destination module. The additional diversity techniques could include any of the popular methods commonly in use including frequency-, time-, polarization-, or code-division multiplexing. This case is illustrate (using a unique spreading code as an example) in FIG. 82.

4. Module cannot Establish Contact with Another Module in its Local User List:

If module attempts communication using some diversity scheme unique to the local group address of the destination module and still cannot establish contact it then requests the supervisor for a copy of the supervisor's local group member list. If the destination module is not on the list the module assumes that its local user list must be incorrect and requests the supervisor to update the local group. If the destination module is on the supervisor's list it is assumed that the source module cannot establish direct contact with the destination module (due to any of a number of reasons such as channel degradation, unknown obstructions, un-sensed interference, etc.) and the supervisor attempts to establish contact between the source and destination by acting as a relay. If the supervisor cannot establish contact it begins to search (with the help of the router) for available modules in the source module's local group that could act as mobile relays. If a mobile relay is found the supervisor informs the original transmitting module which device to attempt to relay data through. If a mobile relay cannot be found or a mobile relay cannot establish contact the user is told that contact cannot be established and given the option to re-initiate communication with the destination.

5. Request to Start Group from Module New to Network:

A module cannot start a local group until it first registers with the network. A user's registration with the fixed element network is explained in the SDM layer description. The “start local group” state in the module will be un-selectable by the user until the module has been registered onto the fixed element network.

6. Request to Join Group from Module New to Network:

A module cannot register into a local group until it first registers with the network. A user's registration with the fixed element network is explained in the SDM layer description. The “join local group” state in the module will be un-selectable by the user until the module has been registered onto the fixed element network.

7. Request to Join Group from a Device Already Belonging to a Local Group:

A device is capable of belonging to more than one local group if the network resources exist to support the growth in the local group it joins and if local group security restrictions are not violated by the new users inclusion into the Sad.

8. Request to Join Main Network from Module Assigned to a Supervisor:

A supervisor node handles module requests to register onto the fixed element network in the same way as any other matrix node. This registration procedure is described in the SDM layer section.

9. User Leaves Local Group without Informing Network:

A module that drops the local group by becoming unable to wirelessly communicate with the supervisor or any other module (i.e. without informing the network through a DLG packet, see the Scaling sub-section) is removed from the network on the next automatic update initiated by the supervisor.

Scaling

To increase the size of s supervised as-hoc network see above: Joining the Local Group. Once a module wishes to leave a local group it sends the supervisor a drop local group (DLG) packet. The supervisor then eliminates that user from the user list of the local group specified by the DLG and beamforms a message to each of the remaining users individually telling them that a particular user is no longer in the local group. The remaining local group members update their local group lists by dropping the ousted unit from the local group lists.

3.4.3 Mitigated Ad-Hoc Network (Mad)

Main Features

Mitigated ad-hoc networks allow for communication between modules within the fixed element network that are out of the broadcast range of their own transmitters. A collection of users communicating via the mitigated ad-hoc structure is referred to as a mitigated group. The router is the controller of all mitigated ad-hoc networks which places these Mads very close in function and operation to the situation described in the SDM layer section. Once modules have registered within a mitigated ad-hoc group they contain a list of other members of the Mad. Communication between the members occurs across links of fixed element nodes which the router assigned for that specific communication. When communication ceases the router tears down the connection.

Initialization

Starting Up a Mitigated Group

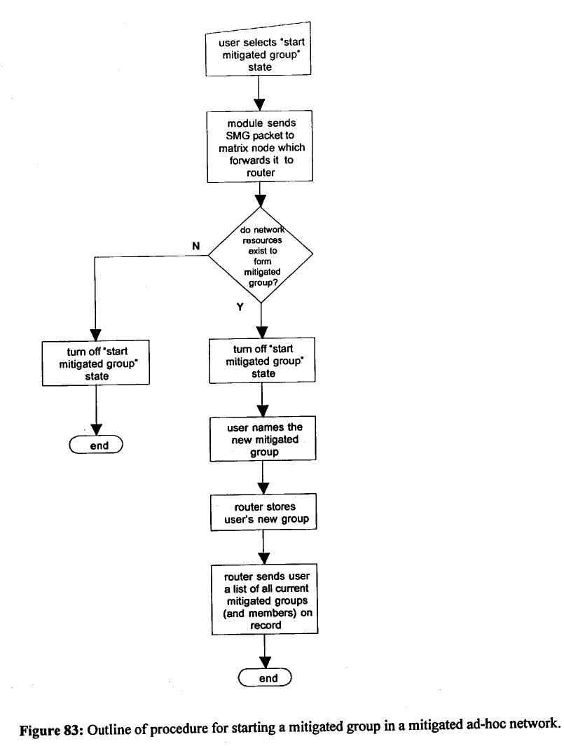

The procedure for starting a mitigated ad-hoc network is outlined in FIG. 83. Users intending to form a mitigated group are assumed to already have their modules registered with the router. Following a pattern similar to that outlined for supervised ad-hoc networks (see the sub-section titled Starting Up a Local Group: Manual) the user places the module in the “start mitigated group” state which prompts it to send a start mitigated group (SMG) packet to a nearby matrix node, the matrix node relays the SMG packet to the router. The SMG includes the address of the module along with data identifying the packet as a specific request to start a group. After sending the SMG the module waits a certain amount of time before giving up on hearing any acknowledgement and informing the user that a connection could not be made. If the router determines that insufficient network resources exist to initiate a new Mad it will deny the module's request to start a mitigated group.

If the router successfully processes the SMG it prompts the user requesting to set up a mitigated group to name the new Mad. Since the router can keep track of a large number of mitigated groups a unique Mad name must be provided by the user in order for the router to accept the request to start a new mitigated group. The router also sends the module a list of mitigated group names (and the users assigned to each mitigated group) it currently has on record. Once the user returns a reply, the router stores away the mitigated group along with its only member—the user who sent the SMG. A user can start only one mitigated group per SMG packet sent.

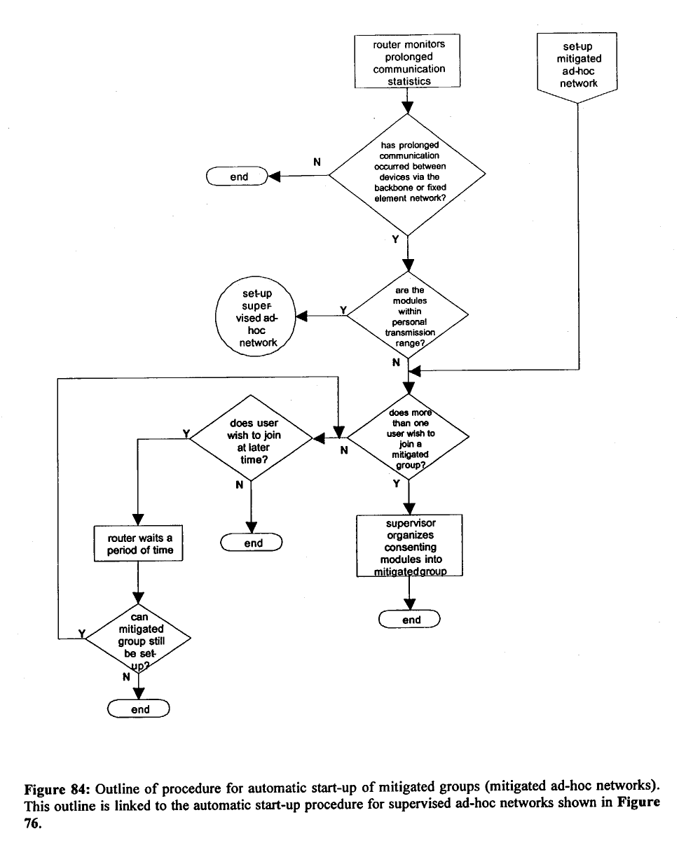

A mitigated ad-hoc network could be started automatically in a manner similar to that described in the Starting Up a Local Group: Automatic sub-section of the Supervised Ad-Hoc section. The procedure for automatically starting up a mitigated group is shown in FIG. 84.

Joining a Mitigated Group

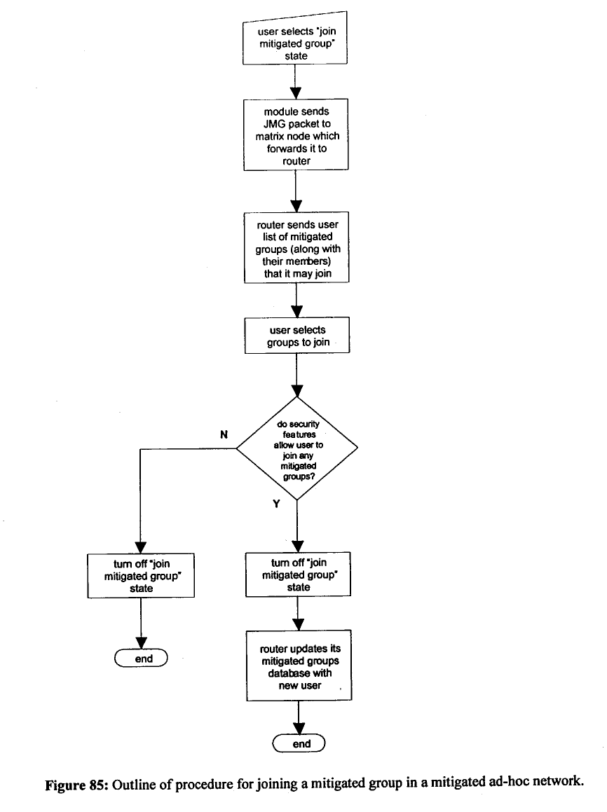

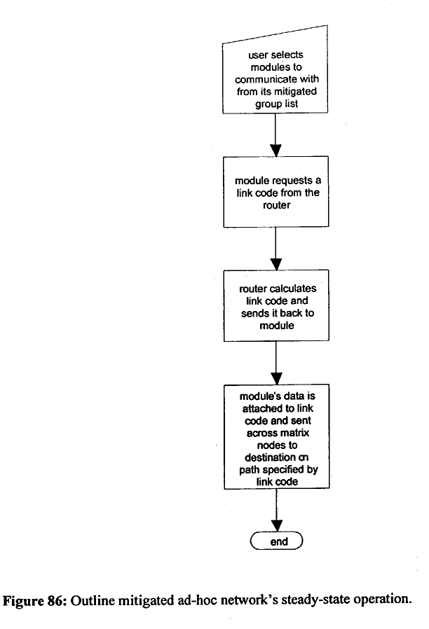

The procedure for joining a mitigated group is outlined in FIG. 85. To join a mitigated group the user sets the module into the “join mitigated group” state which prompts the module to send a join mitigated group (JMG) packet to a nearby matrix node which relays the JMG packet to the router. The router sends the module a list of mitigated group names which include lists of members in each mitigated group. The module then sends a request to the router if it wishes to join any of the local groups shown. Depending on the security measures that are in place the router (via the appropriate matrix nodes) may poll the current members of the mitigated group to give consent to the module's request to join their mitigated group. The default security procedure requires only one user to give consent for a new user to be allowed to enter the Mad and only one user to decline acceptance for the new user to be refused entry into the Mad. Also, if the router determines that insufficient network resources exist to accept another user into a Mad it will deny the module's request to enter a mitigated group. If a new user is accepted into a Mad the router updates its mitigated groups database by appending the new user to a Mad's mitigated group list.

Steady-State Operation

An outline of a mitigated ad-hoc network's communication process is shown in FIG. 86. To communicate with any member of a mitigated group the user indicates the members he wishes to communicate with by selecting them from its mitigated group list. The module sends a request to the router to determine (perhaps) a multi-hop path (link code) to another matrix node which can deliver the data to the destination module. This link code is passed back to the sending module. The link code is included in the header of the source module's packets. The receiving modules use the link code to relay the data along the network (matrix node-to-matrix node) until the destination module is reached. The router keeps track of the location of each device in the network and can trace an optimal path between source and destination(s).

An important aspect of steady state operation is the procedure to update mitigated groups. The update procedure for mitigated ad-hoc networks is entirely the same as the matrix node updating procedure described in the SDM layer section. Basically, mitigated group members clustered around any matrix node are updated whenever the matrix node initiates an RFU signal to the modules registered to it. Before sending any other stream of data the modules must query the router to update their link codes to other modules.

Contingencies

See the SDM Layer Description.

Scaling

To increase the size of mitigated ad-hoc network see above: Joining a Mitigated Group. Once a module wishes to leave a mitigated group it sends a nearby matrix node a, drop mitigated group (DMG) packet. The router then eliminates that module from the user list of the mitigated group(s) it belonged to and beamforms a message to each of the remaining users in that mitigated group telling them that a particular user is no longer in the mitigated group. The remaining mitigated group members update their mitigated group lists.

4. Glossary

ASA: Assign supervised address beacon. This signal, sent by a supervisor to a module informs the module of its assigned address in a local group.

ASDM: Adaptive Spatial-Division Multiplexing.

CLG: Cancel local group packet. Sent by a supervisor to modules informing them that an entire local group of a supervised ad-hoc network is being disconnected.

device: Portable computer, intended as device to which plug-in is attached thus enabling it with ability to communicate wirelessly to network. Often used to denote communicator with both device and plug-in already joined. Syn: module.

DLG: Drop local group packet. The signal sent by a module belonging to a local group informing its supervisor that it is leaving the local group.

DOA: Direction of arrival for signal at a node.

DP: Disassociation packet.

fixed element: All fixed elements of the network including matrix nodes, router and backbone.

JLG: Join local group packet. A packet sent by a module to the network indicating its intention to join a nearby local group.

JMG: Join mitigated group packet. A packet sent by a module to the network indicating its intention to join a mitigated group.

link code: A path plan sent to a module from the router. This path plan is attached to data sent by the module and informs matrix nodes how to relay (hop) data across the network to reach another destination module and thus transfer data in a mitigated ad-hoc network.

LMAC: Localized medium access control.

local group: A group of users communicating with one another in a supervised ad-hoc network.

local group list: A list of local groups and their members along with their addresses and relative directions to modules in a supervised ad-hoc network.

matrix node: The extension points and access points in the network.

mitigated group: A group of users communicating with one another in a mitigated ad-hoc network.

mitigated group list: A list of mitigated groups and their members along with their addresses.

mobile relay: Modules in supervised ad-hoc networks that act as transfer points between a source and destination module using multi-hop communication.

module: See device.

network node: see node.

node: Refers to an access point, matrix node, or user module.

plug-in: Transceiver/processing unit intended to connect to device (module) thus enabling them to communicate wirelessly within the network.

referance module: The actual (hardware) module on whose display a user list (or local group list or mitigated group list) is being viewed or on which a network database is being studied or referred to.

relay routing: The use of a supervisor or module to act as a go-between for communication between two or more other modules (typically used in supervised ad-hoc networks).

RFA: Request for access to FE/SDM network beacon.

RFAD: RFA Detected packet.

RFAS: Request for access to supervised ad-hoc network beacon.

RFAV: Request for access to vanilla ad-hoc network beacon.

router: The processing and controlling interface between the backbone network and the matrix nodes.

RFD: Request for drop beacon. This beacon is sent by a module to the ad-hoc network and states that the device is leaving the network.

RFH: Request for handoff packet.

RFM: Request for measurement packet.

RFMR: Request for measurement response packet.

RFU: Request for user update.

RFUR: Request for user update response.

RVA: Re-set vanilla ad-hoc network beacon.

SDM: Spatial division multiplexing.

SLG: Start local group packet. A request sent by a module to a matrix node when the module's user wishes to start a supervised ad-hoc network.

SMG: Start mitigated group packet. A request sent by a module to a matrix node when the module's user wishes to start a mitigated ad-hoc network.

supervisor (node): A matrix node helping organize the flow of data in a local group.

user: Person using a device.

user list: List of members along with their addresses and relative direction to a user in a vanilla ad-hoc network.

WUP: Weight update packet.

### 5. REFERENCES

Fixed Element Layer

A. Leon-Garcia and I. Widjaja, Communication Networks: Fundamental Concepts and Key Architectures, Toronto: McGraw-Hill, 2000

B. Van Veen, K. Buckley, “Beamforming: A Versatile Approach to Spatial Filtering”, IEEE ASSP Magazine, April 1988, pp. 4-24.

Spatial Division Multiplexing (SDM) Layer

K. Balachandran, S. Kadaba, S. Nanda, “Channel Quality Estimation and Rate Adaptation for Cellular Mobile Radio”, IEEE Journal on Selected Areas in Communications, July 1999, pg. 1244-1256.

B. Bing, High-Speed Wireless ATM and LANs, Boston: Artech House Publishers, 2000, pg. 24-39.

K. Buckley, X. Xu, “Spatial-Spectrum Estimation in a Location Sector”, IEEE Transactions on Acoustics, Speech, and Signal Processing, November 1990, pg. 1842-1852.

E. Dinan, B. Jabbari, “Spreading Codes for Direct Sequence CDMA and Wideband CDMA Cellular Networks”, IEEE Communications Magazine, September 1998, pg. 48-54.

A El-Osery, C. Abdallah, “Distributed Power Control in CDMA Cellular Systems”, IEEE Antennas and Propagation Magazine, August 2000, pg. 152-159.

H. Krim, M. Viberg, “Two Decades of Array Signal Processing Research”, IEEE Signal Processing Magazine, July 1996, pg. 67-94.

S. Nanda, K. Balanchandran, S. Kumar, “Adaptation Techniques in Wireless Packet Data Services”, IEEE Communications Magazine, January 2000, pg. 54-64.

B. Van Veen, K. Buckley, “Beamforming: A Versatile Approach to Spatial Filtering”, IEEE ASSP Magazine, April 1988, pg. 4-24.

[1] K. Sohrabi and G. J. Pottie, “Performance of a novel self-organization protocol for wireless ad-hoc sensor networks,” IEEE Vehicular Technology Conference, p. 1222-1226, 1999.

[2] B. Das and V. Bharghavan, “Routing in ad-hoc networks using minimum connected dominating sets,” IEEE International Conference on Communications, p. 376-380, 1997.

[3] J. Meggers and G. Filios, “Multicast communication in “ad hoc” networks,” IEEE Vehicular Technology Conference, p. 372-376, 1998.

[4] C. Romans and J. Tourrilhes, “A medium access protocol for wireless LANs which supports isochronous and asynchronous traffic,” IEEE International Symposium on Personal, Indoor and Mobile Radio Communications, p. 147-152, 1998.

[5] A. B. McDonald and T. Znati, “A path availability model for wireless ad-hoc networks,” IEEE Wireless Communications and Networking Conference, p. 35-40, 1999.

[6] R. L. Davies, R. M. Watson, A. Munro and M. H. Barton, “Ad-hoc wireless networking: contention free multiple access,” IEE Conference on Telecommunications, p. 73-77, 1994.

1. A wireless communication network comprising:
(a) a plurality of network nodes, each network node including a node beamforming antenna array for establishing a spatial communication channel;
(b) a central router in communication with each of said network nodes, said central router comprising:
(i) a memory; and
(ii) a processor coupled to said memory such that said processor executes instructions stored in memory for selectively activating at least one network node of said plurality of network nodes such that each activated network node has a transmission neighbourhood and such that each said node beamforming antenna array of each said activated network node is utilized to establish a first two way spatial communication channel.

2. The wireless communication network of claim 1, wherein said central router is coupled to one or more of said plurality of network nodes through a high capacity optical channel.

3. The wireless communication network of claim 1, wherein said central router is coupled to one or more of said plurality of network nodes through a high capacity wire channel.

4. The wireless communication network of claim 1, wherein said central router processor determines the physical location of each activated network node and selectively activates network nodes such that none of the activated network nodes are physically collinear.

5. The wireless communication network of claim 1, wherein said central router processor determines the physical location of each activated network node and selectively activates network nodes such that for any three activated network nodes, only one of the three activated network nodes is physically located within the transmission neighbourhoods of all the three activated network nodes.

6. The wireless communication network of claim 1, wherein said central router maintains a table of beamforming weights for each network node and utilizes said beamforming weights to select said activated network nodes.

7. The wireless communication network of claim 1, further comprising a mobile device having a mobile beamforming antenna array and being physically located within the transmission neighbourhood of an activated network node, said mobile beamforming antenna array and said node beamforming antenna array of said activated network node being adapted to provide uplink and downlink transmission to said mobile device over said first communication channel.

8. The wireless communication network of claim 1, wherein said central router processor selectively activates at least one network node of said plurality of network nodes such that each said node beamforming antenna array of each said activated network node is utilized to establish a second two-way spatial communication channel.

9. The wireless communication network of claim 8, wherein said first and said second spatial channel does not overlap and wherein each of said first and second spatial channel operates at a data rate adapted to the channel's transmission and physical characteristics.

10. The wireless communication network of claim 7, wherein said central router processor determines whether said mobile device is moving outside the transmission neighbourhood of each node beamforming antenna array of said activated network nodes forming said first two-way spatial communication channel and if so, selectively activates at least one network node to establish a second two way spatial communication channel such that said mobile beamforming antenna array and said node beamforming antenna array of one of said activated network nodes of said second two-way spatial communication channel, are adapted to provide uplink and downlink transmission to said mobile device over said second communication channel.

11. The wireless communication network of claim 10, wherein said mobile beamforming antenna array and said node beamforming antenna array of one of said activated network nodes of said second two-way spatial communication channel, are adapted to provide uplink and downlink transmission to said mobile device on said second communication channel in addition to said uplink and downlink transmission on said first communication channel.

12. The wireless communication network of claim 11, wherein said central router processor locally isolates and treats contentions amongst said activated network nodes and said mobile device using multiple access techniques.

13. The wireless communication network of claim 1, further comprising first and second mobile devices having first and second mobile beamforming antennas respectively, said first and second mobile devices physically located within the transmission neighbourhood of at least one of said network nodes, wherein said central router processor selectively activates at least one network node of said plurality of network nodes such that said first and second mobile beamforming antennas and said node beamforming antenna array of each said activated network node are used to establish a two-way spatial communication channel between said first and second mobile devices.

14. A method of providing a communication path through a wireless network comprising a central router and a plurality of network nodes each having a beamforming antenna, said method comprising the steps of:
(a) establishing communication between said central router and each of said plurality of network nodes;
(b) selectively activating at least one network node of said plurality of network nodes such that each activated network node has a transmission neighbourhood; and
(c) utilizing each said node beamforming antenna array of each said activated network node to establish a first two-way spatial communication channel.

15. The method of claim 14, further comprising the steps of determining the physical location of each activated network node and selectively activating network nodes such that none of the activated network nodes are physically collinear.

16. The method of claim 14, further comprising the steps of determining the physical location of each activated network node and selectively activating network nodes such that for any three activated network nodes, only one of the three activated network nodes is physically located within the transmission neighbourhoods of all the three activated network nodes.

17. The method of claim 14, wherein step (b) includes the steps of maintaining a table of beamforming weights for each network node and utilizing said beamforming weights to select said activated network nodes.

18. The method of claim 14, further comprising the step of providing said first two-way spatial communication channel to a mobile device having a mobile beamforming antenna array and physically located within the transmission neighbourhood of at least one of said activated network nodes.

19. The method of claim 18, further comprising the step of selectively activating at least one network node of said plurality of network nodes such that each said node beamforming antenna array of each said activated network node is utilized to establish a second two-way spatial communication channel.

20. The method of claim 19, wherein said mobile beamforming antenna array and said node beamforming antenna array of one of said activated network nodes of said second two-way spatial communication channel provide simultaneous uplink and downlink transmission to said mobile device on said first and second communication channel.

21. The method of claim 18, further comprising the step of determining whether said mobile device is moving outside the transmission neighbourhood of each node beamforming antenna array of said activated network nodes forming said first two-way spatial communication channel and if so, selectively activating at least one network node to establish a second two-way spatial communication channel such that said mobile beamforming antenna array and said node beamforming antenna array of one of said activated network nodes forming said second two-way spatial communication channel, are adapted to provide uplink and downlink transmission to said mobile device over said second communication channel.

22. The wireless communication network of claim 21, further comprising the step of locally isolating and treating contentions amongst said activated network nodes and said mobile device with multiple access techniques.

23. The method of claim 14, wherein the network further comprises first and second mobile devices physically located within the transmission neighbourhood of at least one of said network nodes, and further comprising the step of selectively activating at least one network node of said plurality of network nodes such that each said node beamforming antenna array of each said activated network node is utilized to establish a two-way spatial communication channel between said first and second mobile devices.
